(19) United States
(12) Patent Application Publication
(10) Pub. No.: US 2008/0130467 A1
(43) Pub. Date: Jun. 5, 2008

(54) Objective optical system and optical pickup including the same

(76) Inventors: Michihiro Yamagata, Osaka (JP); Yoshiaki Komma, Osaka (JP); Yasuhiro Tanaka, Hyogo (JP); Katsuhiko Hayashi, Osaka (JP)

Correspondence Address: MCDERMOTT WILL & EMERY LLP, 600 13TH STREET, NW, WASHINGTON, DC, 20005-3096, US

(21) Appl. No.: 11/819,204

(22) Filed: Jun. 26, 2007

Related U.S. Application Data
(60) Provisional application No. 60/878,398, filed on Jan. 4, 2007.

(30) Foreign Application Priority Data
Jun. 26, 2006 (JP) 2006-175805

(51) Int. Cl. G11B 7/00

(52) U.S. Cl. 369/112.05

(57) ABSTRACT

An objective optical system 10 includes a diffraction plane 15 for separating a laser light beam into at least 0^{th}-order diffracted light and 1^{st}-order diffracted light. The objective optical system 10 is configured to focus the 0^{th}-order diffracted light onto an information recording surface 22a of a first information recording medium 20a and the 1^{st}-order diffracted light onto an information recording surface 22b of a second information recording medium 20b and meet the following conditional expression (1):

η₀>η₁ (1)

wherein η₀ is the diffraction efficiency of the 0^{th}-order diffracted light and η₁ is the diffraction efficiency of the 1^{st}-order diffracted light.

### BACKGROUND OF THE INVENTION

1. Field of the Invention

The present invention relates to an objective optical system and an optical pickup including the same.

2. Description of Related Art

As a new information recording medium, optical disks with high recording density and large capacity have already been proposed. At present, there are various standards for the optical disks. The optical disks of different standards are different in, for example, thickness of a protection layer (also known as substrate thickness), wavelength of a laser light beam to be used and numerical aperture (NA) of an objective optical system used for focusing the laser light beam. Therefore, in general, an optical pickup (an optical disk apparatus) engineered exclusively to information reproduction from a certain kind of optical disk cannot be suitable for information reproduction from another kind of optical disk. For this reason, a compatible apparatus capable of reproducing from and recording (writing) on the optical disks of different standards has been under development.

For example, Patent Literature 1 (Japanese Unexamined Patent Publication No. H7-98431) discloses an objective optical system using a diffraction plane. The objective optical system is configured to focus diffracted lights of different diffraction orders onto information recording surfaces of two different optical disks having protection layers of different thicknesses, respectively. Further, Patent Literature 2 (Japanese Unexamined Patent Publication No. H10-10308) discloses optimum diffraction efficiencies of the diffracted lights having different diffraction orders for the objective optical system disclosed by Patent Literature 1. In detail, holography is defined such that 0^{th}- and 1^{st}-order diffracted lights used for information recording/reproduction on/from the optical disks have a diffraction efficiency of 30% or higher, while one of +2^{nd}- and −1^{st}-order diffracted lights which are not used for recording/reproducing information on/from the optical disks has a diffraction efficiency of 2% or lower.

According to another proposed technique for compatibility, an optical device having a refractive index dependent on wavelength is used such that laser light beams of different wavelengths are focused onto different positions.

### SUMMARY OF THE INVENTION

For example, if the wavelengths of the laser light beams to be used for different optical disks are varied from each other, it may be possible to record/reproduce information on/from the different kinds of optical disks by use of an optical device having a refractive index dependent on wavelength. However, if the laser light beams used for the different optical disks have substantially the same wavelength, the positions to which the laser light beams are focused cannot be adjusted even if the optical device having a refractive index dependent on wavelength is used. Therefore, it is impossible to perform information recording and reproduction on and from different kinds of optical disks corresponding to the laser light beams having substantially the same wavelength.

In contrast, the techniques disclosed by Patent Literatures 1 and 2 can be applied to the optical disks corresponding to the laser light beams having substantially the same wavelength. However, if the holography is defined such that the 0^{th}- and 1^{st}-order diffracted lights used for information recording/reproduction on/from the optical disks have the diffraction efficiency of 30% or higher, while one of the +2^{nd}- and −1^{st}-order diffracted lights which are not used for recording/reproducing information on/from the optical disks has the diffraction efficiency of 2% or lower as described in Patent Literature 2, the amount of light to be focused onto the information recording surfaces of the optical disks becomes insufficient. This may raise the possibility of inappropriate information recording (writing) on the optical disks.

That is, the objective optical system and the optical pickup as disclosed by Patent Literatures 1 and 2 are able to suitably reproduce information from the various kinds of optical disks corresponding to the laser light beams having substantially the same wavelength. However, they may possibly fail to perform appropriate information recording on these optical disks.

In consideration of the above-described issue, the present invention has been achieved. An object of the present invention is to provide an objective optical system capable of suitably reproducing information from each of various kinds of information recording media corresponding to laser light beams having substantially the same wavelength and suitably recording information on at least one of the information recording media.

In order to achieve the object, the present invention provides an objective optical system used to focus, in an optical pickup which performs information recording/reproduction on/from a first information recording medium and information reproduction from a second information recording medium, a laser light beam onto information recording surfaces of the first and second information recording media, the first and second information recording media including information recording surfaces corresponding to laser light beams of substantially the same wavelength, respectively, and protection layers having different thicknesses from each other and covering the information recording surfaces, respectively, wherein the objective optical system includes a diffraction plane for separating the laser light beam into at least 0^{th}-order diffracted light and 1^{st}-order diffracted light such that the 0^{th}-order diffracted light is focused onto the information recording surface of the first information recording medium and the 1^{st}-order diffracted light is focused onto the information recording surface of the second information recording medium and the objective optical system is configured to meet the following conditional expression (1):

η₀>η₁ (1)

wherein η₀ is the diffraction efficiency of the 0^{th}-order diffracted light and η₁ is the diffraction efficiency of the 1^{st}-order diffracted light.

Further, the present invention also provides an optical pickup which performs information recording/reproduction on/from a first information recording medium including a first information recording surface and a first protection layer covering the first information recording surface and information reproduction from a second information recording medium including a second information recording surface corresponding to a laser light beam having substantially the same wavelength as that of a laser light beam corresponding to the first information recording surface and a second protection layer covering the second information recording surface and having a thickness different from that of the first protection layer, the optical pickup including: a first light source for emitting a laser light beam having a wavelength corresponding to the first and second information recording surfaces; a first objective optical system for focusing the laser light beam onto each of the first and second information recording surfaces; and a first detector for detecting the laser light beam reflected from the first or second information recording surface, wherein the first objective optical system includes a diffraction plane which separates the laser light beam emitted from the first light source into at least 0^{th}-order diffracted light and 1^{st}-order diffracted light such that the 0^{th}-order diffracted light is focused onto the first information recording surface of the first information recording medium and the 1^{st}-order diffracted light is focused onto the second information recording surface of the second information recording medium and the first objective optical system is configured to meet the following conditional expression (1):

η₀>η₁ (1)

wherein η₀ is the diffraction efficiency of the 0^{th}-order diffracted light and η₁ is the diffraction efficiency of the 1^{st}-order diffracted light.

According to the present invention, information is suitably reproduced from each of the various kinds of information recording media corresponding to the laser light beams having substantially the same wavelength and information is suitably recorded on at least one of the information recording media.

### BRIEF DESCRIPTION OF THE DRAWINGS

FIG. 1 is a view illustrating the structure of a major part of an optical pickup 1 according to a first embodiment.

FIG. 2 is an enlarged view illustrating the structure of an objective optical system 10 and its vicinity.

FIG. 3 is a view illustrating a diffraction element 11 partially cut away.

FIG. 4 is an enlarged sectional view illustrating part of the diffraction element 11.

FIG. 5 is a graph illustrating the possible ranges of values x and y for preferable diffraction efficiency.

FIG. 6 is a graph illustrating the possible ranges of values x and y for preferable stray light ratio.

FIG. 7 is a graph illustrating the possible ranges of values x and y for more preferable diffraction efficiency and more preferable stray light ratio.

FIG. 8 is a side view of an objective lens 12a according to a first modification.

FIG. 9 is a sectional view of an objective lens 12a according to a second modification.

FIG. 10 is a sectional view of an objective lens 12c according to a third modification.

FIG. 11 is a view illustrating the structure of a major part of an optical pickup 2 according to a second embodiment.

FIG. 12 is a view illustrating the structure of a major part of an optical pickup 3 according to a third embodiment.

FIG. 13 is a view illustrating the structure of a major part of an optical pickup 4 according to a fourth embodiment.

### DETAILED DESCRIPTION OF THE INVENTION

Hereinafter, preferred embodiments of the present invention will be explained in detail with reference to the drawings.

### First Embodiment

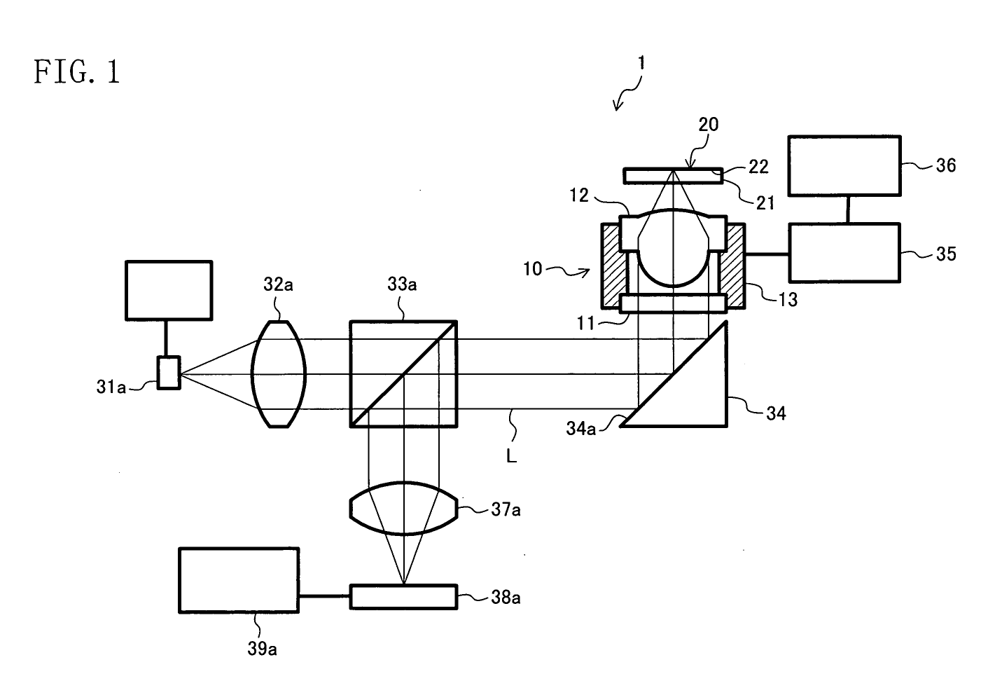

FIG. 1 shows the structure of a major part of an optical pickup 1 according to a first embodiment.

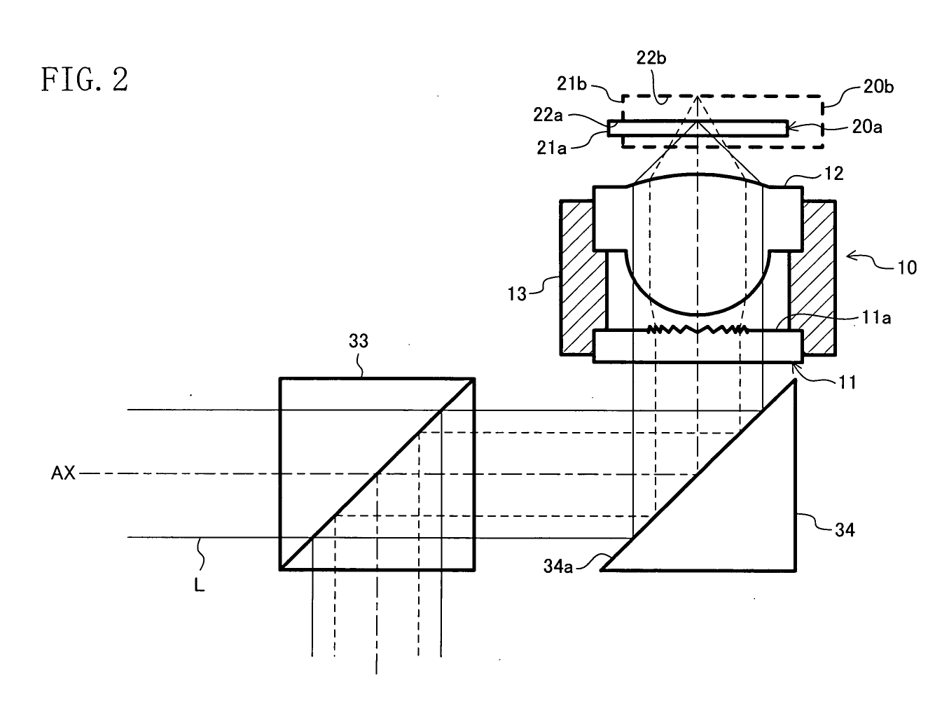

FIG. 2 is an enlarged view illustrating the structure of an objective optical system 10 and its vicinity.

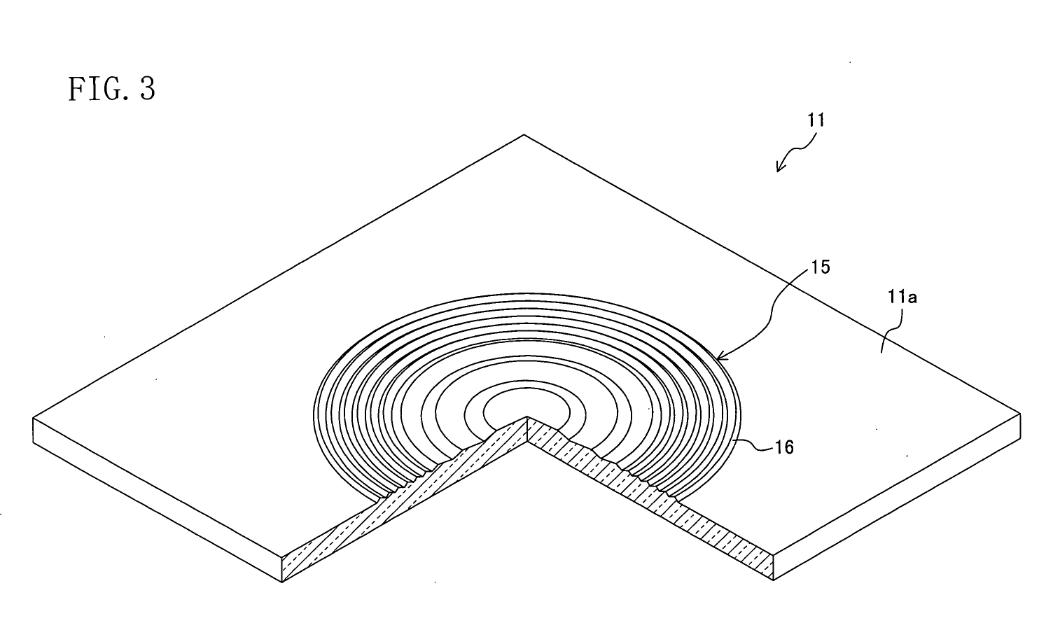

FIG. 3 is a sectional view illustrating a diffraction element 11 partially cut away.

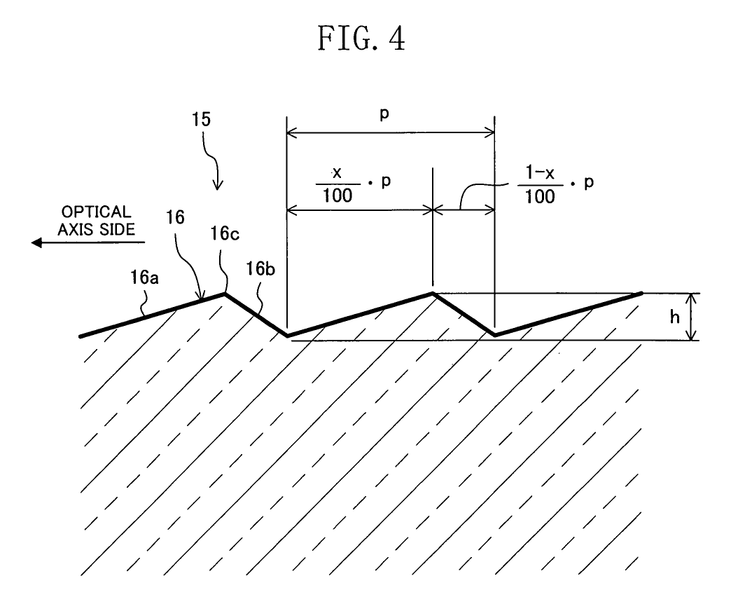

FIG. 4 is an enlarged sectional view illustrating part of the diffraction element 11.

The optical pickup 1 of the first embodiment is a device for recording/reproducing information on/from an information recording medium 20, such as an optical disk, by focusing a laser light beam onto an information recording surface 22 of the information recording medium 20 covered with a protection layer 21. More specifically, the optical pickup 1 is able to record/reproduce information on/from a first information recording medium 20a and reproduce information from a second information recording medium 20b by focusing a laser light beam onto information recording surfaces 22a and 22b of the first and second information recording media 20a and 20b corresponding to laser light beams of substantially the same wavelength and being covered with protection layers 21a and 21b of different thicknesses from each other, respectively.

In the present embodiment, the protection layer 21b of the second information recording medium 20b is thicker than the protection layer 21a of the first information recording medium 20a. However, the present invention is not limited thereto.

There is no particular limitation on the kind of information recording media to be used as the first and second information recording media 20a and 20b. For example, the first information recording medium 20a may be a Blu-Ray Disc® (hereinafter abbreviated as BD, corresponding laser beam wavelength: 400-415 nm, thickness of the protection layer 21a: 0.1 mm) and the second information recording medium 20b may be a High Definition Digital Versatile Disc® (hereinafter abbreviated as HD-DVD, corresponding laser beam wavelength: 400-415 nm, thickness of the protection layer 21b: 0.6 nm).

The optical pickup 1 includes a first light source 31a, a collimator lens 32a, a beam splitter 33a, a mirror 34 and an objective optical system 10, a detection optical system 37a and a light receiving element 38a which are arranged on an optical axis AX in this order. The optical pickup 1 further includes an actuator 35, a control unit 36 and a signal processing unit 39a.

The first light source 31a emits a laser light beam L having a wavelength corresponding to the information recording surfaces 22a and 22b. For example, if the first information recording medium 20a is a BD and the second information recording medium 20b is a HD-DVD, the wavelength of the laser light beam L emitted from the first light source 31a is about 408 nm. For example, the first light source 31a may be a semiconductor laser light source.

The laser light beam L emitted from the first light source 31a is converted into a nearly parallel light beam by the collimator lens 32a. The laser light beam L converted to the nearly parallel light beam passes through the beam splitter 33a and is guided to the objective optical system 10 by a reflection plane 34a of the mirror 34.

The objective optical system 10 is provided for focusing the laser light beam L. With the objective optical system 10, the laser light beam L is focused onto each of the information recording surfaces 22a and 22b of the first and second information recording media 20a and 20b. On each of the information recording surfaces 22, a plurality of pits (not shown) associated with recorded data are arranged along the circumferential direction. When the laser light beam L is focused onto part of the information recording surface 22 where the pits are not arranged, the laser light beam L is reflected on the information recording surface 22 and almost every portion of the reflected laser light beam enters the objective optical system 10. On the other hand, when the laser light beam L is focused onto part of the information recording surface 22 where the pits are arranged, the laser light beam L is irregularly reflected on the information recording surface 22. Therefore, the amount of light reflected and entered the objective optical system 10 becomes smaller than that of the light reflected on the part of the information recording surface without the pits.

The laser light beam L reflected on the information recording surface 22 is then re-converted to a nearly parallel light beam by the objective optical system 10. The reflected light beam re-converted into the nearly parallel light beam is reflected on the reflection plane 34a of the mirror 34 and guided to the beam splitter 33a. The reflected light beam is reflected again on a reflection plane provided in the beam splitter 33a and focused onto the light receiving element 38a by the detection optical system 37a. Then, an electrical signal corresponding to the amount of the focused reflected light beam is output from the light receiving element 38a to the signal processing unit 39. That is, detection is made as to whether the pits exist or not on part of the information recording surface onto which the laser light beam has been focused, and then the electrical signal corresponding to the detection result is output to the signal processing unit 39. In this manner, the information recorded on the information recording surface 22 is read out.

In order to record information on the information recording surface 22a of the first information recording medium 20a, a laser light beam L associated with the information to be recorded is emitted from the first light source 31a. In the same manner as the above-described reproduction, the emitted laser light beam L is focused onto the information recording surface 22a. Then, for example, property change occurs only on part of the information recording surface 22a irradiated with the laser light beam L having intensity higher than the predetermined level to form the pits thereon, thereby recording the information.

Hereinafter, the focusing of the laser light beam L onto the information recording surfaces 22 according to the first embodiment will be explained in detail.

The objective optical system 10 includes a diffraction element 11 made of a resin, an objective lens 12 having two aspheric lens surfaces which are substantially rotationally symmetric about the optical axis AX and a lens folder 13 for holding the diffraction element 11 and the objective lens 12. The lens folder 13 is connected to the actuator 35 for actuating the lens folder 13 and the actuator 35 is connected to the control unit 36 for controlling the actuator 35. The actuator 35 and the control unit 36 allow the diffraction element 11 and the objective lens 12 held by the lens folder 13 to move together in the focusing direction and/or tracking direction.

The diffraction element 11 is a parallel-plate element as shown in FIG. 3. A diffraction plane 15, which is nearly circular when viewed in plan, is formed in part of a surface 11a of the diffraction element 11. The diffraction plane 15 has a diameter smaller than that of the laser light beam L incident on the diffraction element 11.

The laser light beam L entered the diffraction element 11 is separated on the diffraction plane 15 of the diffraction element 11 into a plurality of diffracted lights having different diffraction orders including at least 0^{th}-order diffracted light and 1^{st} ″-order diffracted light.

The 0^{th}-order diffracted light is light which is not diffracted. If the laser light beam L is 0^{th}-order diffracted, the laser light beam L coming out of the diffraction element 11 is substantially the same as a laser light beam which does not pass through the diffraction element 11. Therefore, light from the diffraction plane 15 and light from part of the diffraction element 11 outside the diffraction plane 15 enter the objective lens 12 in the same manner. That is, the parallel light beam entered the diffraction element 11 is emitted from the diffraction element 11 without any change.

The objective lens 12 is designed such that NA (numerical aperture) with respect to the parallel light beam incident on the objective lens 12 conforms to NA of the first information recording medium 20a (0.85 when the first information recording medium 20a is a BD). Simultaneously, the objective lens 12 is designed to have optical power that allows the parallel light beam (0^{th}-order diffracted light) incident on the objective lens 12 to converge onto the information recording surface 22a of the first information recording medium 20a. Thus, the 0^{th}-order diffracted light serves as signal light for the first information recording medium 20a to record/reproduce information on/from the first information recording medium 20a.

For the second information recording medium 20b, 1^{st}-order diffracted light serves as signal light. That is, the 1^{st}-order diffracted light generated on the diffraction plane 15 of the diffraction element 11 is focused onto the information recording surface 22b of the second information recording medium 20b. As described above, the diameter of the diffraction plane 15 is smaller than the diameter of the laser light beam L. Therefore, the light beam which enters the objective lens 12 when the second information recording medium 20b is placed is smaller in diameter than the light beam incident on the objective lens 12 when the first information recording medium 20a is placed. The objective lens 12 is designed such that NA with respect to the light beam having the relatively small diameter and incident on the objective lens 12 conforms to NA of the second information recording medium 20b (0.65 when the second information recording medium 20b is a HD-DVD). Simultaneously, the objective lens 12 is designed to allow the light beam with the relatively small diameter incident on the objective lens 12 to converge onto the information recording surface 22b of the second information recording medium 20b.

Information recording on the information recording surface 22 requires a larger amount of light as compared with information reproduction from the information recording surface 22. Therefore, it is preferred that the 0^{th}-order diffracted light used as the signal light for recording information on the first information recording medium 20a has particularly high diffraction efficiency. As a matter of course, it is also preferred that the 1^{st}-order diffracted light used for reproducing information from the second information recording medium 20b has high diffraction efficiency. In this case, the information reproduction is suitably carried out with less noise.

Even if the diffraction efficiencies of the 0^{th}- and 1^{st}-order diffracted lights are set enough high, information recording/reproduction on/from each of the information recording media cannot be performed in a suitable manner, if other diffracted light than the signal light is generated in an amount relatively larger than the amount of the signal light, i.e., if a large amount of stray light is generated.

For example, light which is 0^{th}-order diffracted on the diffraction plane 15, reflected on the information recording surface 22 and then 0^{th}-order diffracted again on the diffraction plane 15 (signal light for the first information recording medium 20a) and light which is +1^{st}-order diffracted on the diffraction plane 15, reflected on the information recording surface 22 and then −1^{st}-order diffracted again on the diffraction plane 15 form an image on the same position of the light receiving element 38a. Further, light which is −1^{st}-order diffracted on the diffraction plane 15, reflected on the information recording surface 22 and then +1^{st}-order diffracted again on the diffraction plane 15 also forms an image on the same position of the light receiving element 38a. On the other hand, light which is +1^{st}-order diffracted on the diffraction plane 15, reflected on the information recording surface 22 and then +1^{st}-order diffracted again on the diffraction plane 15 (signal light for the second information recording medium 20b) and light which is 0^{th}-order diffracted on the diffraction plane 15, reflected on the information recording surface 22 and then +2^{nd}-order diffracted again on the diffraction plane 15 form an image on the same position of the light receiving element 38a. Further, light which is +2^{nd}-order diffracted on the diffraction plane 15, reflected on the information recording surface 22 and then 0^{th}-order diffracted again on the diffraction plane 15 also forms an image on the same position of the light receiving element 38a. That is, if the lights traveling between the first light source 31a and the light receiving element 38a have the same sum of diffraction orders, each of the lights forms an image on the same position of the light receiving element 38a. Hereinafter, light which is m^{th}-order (m is an integer) diffracted on the diffraction plane 15, reflected on the information recording surface 22 and then n^{th}-order (n is an integer) diffracted again on the diffraction plane 15 is referred to as “(m, n) diffracted light”.

Therefore, even if the diffraction efficiency of the 0^{th}-order diffracted light is set high enough, the ratio of stray light to the 0^{th}-order diffracted light (hereinafter referred to as 0^{th}-order/stray light ratio) is increased when the diffraction efficiency of the +1^{st}-order diffracted light and/or the diffraction efficiency of the −1^{st}-order diffracted light is high. As a result, information recording/reproduction on/from the first information recording medium 20a cannot be performed in an appropriate manner.

That is, for appropriate information recording/reproduction on/from the first information recording medium 20a and appropriate information reproduction from the second information recording medium 20b, it is necessary to set the diffraction efficiency of the 0^{th}-order diffracted light extremely high, the diffraction efficiency of the 1^{st}-order diffracted light high and the 0^{th}-order/stray light ratio and the 1^{st}-order/stray light ratio low.

In consideration of the above, according to the first embodiment of the invention, the diffraction efficiency of the 0^{th}-order diffracted light serving as the signal light for recording/reproducing information on/from the first information recording medium 20a is set relatively high. At the same time, the diffraction efficiency of the 0^{th}-order diffracted light is set higher than that of the 1^{st}-order diffracted light. That is, the objective optical system 10 is configured to meet the following conditional expression (1):

η₀>η₁ (1)

wherein η₀ is the diffraction efficiency of the 0^{th}-order diffracted light separated from the laser light beam L on the diffraction plane 15 and η₁ is the diffraction efficiency of the 1^{st}-order diffracted light separated from the laser light beam L on the diffraction plane 15.

Thus, the ratio of the amount of the stray light, i.e., the (+1, −1) diffracted light or the (−1, +1) diffracted light, to the amount of the (0, 0) diffracted light as the signal light becomes relatively low. In other words, the 0^{th}-order/stray light ratio is reduced. This makes it possible to perform appropriate information recording/reproduction on/from the first information recording medium 20a. From the aspect of reduction of the 0^{th}-order/stray light ratio to a further extent, the objective optical system 10 is preferably configured to meet the following conditional expression (1-b), more preferably (1-a):

η₀>2η₁ (1-b)

η₀>>η₁ (1-a)

wherein η₀ is the diffraction efficiency of the 0^{th}-order diffracted light separated from the laser light beam L on the diffraction plane 15 and η₁ is the diffraction efficiency of the 1^{st}-order diffracted light separated from the laser light beam L on the diffraction plane 15.

In the present specification, “η₀>>η₁” indicates that η₀ is considerably higher, for example, twice or more higher, or three times or more higher, than η₁.

Further, from the aspect of reduction of the diffraction efficiencies of the (+1, −1) and (−1, +1) diffracted lights so as to reduce the 0^{th}-order/stray light ratio to a further extent, the objective optical system 10 is configured to meet the above-described conditional expression (1), preferably (1-b), more preferably (1-a), and the following conditional expression (1-c), preferably (1-e), more preferably (1-d):

η₀>η₋₁ (1-c)

η₀>2η₋₁ (1-e)

η₀>>η₋₁ (1-d)

wherein η₀ is the diffraction efficiency of the 0^{th}-order diffracted light separated from the laser light beam L on the diffraction plane 15 and η₋₁ is the diffraction efficiency of the −1^{st}-order diffracted light separated from the laser light beam L on the diffraction plane 15.

In the present specification, “η₀>>η₋₁” indicates that η₀ is considerably higher, for example, twice or more higher, or three times or more higher, than η₋₁.

More specifically, the objective optical system 10 is preferably configured to meet the following conditional expressions (3) and (4). Further, the objective optical system 10 preferably meets the conditional expressions (3-a) and (3-b), more preferably (4-a):

η₀>60% (3)

η₀>65% (3-a)

η₀>67% (3-b)

η₁>10% (4)

η₁>12% (4-a)

wherein η₀ is the diffraction efficiency of the 0^{th}-order diffracted light separated from the laser light beam L on the diffraction plane 15 and η₁ is the diffraction efficiency of the 1^{st}-order diffracted light separated from the laser light beam L on the diffraction plane 15.

As described above, a main cause of the increase of the 0^{th}-order/stray light ratio is the (+1, −1) and (−1, +1) diffracted lights. However, other diffracted lights than these, for example, diffracted light whose diffraction orders are summed up to 0, may also increase the 0^{th}-order/stray light ratio. For example, (+2, −2) and (−2, +2) diffracted lights can also be the cause of the increase of the 0^{th}-order/stray light ratio. From this aspect, the objective optical system 10 preferably meets the following conditional expression (2), more preferably (2-b), even more preferably (2-a):

η₀>ηₘ (2)

η₀>2ηₘ (2-b)

η₀>>ηₘ (2-a)

wherein η₀ is the diffraction efficiency of the 0^{th}-order diffracted light separated from the laser light beam L on the diffraction plane 15 and ηₘ is the diffraction efficiency of m^{th}-order diffracted light separated from the laser light beam L on the diffraction plane 15 (m is an integer other than 0).

In the present specification, “η₀>>ηₘ” indicates that 10 is considerably higher, for example, twice or more higher, or three times or more higher, than ηₘ.

For appropriate reproduction of information recorded on the second information recording medium 20b, it is also necessary to reduce the ratio of stray light to the 1^{st}-order diffracted light (hereinafter referred to as 1^{st}-order/stray light ratio). A main cause of the increase of the 1^{st}-order/stray light ratio is (0, +2) and (+2, 0) diffracted lights. However, according to the first embodiment, the diffraction efficiency of the 0^{th}-order diffracted light is set enough high for the purpose of appropriate information recording/reproduction on/from the first information recording medium 20a. Therefore, the amounts of the (0, +2) and (+2, 0) diffracted lights become relatively large. Accordingly, it is preferable to set the diffraction efficiency of the 2^{nd}-order diffracted light considerably low. Specifically, the diffraction efficiency of the 2^{nd}-order diffracted light is preferably lower than 1%, more preferably lower than 0.5%.

The 1^{st}-order/stray light ratio is also reduced by other diffracted light than the (0, +2) and (+2, 0) diffracted lights, e.g., diffracted light whose diffraction orders are summed up to 2. Therefore, the objective optical system 10 is preferably configured to meet the following conditional expression (2-c), more preferably (2-d), even more preferably (2-e):

η₀>η₁>ηₘ (2-c)

η₀>2η₁>2ηₘ (2-d)

η₀>>η₁>>ηₘ (2-e)

wherein η₀ is the diffraction efficiency of the 0^{th}-order diffracted light separated from the laser light beam L on the diffraction plane 15, η₁ is the diffraction efficiency of the 1^{st}-order diffracted light separated from the laser light beam L on the diffraction plane 15 and ηₘ is the diffraction efficiency of m^{th}-order diffracted light separated from the laser light beam L on the diffraction plane 15 (m is an integer other than 0 and 1).

Especially for the purpose of reducing the 0^{th}-order/stray light ratio, the objective optical system 10 preferably meets the following conditional expression (5), more preferably (5-a). The conditional expressions (5) and (5-a) indicate a preferable range of the ratio of the sum of the diffraction efficiencies of the (+1, −1) and (−1, +1) diffracted lights with respect to the diffraction efficiency of the (0, 0) diffracted light:

2×(η₁×η₋₁)/(η₀²)<0.15 (5)

2×(η₁×η₋₁)/(η₀²)<0.10 (5-a)

wherein η₀ is the diffraction efficiency of the 0^{th}-order diffracted light separated from the laser light beam L on the diffraction plane 15, η₁ is the diffraction efficiency of the 1^{st}-order diffracted light separated from the laser light beam L on the diffraction plane 15 and η₋₁ is the diffraction efficiency of the −1^{st}-order diffracted light separated from the laser light beam L on the diffraction plane 15.

Especially for the purpose of reducing the 1^{st}-order/stray light ratio, the objective optical system 10 preferably meets the following conditional expression (6), more preferably (6-a). The conditional expressions (6) and (6-a) indicate a preferable range of the ratio of the sum of the diffraction efficiencies of the (0, +2) and (+2, 0) diffracted lights with respect to the diffraction efficiency of the (+1, +1) diffracted light:

2×(η₀×η₂)/(η₁²)<0.15 (6)

2×(η₀×η₂)/(η₁²)<0.10 (6-a)

wherein η₀ is the diffraction efficiency of the 0^{th}-order diffracted light separated from the laser light beam L on the diffraction plane 15, η₁ is the diffraction efficiency of the 1^{st}-order diffracted light separated from the laser light beam L on the diffraction plane 15 and η₂ is the diffraction efficiency of the 2^{nd}-order diffracted light separated from the laser light beam L on the diffraction plane 15.

The diffraction plane 15 is configured such that the optical power with respect to the 1^{st}-order diffracted light will be positive or negative, i.e., not to be zero, thereby focusing the 0^{th}- and 1^{st}-order diffracted lights onto different positions from each other. With this configuration, spherical aberration derived from difference in thickness between the protective layer 21a of the first information recording medium 20a and the protective layer 21b of the second information recording medium 20b is cancelled. If the optical power of the diffraction plane 15 with respect to the 1^{st}-order diffracted light is set positive, chromatic aberration that occurs when the wavelength of the laser light beam L emitted from the first light source 31a is varied in response to ambient temperature or the like is suitably corrected. On the other hand, if the optical power of the diffraction plane 15 with respect to the 1^{st}-order diffracted light is set negative, working distance during the reproduction of information from the second information recording medium 20b (distance between the second information recording medium 20b and the objective lens 12) is increased.

The optical power of the diffraction plane 15 with respect to the 0^{th}-order diffracted light may be either positive or negative. If the optical power of the diffraction plane 15 with respect to the 0^{th}-order diffracted light is set positive, chromatic aberration that occurs when the wavelength of the laser light beam L emitted from the first light source 31a is varied in response to ambient temperature or the like is suitably corrected. On the other hand, if the optical power of the diffraction plane 15 with respect to the 0^{th}-order diffracted light is set negative, working distance during the reproduction of information from the first information recording medium 20a (distance between the first information recording medium 20a and the objective lens 12) is increased.

The objective lens 12 and the diffraction element 11 are actuated by the actuator 35 together with the lens folder 13 such that the laser light beam is focused onto each of the information recording surfaces 22a and 22b of the information recording media 20a and 20b.

Now, the shape of the diffraction plane 15 of the diffraction element 11 will be explained in detail with reference to FIGS. 3 and 4.

In order to set the diffraction efficiency of the 0^{th}-order diffracted light high and the diffraction efficiency of other diffracted lights than the 0^{th}-order diffracted light relatively low as described above, the diffraction plane 15 is preferably relief-engraved, i.e., configured to include a plurality of annular convex portions 16 which are arranged concentrically and periodically and have a nearly triangular cross section with a vertex 16c having an obtuse vertex angle (preferable 150° or larger), respectively, as shown in FIG. 4. In the present specification, the expression “nearly triangular” indicates a triangular shape with one or both of two sides being curved (e.g., parabolic), such as a dome shape, and a triangular shape with a chamfered or rounded vertex.

For example, a diffraction plane according to Patent Literatures 1 and 2 includes periodically arranged convex portions each having a nearly triangular cross section with a vertex angle as relatively small as less than 100°. It is relatively difficult to form such a diffraction plane. In order to provide the convex portions with vertexes having high form accuracy by a cutting technique, the size of a cutting tool must be relatively smaller than the pitch of the convex portions. Therefore, machining time is prolonged and cost is increased.

According to the first embodiment, in contrast, each of the convex portions periodically arranged on the diffraction plane 15 has a considerably large vertex angle as described above. Therefore, it is relatively easy to form the diffraction plane. Further, even if the size of the cutting tool is relatively large, the convex portions are provided with the vertexes having high form accuracy. Thus, the machining time for the diffraction plane 15 is reduced and the cost is also reduced. As a result, the objective optical system 10 and the optical pickup 1 are achieved with reduced cost.

According to the first embodiment described above, information recording/reproduction on/from the first information recording medium 20a is appropriately performed and information reproduction from the second information recording medium 20b, to which a laser light beam having substantially the same wavelength as the wavelength of the laser light beam used for the first information recording medium 20a is applied, is appropriately performed. Further, the optical pickup 1 is obtained in an easy and low-cost manner.

Each of the diffraction efficiencies of the diffraction lights having different diffraction orders can be adjusted by changing a vertex position and the height of the convex portion 16 to the laser light beam L, i.e., h/{λ(n−1)} (hereinafter indicated as y on the assumption that y=h/{λ/(n−1)}). Provided that the diffraction plane 15 has negative optical power, the vertex position is the ratio of a distance between part of the convex portion 16 closest to the optical axis AX and the vertex 16c of the convex portion 16 [(x/100)×p] with respect to the pitch p of the convex portions 16 on the cross section of the diffraction plane 15 including the optical axis AX (see FIG. 4 illustrating the diffraction plane 15 having the negative optical power). On the other hand, when the diffraction plane 15 has positive optical power, the vertex position is the ratio (%) of a distance between part of the convex portion 16 farthest from the optical axis AX and the vertex 16c of the convex portion 16 with respect to the pitch of the convex portions 16. Hereinafter, the vertex position may be referred to as x. Symbol h indicates the height of the convex portion 16 in the optical axis direction, λ indicates the wavelength of the laser light beam L and n indicates the refractive index of the diffraction element 11 corresponding to the wavelength of the laser light beam L.

Table 1 shows correlation among the vertex position x, the value y and the diffraction efficiencies of the 1^{st}- and 0^{th}-order diffracted lights.

TABLE 1

| | | VERTEX POSITION x (%) | | | | | | | | | | | | | | | |
|---|---|---|---|---|---|---|---|---|---|---|---|---|---|---|---|---|---|
| | | 55 | | 58 | | 60 | | 65 | | 70 | | 72 | | 75 | | 77 | |
| | | η1 | η0 | η1 | η0 | η1 | η0 | η1 | η0 | η1 | η0 | η1 | η0 | η1 | η0 | η1 | η0 |
| y | 0.24 | 8.7 | 82.4 | 8.9 | 82.4 | 9.0 | 82.4 | 9.2 | 82.4 | 9.3 | 82.4 | 9.4 | 82.4 | 9.4 | 82.4 | 9.3 | 82.4 |
| | 0.25 | 9.4 | 81.0 | 9.6 | 81.0 | 9.7 | 81.0 | 10.0 | 81.0 | 10.1 | 81.0 | 10.1 | 81.0 | 10.2 | 81.0 | 10.1 | 81.0 |
| | 0.26 | 10.1 | 79.6 | 10.3 | 79.6 | 10.5 | 79.6 | 10.7 | 79.6 | 10.9 | 79.6 | 11.0 | 79.6 | 11.0 | 79.6 | 11.0 | 79.6 |
| | 0.27 | 10.8 | 78.2 | 11.1 | 78.2 | 11.2 | 78.2 | 11.5 | 78.2 | 11.7 | 78.2 | 11.8 | 78.2 | 11.8 | 78.2 | 11.8 | 78.2 |
| | 0.28 | 11.5 | 76.7 | 11.8 | 76.7 | 12.0 | 76.7 | 12.3 | 76.7 | 12.6 | 76.7 | 12.7 | 76.7 | 12.7 | 76.7 | 12.7 | 76.7 |
| | 0.29 | 12.3 | 75.2 | 12.6 | 75.2 | 12.8 | 75.2 | 13.2 | 75.2 | 13.5 | 75.2 | 13.5 | 75.2 | 13.6 | 75.2 | 13.7 | 75.2 |
| | 0.3 | 13.0 | 73.6 | 13.3 | 73.6 | 13.6 | 73.6 | 14.0 | 73.6 | 14.4 | 73.6 | 14.4 | 73.6 | 14.6 | 73.6 | 14.6 | 73.6 |
| | 0.31 | 13.7 | 72.1 | 14.1 | 72.1 | 14.4 | 72.1 | 14.9 | 72.1 | 15.3 | 72.1 | 15.4 | 72.1 | 15.5 | 72.1 | 15.6 | 72.1 |
| | 0.32 | 14.5 | 70.5 | 14.9 | 70.5 | 15.2 | 70.5 | 15.8 | 70.5 | 16.2 | 70.5 | 16.3 | 70.5 | 16.5 | 70.5 | 16.6 | 70.5 |
| | 0.33 | 15.3 | 68.9 | 15.7 | 68.9 | 16.0 | 68.9 | 16.6 | 68.9 | 17.1 | 68.9 | 17.3 | 68.9 | 17.5 | 68.9 | 17.6 | 68.9 |
| | 0.34 | 16.0 | 67.3 | 16.5 | 67.3 | 16.8 | 67.3 | 17.5 | 67.3 | 18.1 | 67.3 | 18.3 | 67.3 | 18.5 | 67.3 | 18.6 | 67.3 |
| | 0.35 | 16.8 | 65.6 | 17.3 | 65.6 | 17.7 | 65.6 | 18.5 | 65.6 | 19.1 | 65.6 | 19.3 | 65.6 | 19.5 | 65.6 | 19.7 | 65.6 |
| | 0.36 | 17.5 | 64.0 | 18.2 | 64.0 | 18.5 | 64.0 | 19.4 | 64.0 | 20.1 | 64.0 | 20.3 | 64.0 | 20.6 | 64.0 | 20.7 | 64.0 |
| | 0.37 | 18.3 | 62.3 | 19.0 | 62.3 | 19.4 | 62.3 | 20.3 | 62.3 | 21.1 | 62.3 | 21.3 | 62.3 | 21.6 | 62.3 | 21.8 | 62.3 |
| | 0.38 | 19.1 | 60.6 | 19.8 | 60.6 | 20.2 | 60.6 | 21.2 | 60.6 | 22.1 | 60.6 | 22.4 | 60.6 | 22.7 | 60.6 | 22.9 | 60.6 |

Table 1 indicates that each of the diffraction efficiencies of the diffracted lights having different diffraction orders can be adjusted by changing the vertex position x and the value y. As shown in Table 1, the diffraction plane 15 that satisfies the conditional expressions (3-a) and (4) specifying the preferred diffraction efficiencies is obtained if the diffraction plane 15 is configured to meet the conditional expression (9) when 55<vertex position x≦60, the conditional expression (10) when 60≦vertex position x≦65 and the conditional expression (11) when 65≦vertex position x<77:

η₀>65% (3-a)

η₁>10% (4)

0.26≦y≦0.35 (9)

−0.002x+0.38≦y≦0.35 (10)

0.25≦y≦0.35 (11)

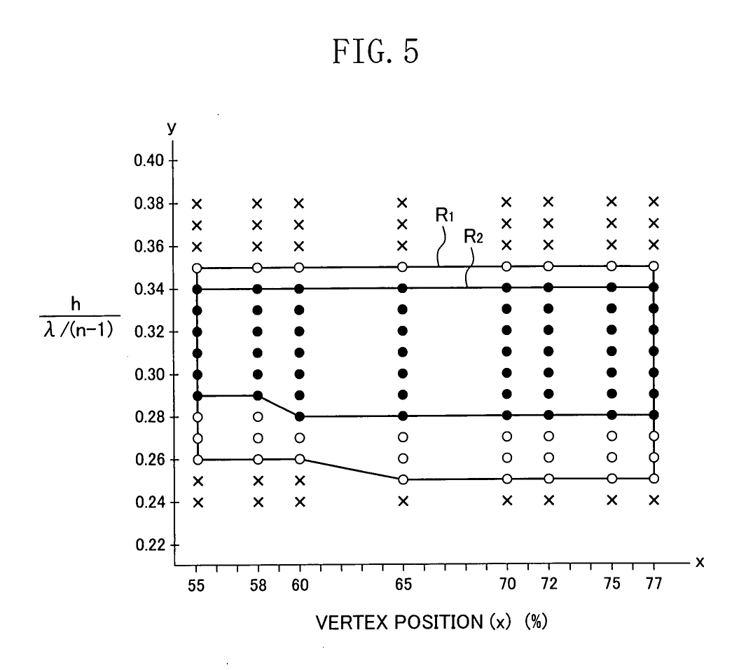

Specifically, the diffraction plane 15 that satisfies the conditional expressions (3-a) and (4) is obtained when the values x and y are within a region R₁ shown in FIG. 5. In FIG. 5, symbol x indicates that at least one of the conditional expressions (3-a) and (4) is not satisfied. Symbols ∘ and • indicate that both of the conditional expressions (3-a) and (4) are satisfied. More specifically, symbol • indicates that the conditional expressions (3-b) and (4-a) are also satisfied.

Further, as shown in Table 1, the diffraction plane 15 that satisfies the conditional expressions (3-b) and (4-a) specifying the preferred diffraction efficiencies is obtained if the diffraction plane 15 is configured to meet the conditional expression (9-a) when 55<vertex position x≦58, the conditional expression (10-a) when 58≦vertex position x≦60 and the conditional expression (11-a) when 60≦vertex position x≦77:

η₀>67% (3-b)

η₁>12% (4-a)

0.29≦y≦0.34 (9-a)

−0.005x+0.58≦y≦0.34 (10-a)

0.28≦y≦0.34 (11-a)

Specifically, the diffraction plane 15 that satisfies the conditional expressions (3-b) and (4-a) is obtained when the values x and y are within a region R₂ shown in FIG. 5.

Thus, as described above, each of the diffraction efficiencies of the diffracted lights having different diffraction orders are adjusted by changing the vertex position x and the value y. Therefore, the 0^{th}-order/stray light ratio and the 1^{st}-order/stray light ratio are also adjusted by changing the vertex position x and the value y.

Table 2 shows correlation among the vertex position x, the value y, the 1^{st}-order/stray light ratio and the 0^{th}-order/stray light ratio.

TABLE 2

| | | VERTEX POSITION x (%) | | | | | | | |
|---|---|---|---|---|---|---|---|---|---|
| | | 55 | | 58 | | 60 | | 65 | |
| | | +1st- | 0th- | +1st- | 0th- | +1st- | 0th- | +1st- | 0th- |
| | | ORDER/ | ORDER/ | ORDER/ | ORDER/ | ORDER/ | ORDER/ | ORDER/ | ORDER/ |
| | | STRAY | STRAY | STRAY | STRAY | STRAY | STRAY | STRAY | STRAY |
| | | LIGHT | LIGHT | LIGHT | LIGHT | LIGHT | LIGHT | LIGHT | LIGHT |
| | | RATIO | RATIO | RATIO | RATIO | RATIO | RATIO | RATIO | RATIO |
| y | 0.24 | 23.7 | 2.1 | 8.3 | 2.0 | 2.0 | 2.0 | 3.9 | 1.9 |
| | 0.25 | 25.6 | 2.5 | 8.8 | 2.4 | 3.4 | 2.4 | 3.3 | 2.3 |
| | 0.26 | 26.5 | 2.9 | 10.4 | 2.9 | 2.9 | 2.8 | 1.4 | 2.7 |
| | 0.27 | 26.8 | 3.5 | 11.5 | 3.4 | 5.0 | 3.3 | 1.2 | 3.2 |
| | 0.28 | 27.7 | 4.1 | 12.1 | 4.0 | 5.3 | 3.9 | 0.0 | 3.7 |
| | 0.29 | 29.1 | 4.8 | 13.3 | 4.7 | 6.5 | 4.6 | 0.0 | 4.4 |
| | 0.3 | 29.7 | 5.5 | 14.1 | 5.5 | 7.2 | 5.4 | 0.0 | 5.1 |
| | 0.31 | 30.5 | 6.5 | 15.2 | 6.3 | 8.4 | 6.3 | 0.0 | 6.0 |
| | 0.32 | 31.6 | 7.5 | 16.5 | 7.4 | 9.2 | 7.2 | 0.0 | 6.9 |
| | 0.33 | 32.0 | 8.6 | 16.7 | 8.5 | 9.7 | 8.4 | 0.5 | 8.0 |
| | 0.34 | 32.5 | 9.9 | 17.7 | 9.8 | 10.4 | 9.6 | 0.9 | 9.2 |
| | 0.35 | 33.1 | 11.4 | 18.4 | 11.2 | 11.3 | 11.1 | 1.2 | 10.5 |
| | 0.36 | 33.7 | 13.1 | 19.0 | 12.9 | 11.9 | 12.7 | 1.7 | 12.0 |
| | 0.37 | 33.8 | 15.0 | 19.8 | 14.7 | 12.6 | 14.5 | 2.1 | 13.8 |
| | 0.38 | 34.3 | 17.1 | 20.4 | 16.8 | 13.3 | 16.6 | 2.4 | 15.7 |
| | | VERTEX POSITION x (%) | | | | | | | |
| | | 70 | | 72 | | 75 | | 77 | |
| | | +1st- | 0th- | +1st- | 0th- | +1st- | 0th- | +1st- | 0th- |
| | | ORDER/ | ORDER/ | ORDER/ | ORDER/ | ORDER/ | ORDER/ | ORDER/ | ORDER/ |
| | | STRAY | STRAY | STRAY | STRAY | STRAY | STRAY | STRAY | STRAY |
| | | LIGHT | LIGHT | LIGHT | LIGHT | LIGHT | LIGHT | LIGHT | LIGHT |
| | | RATIO | RATIO | RATIO | RATIO | RATIO | RATIO | RATIO | RATIO |
| y | 0.24 | 26.5 | 1.8 | 41.5 | 1.7 | 67.9 | 1.6 | 86.9 | 1.6 |
| | 0.25 | 22.2 | 2.1 | 34.7 | 2.0 | 56.6 | 1.9 | 74.1 | 1.9 |
| | 0.26 | 17.4 | 2.5 | 27.9 | 2.4 | 47.5 | 2.3 | 63.4 | 2.2 |
| | 0.27 | 13.6 | 3.0 | 22.5 | 2.9 | 40.2 | 2.7 | 53.5 | 2.6 |
| | 0.28 | 10.7 | 3.5 | 18.2 | 3.4 | 34.2 | 3.2 | 46.4 | 3.1 |
| | 0.29 | 8.3 | 4.1 | 14.8 | 3.9 | 28.4 | 3.7 | 38.7 | 3.6 |
| | 0.3 | 6.4 | 4.8 | 12.0 | 4.6 | 23.7 | 4.4 | 33.2 | 4.2 |
| | 0.31 | 5.0 | 5.5 | 9.8 | 5.3 | 19.8 | 5.0 | 28.0 | 4.8 |
| | 0.32 | 3.2 | 6.4 | 7.4 | 6.2 | 16.6 | 5.8 | 24.2 | 5.6 |
| | 0.33 | 2.3 | 7.4 | 6.0 | 7.2 | 13.5 | 6.7 | 20.1 | 6.5 |
| | 0.34 | 1.6 | 8.5 | 4.4 | 8.2 | 11.4 | 7.8 | 17.1 | 7.4 |
| | 0.35 | 1.1 | 9.8 | 3.5 | 9.4 | 9.3 | 8.9 | 14.3 | 8.5 |
| | 0.36 | 0.6 | 11.2 | 2.5 | 10.8 | 7.5 | 10.2 | 11.9 | 9.7 |
| | 0.37 | 0.3 | 12.8 | 1.9 | 12.3 | 6.1 | 11.6 | 9.9 | 11.1 |
| | 0.38 | 0.2 | 14.6 | 1.2 | 14.1 | 4.7 | 13.2 | 8.3 | 12.7 |

As shown in Table 2, the diffraction plane 15 that satisfies the conditional expressions (5) and (6) specifying the preferable stray ratios is obtained if the diffraction plane 15 is configured to meet the conditional expression (13) when 58≦vertex position x≦60, the conditional expression (14) when 60≦vertex position x≦65, the conditional expression (15) when 65<vertex position x<70, the conditional expression (16) when 70≦vertex position x≦72, the conditional expression (17) when 72≦vertex position x≦75 and the conditional expression (18) when 75≦vertex position x≦77.

2×(η₁×η₋₁)/(η₀²)<0.15 (5)

2×(η₀×η₂)/(η₁²)<0.15 (6)

0.24≦y≦0.035x−1.73 (13)

0.24≦y≦0.37 (14)

(0.03/5)x−0.15≦y≦0.002x+0.24 (15)

0.01x−0.43≦y≦0.38 (16)

(0.04/3)x−0.67≦y≦0.38 (17)

0.01x−0.42≦y≦0.38 (18)

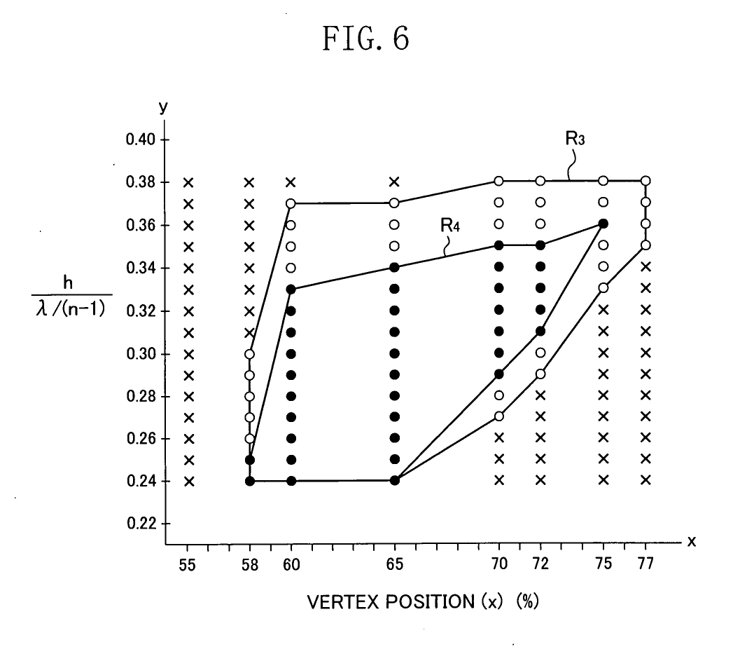

Specifically, the diffraction plane 15 that satisfies the conditional expressions (5) and (6) specifying the preferable stray light ratios is obtained when the values x and y are within a region R₃ shown in FIG. 6. In FIG. 6, symbol x indicates that at least one of the conditional expressions (5) and (6) is not satisfied. Symbols ∘ and • indicate that both of the conditional expressions (5) and (6) are satisfied. More specifically, symbol • indicates that the conditional expressions (5-a) and (6-a) are also satisfied.

Further, as shown in Table 2, the diffraction plane 15 that satisfies the conditional expressions (5-a) and (6-a) specifying the preferred diffraction efficiencies is obtained if the diffraction plane 15 is configured to meet the conditional expression (13-a) when 58≦vertex position x≦60, the conditional expression (14-a) when 60≦vertex position x≦65, the conditional expression (15-a) when 65≦vertex position x≦70, the conditional expression (16-a) when 70≦vertex position x≦72 and the conditional expression (17-a) when 72≦vertex position x≦75.

2×(η₁×η₋₁)/(η₀²)<0.10 (5-a)

2×(η₀×η₂)/(η₁²)<0.10 (6-a)

0.24≦y≦0.04x−2.07 (13-a)

0.24≦y≦0.002x+0.21 (14-a)

0.01x−0.41≦y≦0.002x+0.21 (15-a)

0.01x−0.41≦y≦0.35 (16-a)

(0.01/3)x+0.11≦y≦(0.05/3)x−0.89 (17-a)

Specifically, the diffraction plane 15 that satisfies the conditional expressions (5-a) and (6-a) specifying the preferred diffraction efficiencies is obtained when the values x and y are within a region R₄ shown in FIG. 6.

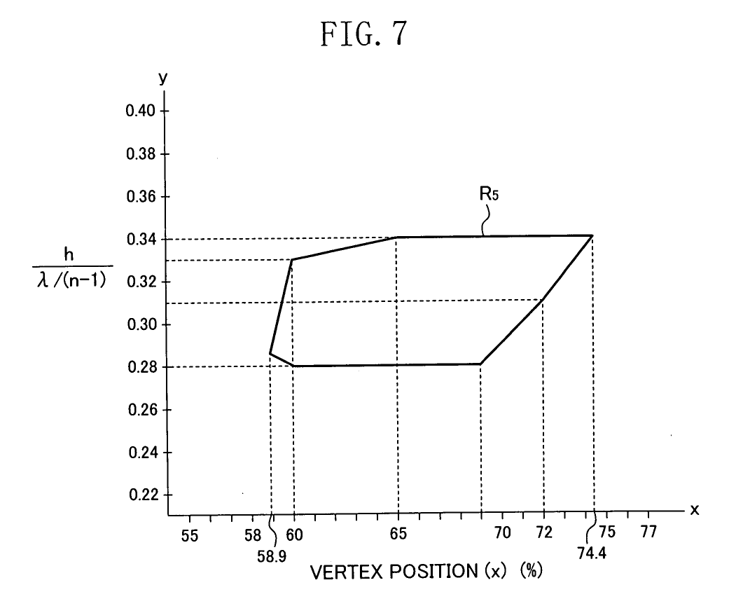

Thus, as described above, the diffraction plane 15 that satisfies the conditional expressions (3-a) and (4) specifying the preferred diffraction efficiencies and the conditional expressions (5-a) and (6-a) specifying the preferred diffraction efficiencies is obtained when the values x and y are within a region R₅ shown in FIG. 7.

Tables 3 to 18 show detailed correlation among the vertex position x, the value y, the diffraction efficiencies and the stray ratios of the diffracted lights having different diffraction orders.

Data shown in Tables 3 to 6 are obtained under the following conditions.

Refractive index of the diffraction element 11 to 408 nm wavelength: 1.626969

Refractive index of the diffraction element 11 to 670 nm wavelength: 1.605945

Refractive index of the diffraction element 11 to 780 nm wavelength: 1.602489

Material of the diffraction element 11: glass

Data shown in Tables 7 to 10 are obtained under the following conditions.

Refractive index of the diffraction element 11 to 408 nm wavelength: 1.558358

Refractive index of the diffraction element 11 to 670 nm wavelength: 1.539132

Refractive index of the diffraction element 11 to 780 nm wavelength: 1.536028

Material of the diffraction element 11: resin

Data shown in Tables 11 to 14 are obtained under the following conditions.

Refractive index of the diffraction element 11 to 408 nm wavelength: 1.523913

Refractive index of the diffraction element 11 to 670 nm wavelength: 1.505697

Refractive index of the diffraction element 11 to 780 nm wavelength: 1.503026

Material of the diffraction element 11: resin

Data shown in Tables 15 to 18 are obtained under the following conditions.

Refractive index of the diffraction element 11 to 408 nm wavelength: 1.782785

Refractive index of the diffraction element 11 to 670 nm wavelength: 1.749315

Refractive index of the diffraction element 11 to 780 nm wavelength: 1.744061

Material of the diffraction element 11: glass

Data shown in Tables 3, 7, 11 and 15 are obtained when the vertex position x is 55%. Data shown in Tables 4, 8, 12 and 16 are obtained when the vertex position x is 60%. Data shown in Tables 5, 9, 13 and 17 are obtained when the vertex position x is 70%. Data shown in Tables 6, 10, 14 and 18 are obtained when the vertex position x is 75%.

Data of Tables 3 to 18 are obtained on the assumption that the diffraction plane 15 has negative optical power.

TABLE 3

| | | | | | | | | | STRAY LIGHT | |
|---|---|---|---|---|---|---|---|---|---|---|
| | R OF | PITCH OF | DIFFRACTION EFFICIENCY | | | | | | RATIO | |
| | VERTEX | ANNULAR | WAVELENGTH 408 nm | | | | 670 nm | 780 nm | 1st- | 0th- |
| | 16c | CONVEX | 2nd- | 1st- | 0th- | −1st- | 0th- | 0th- | ORDER | ORDER |
| y | (μm) | PORTIONS | ORDER(%) | ORDER(%) | ORDER(%) | ORDER(%) | ORDER(%) | ORDER(%) | (%) | (%) |
| 0.26 | 0 | | 0.2 | 10.1 | 79.6 | 9.2 | 92.5 | 94.5 | 26.5 | 2.9 |
| | 5 | 50 | 0.2 | 10.1 | 79.6 | 9.2 | 92.5 | 94.5 | 26.5 | 2.9 |
| | | 10 | 0.2 | 10.1 | 79.7 | 9.1 | 92.5 | 94.5 | 26.6 | 2.9 |
| | | 5 | 0.2 | 9.8 | 80.2 | 9.0 | 92.8 | 94.7 | 24.9 | 2.7 |
| | 10 | 50 | 0.2 | 10.1 | 79.6 | 9.2 | 92.5 | 94.5 | 26.5 | 2.9 |
| | | 10 | 0.2 | 10.0 | 79.8 | 9.1 | 92.6 | 94.5 | 25.3 | 2.9 |
| | | 5 | 0.2 | 9.0 | 81.9 | 8.3 | 93.4 | 95.2 | 30.2 | 2.2 |
| 0.28 | 0 | | 0.2 | 11.5 | 76.7 | 10.4 | 91.4 | 93.6 | 27.7 | 4.1 |
| | 5 | 50 | 0.2 | 11.5 | 76.7 | 10.4 | 91.4 | 93.6 | 27.7 | 4.1 |
| | | 10 | 0.2 | 11.5 | 76.7 | 10.3 | 91.4 | 93.7 | 27.9 | 4.0 |
| | | 5 | 0.2 | 11.2 | 77.5 | 10.1 | 91.7 | 93.9 | 27.3 | 3.8 |
| | 10 | 50 | 0.2 | 11.5 | 76.7 | 10.4 | 91.4 | 93.6 | 27.7 | 4.1 |
| | | 10 | 0.2 | 11.4 | 76.9 | 10.3 | 91.5 | 93.7 | 28.3 | 4.0 |
| | | 5 | 0.2 | 10.1 | 79.5 | 9.4 | 92.5 | 94.5 | 32.5 | 3.0 |
| 0.30 | 0 | | 0.3 | 13.0 | 73.6 | 11.6 | 90.1 | 92.7 | 29.7 | 5.5 |
| | 5 | 50 | 0.3 | 13.0 | 73.6 | 11.6 | 90.1 | 92.7 | 29.7 | 5.5 |
| | | 10 | 0.3 | 13.0 | 73.7 | 11.6 | 90.2 | 92.8 | 29.8 | 5.5 |
| | | 5 | 0.3 | 12.6 | 74.6 | 11.3 | 90.6 | 93.0 | 29.3 | 5.1 |
| | 10 | 50 | 0.3 | 13.0 | 73.6 | 11.6 | 90.1 | 92.7 | 29.7 | 5.5 |
| | | 10 | 0.3 | 12.9 | 73.9 | 11.5 | 90.3 | 92.8 | 29.4 | 5.4 |
| | | 5 | 0.3 | 11.2 | 77.2 | 10.3 | 91.6 | 93.8 | 35.5 | 3.9 |
| 0.32 | 0 | | 0.5 | 14.5 | 70.5 | 12.8 | 88.8 | 91.8 | 31.6 | 7.5 |
| | 5 | 50 | 0.5 | 14.5 | 70.5 | 12.8 | 88.8 | 91.8 | 31.6 | 7.5 |
| | | 10 | 0.5 | 14.5 | 70.6 | 12.8 | 88.9 | 91.8 | 31.1 | 7.4 |
| | | 5 | 0.4 | 14.0 | 71.8 | 12.5 | 89.4 | 92.2 | 30.2 | 6.8 |
| | 10 | 50 | 0.5 | 14.5 | 70.5 | 12.8 | 88.8 | 91.8 | 31.6 | 7.5 |
| | | 10 | 0.5 | 14.4 | 70.8 | 12.7 | 89.0 | 91.9 | 30.9 | 7.3 |
| | | 5 | 0.4 | 12.3 | 75.0 | 11.3 | 90.7 | 93.1 | 37.5 | 5.0 |
| 0.34 | 0 | | 0.6 | 16.0 | 67.3 | 14.0 | 87.5 | 90.7 | 32.5 | 9.9 |
| | 5 | 50 | 0.6 | 16.0 | 67.3 | 14.0 | 87.5 | 90.7 | 32.5 | 9.9 |
| | | 10 | 0.6 | 16.0 | 67.4 | 14.0 | 87.5 | 90.8 | 32.2 | 9.9 |
| | | 5 | 0.5 | 15.4 | 68.8 | 13.7 | 88.1 | 91.2 | 31.4 | 8.9 |
| | 10 | 50 | 0.6 | 16.0 | 67.3 | 14.0 | 87.5 | 90.7 | 32.5 | 9.9 |
| | | 10 | 0.6 | 15.9 | 67.7 | 14.0 | 87.7 | 90.9 | 31.8 | 9.7 |
| | | 5 | 0.5 | 13.4 | 72.7 | 12.3 | 89.8 | 92.5 | 39.8 | 6.2 |
| 0.36 | 0 | | 0.8 | 17.5 | 64.0 | 15.3 | 86.1 | 89.7 | 33.7 | 13.1 |
| | 5 | 50 | 0.8 | 17.5 | 64.0 | 15.3 | 86.1 | 89.7 | 33.7 | 13.1 |
| | | 10 | 0.8 | 17.5 | 64.1 | 15.2 | 86.1 | 89.7 | 33.5 | 13.0 |
| | | 5 | 0.7 | 16.8 | 65.8 | 14.8 | 86.9 | 90.3 | 31.9 | 11.5 |
| | 10 | 50 | 0.8 | 17.5 | 64.0 | 15.3 | 86.1 | 89.7 | 33.7 | 13.1 |
| | | 10 | 0.8 | 17.4 | 64.4 | 15.2 | 86.3 | 89.8 | 32.9 | 12.7 |
| | | 5 | 0.6 | 14.4 | 70.4 | 13.2 | 88.8 | 91.7 | 41.2 | 7.7 |
| 0.38 | 0 | | 1.0 | 19.1 | 60.6 | 16.5 | 84.6 | 88.5 | 34.3 | 17.1 |
| | 5 | 50 | 1.0 | 19.1 | 60.6 | 16.5 | 84.6 | 88.5 | 34.3 | 17.1 |
| | | 10 | 1.0 | 19.0 | 60.7 | 16.4 | 84.6 | 88.6 | 33.9 | 16.9 |
| | | 5 | 0.9 | 18.2 | 62.8 | 16.0 | 85.6 | 89.3 | 32.7 | 14.7 |
| | 10 | 50 | 1.0 | 19.1 | 60.6 | 16.5 | 84.6 | 88.5 | 34.3 | 17.1 |
| | | 10 | 1.0 | 18.9 | 61.2 | 16.4 | 84.8 | 88.7 | 33.4 | 16.5 |
| | | 5 | 0.8 | 15.4 | 68.2 | 14.1 | 87.9 | 91.1 | 43.1 | 9.3 |

TABLE 4

| | | | | | | | | | STRAY LIGHT | |
|---|---|---|---|---|---|---|---|---|---|---|
| | R OF | PITCH OF | DIFFRACTION EFFICIENCY | | | | | | RATIO | |
| | VERTEX | ANNULAR | WAVELENGTH 408 nm | | | | 670 nm | 780 nm | 1st- | 0th- |
| | 16c | CONVEX | 2nd- | 1st- | 0th- | −1st- | 0th- | 0th- | ORDER | ORDER |
| y | (μm) | PORTIONS | ORDER(%) | ORDER(%) | ORDER(%) | ORDER(%) | ORDER(%) | ORDER(%) | (%) | (%) |
| 0.26 | 0 | | 0.0 | 10.5 | 79.6 | 8.6 | 92.5 | 94.5 | 2.9 | 2.8 |
| | 5 | 50 | 0.0 | 10.5 | 79.6 | 8.6 | 92.5 | 94.5 | 2.9 | 2.8 |
| | | 10 | 0.0 | 10.4 | 79.7 | 8.6 | 92.5 | 94.5 | 2.9 | 2.8 |
| | | 5 | 0.0 | 10.1 | 80.3 | 8.4 | 92.8 | 94.7 | 4.7 | 2.6 |
| | 10 | 50 | 0.0 | 10.5 | 79.6 | 8.6 | 92.5 | 94.5 | 2.9 | 2.8 |
| | | 10 | 0.0 | 10.4 | 79.8 | 8.5 | 92.6 | 94.6 | 3.0 | 2.8 |
| | | 5 | 0.1 | 9.2 | 82.0 | 7.9 | 93.5 | 95.2 | 11.7 | 2.1 |
| 0.28 | 0 | | 0.1 | 12.0 | 76.7 | 9.7 | 91.4 | 93.6 | 5.3 | 3.9 |
| | 5 | 50 | 0.1 | 12.0 | 76.7 | 9.7 | 91.4 | 93.6 | 5.3 | 3.9 |
| | | 10 | 0.1 | 12.0 | 76.8 | 9.7 | 91.4 | 93.7 | 5.4 | 3.9 |
| | | 5 | 0.1 | 11.6 | 77.6 | 9.5 | 91.7 | 93.9 | 5.8 | 3.6 |
| | 10 | 50 | 0.1 | 12.0 | 76.7 | 9.7 | 91.4 | 93.6 | 5.3 | 3.9 |
| | | 10 | 0.1 | 11.9 | 76.9 | 9.6 | 91.5 | 93.7 | 5.5 | 3.9 |
| | | 5 | 0.1 | 10.3 | 79.8 | 8.8 | 92.6 | 94.6 | 15.0 | 2.9 |
| 0.30 | 0 | | 0.1 | 13.6 | 73.6 | 10.8 | 90.1 | 92.7 | 7.2 | 5.4 |
| | 5 | 50 | 0.1 | 13.6 | 73.6 | 10.8 | 90.1 | 92.7 | 7.2 | 5.4 |
| | | 10 | 0.1 | 13.5 | 73.7 | 10.8 | 90.2 | 92.8 | 7.3 | 5.3 |
| | | 5 | 0.1 | 13.0 | 74.7 | 10.5 | 90.6 | 93.1 | 7.9 | 4.9 |
| | 10 | 50 | 0.1 | 13.6 | 73.6 | 10.8 | 90.1 | 92.7 | 7.2 | 5.4 |
| | | 10 | 0.1 | 13.4 | 73.9 | 10.7 | 90.3 | 92.8 | 7.4 | 5.3 |
| | | 5 | 0.2 | 11.5 | 77.5 | 9.7 | 91.7 | 93.9 | 17.7 | 3.7 |
| 0.32 | 0 | | 0.2 | 15.2 | 70.5 | 11.9 | 88.8 | 91.8 | 9.2 | 7.2 |
| | 5 | 50 | 0.2 | 15.2 | 70.5 | 11.9 | 88.8 | 91.8 | 9.2 | 7.2 |
| | | 10 | 0.1 | 15.1 | 70.6 | 11.9 | 88.9 | 91.8 | 8.6 | 7.2 |
| | | 5 | 0.1 | 14.5 | 71.8 | 11.6 | 89.4 | 92.2 | 9.6 | 6.5 |
| | 10 | 50 | 0.2 | 15.2 | 70.5 | 11.9 | 88.8 | 91.8 | 9.2 | 7.2 |
| | | 10 | 0.1 | 15.0 | 70.9 | 11.8 | 89.0 | 91.9 | 8.8 | 7.1 |
| | | 5 | 0.2 | 12.6 | 75.3 | 10.6 | 90.8 | 93.2 | 21.0 | 4.7 |
| 0.34 | 0 | | 0.2 | 16.8 | 67.3 | 13.0 | 87.5 | 90.7 | 10.4 | 9.6 |
| | 5 | 50 | 0.2 | 16.8 | 67.3 | 13.0 | 87.5 | 90.7 | 10.4 | 9.6 |
| | | 10 | 0.2 | 16.8 | 67.4 | 12.9 | 87.5 | 90.8 | 10.5 | 9.6 |
| | | 5 | 0.2 | 16.0 | 68.9 | 12.7 | 88.2 | 91.3 | 11.3 | 8.5 |
| | 10 | 50 | 0.2 | 16.8 | 67.3 | 13.0 | 87.5 | 90.7 | 10.4 | 9.6 |
| | | 10 | 0.2 | 16.6 | 67.7 | 12.9 | 87.7 | 90.9 | 10.3 | 9.4 |
| | | 5 | 0.3 | 13.6 | 73.1 | 11.5 | 89.9 | 92.6 | 23.6 | 5.9 |
| 0.36 | 0 | | 0.3 | 18.5 | 64.0 | 14.0 | 86.1 | 89.7 | 11.9 | 12.7 |
| | 5 | 50 | 0.3 | 18.5 | 64.0 | 14.0 | 86.1 | 89.7 | 11.9 | 12.7 |
| | | 10 | 0.3 | 18.5 | 64.1 | 14.0 | 86.1 | 89.7 | 12.0 | 12.6 |
| | | 5 | 0.3 | 17.5 | 65.9 | 13.7 | 86.9 | 90.3 | 12.4 | 11.1 |
| | 10 | 50 | 0.3 | 18.5 | 64.0 | 14.0 | 86.1 | 89.7 | 11.9 | 12.7 |
| | | 10 | 0.3 | 18.3 | 64.5 | 14.0 | 86.3 | 89.8 | 12.0 | 12.3 |
| | | 5 | 0.4 | 14.7 | 70.9 | 12.4 | 89.0 | 91.9 | 27.0 | 7.2 |
| 0.38 | 0 | | 0.5 | 20.2 | 60.6 | 15.0 | 84.6 | 88.5 | 13.3 | 16.6 |
| | 5 | 50 | 0.5 | 20.2 | 60.6 | 15.0 | 84.6 | 88.5 | 13.3 | 16.6 |
| | | 10 | 0.4 | 20.2 | 60.8 | 15.0 | 84.6 | 88.6 | 13.2 | 16.4 |
| | | 5 | 0.4 | 19.0 | 62.9 | 14.7 | 85.6 | 89.4 | 13.9 | 14.1 |
| | 10 | 50 | 0.5 | 20.2 | 60.6 | 15.0 | 84.6 | 88.5 | 13.3 | 16.6 |
| | | 10 | 0.4 | 19.9 | 61.2 | 15.0 | 84.9 | 88.8 | 13.2 | 15.9 |
| | | 5 | 0.5 | 15.7 | 68.7 | 13.2 | 88.1 | 91.2 | 29.7 | 8.8 |

TABLE 5

| | | | | | | | | | STRAY LIGHT | |
|---|---|---|---|---|---|---|---|---|---|---|
| | R OF | PITCH OF | DIFFRACTION EFFICIENCY | | | | | | RATIO | |
| | VERTEX | ANNULAR | WAVELENGTH 408 nm | | | | 670 nm | 780 nm | 1st- | 0th- |
| | 16c | CONVEX | 2nd- | 1st- | 0th- | −1st- | 0th- | 0th- | ORDER | ORDER |
| y | (μm) | PORTIONS | ORDER(%) | ORDER(%) | ORDER(%) | ORDER(%) | ORDER(%) | ORDER(%) | (%) | (%) |
| 0.26 | 0 | | 0.1 | 10.9 | 79.6 | 7.3 | 92.5 | 94.5 | 17.4 | 2.5 |
| | 5 | 50 | 0.1 | 10.9 | 79.6 | 7.3 | 92.5 | 94.5 | 17.4 | 2.5 |
| | | 10 | 0.1 | 10.9 | 79.7 | 7.3 | 92.5 | 94.5 | 17.5 | 2.5 |
| | | 5 | 0.1 | 10.4 | 80.6 | 7.2 | 92.9 | 94.8 | 15.0 | 2.3 |
| | 10 | 50 | 0.1 | 10.9 | 79.6 | 7.3 | 92.5 | 94.5 | 17.4 | 2.5 |
| | | 10 | 0.1 | 10.8 | 79.9 | 7.3 | 92.6 | 94.6 | 16.6 | 2.5 |
| | | 5 | 0.1 | 9.0 | 82.9 | 6.8 | 93.8 | 95.5 | 16.6 | 1.8 |
| 0.28 | 0 | | 0.1 | 12.6 | 76.7 | 8.2 | 91.4 | 93.6 | 10.7 | 3.5 |
| | 5 | 50 | 0.1 | 12.6 | 76.7 | 8.2 | 91.4 | 93.6 | 10.7 | 3.5 |
| | | 10 | 0.1 | 12.5 | 76.8 | 8.2 | 91.4 | 93.7 | 10.8 | 3.5 |
| | | 5 | 0.1 | 11.9 | 77.9 | 8.1 | 91.9 | 94.0 | 10.0 | 3.1 |
| | 10 | 50 | 0.1 | 12.6 | 76.7 | 8.2 | 91.4 | 93.6 | 10.7 | 3.5 |
| | | 10 | 0.1 | 12.4 | 77.0 | 8.1 | 91.5 | 93.7 | 10.0 | 3.4 |
| | | 5 | 0.1 | 10.0 | 80.9 | 7.5 | 93.0 | 94.9 | 14.5 | 2.3 |
| 0.30 | 0 | | 0.1 | 14.4 | 73.6 | 9.0 | 90.1 | 92.7 | 6.4 | 4.8 |
| | 5 | 50 | 0.1 | 14.4 | 73.6 | 9.0 | 90.1 | 92.7 | 6.4 | 4.8 |
| | | 10 | 0.1 | 14.3 | 73.8 | 9.0 | 90.2 | 92.8 | 6.5 | 4.7 |
| | | 5 | 0.1 | 13.4 | 75.2 | 8.9 | 90.8 | 93.2 | 5.8 | 4.2 |
| | 10 | 50 | 0.1 | 14.4 | 73.6 | 9.0 | 90.1 | 92.7 | 6.4 | 4.8 |
| | | 10 | 0.1 | 14.1 | 74.1 | 9.0 | 90.3 | 92.9 | 6.0 | 4.6 |
| | | 5 | 0.1 | 11.1 | 78.9 | 8.3 | 92.2 | 94.3 | 12.8 | 3.0 |
| 0.32 | 0 | | 0.1 | 16.2 | 70.5 | 9.8 | 88.8 | 91.8 | 3.2 | 6.4 |
| | 5 | 50 | 0.1 | 16.2 | 70.5 | 9.8 | 88.8 | 91.8 | 3.2 | 6.4 |
| | | 10 | 0.1 | 16.1 | 70.6 | 9.8 | 88.9 | 91.8 | 3.3 | 6.4 |
| | | 5 | 0.1 | 15.0 | 72.4 | 9.7 | 89.7 | 92.4 | 3.2 | 5.6 |
| | 10 | 50 | 0.1 | 16.2 | 70.5 | 9.8 | 88.8 | 91.8 | 3.2 | 6.4 |
| | | 10 | 0.1 | 15.9 | 71.0 | 9.8 | 89.1 | 91.9 | 3.4 | 6.2 |
| | | 5 | 0.1 | 12.1 | 77.0 | 9.1 | 91.5 | 93.7 | 12.6 | 3.7 |
| 0.34 | 0 | | 0.0 | 18.1 | 67.3 | 10.6 | 87.5 | 90.7 | 1.6 | 8.5 |
| | 5 | 50 | 0.0 | 18.1 | 67.3 | 10.6 | 87.5 | 90.7 | 1.6 | 8.5 |
| | | 10 | 0.0 | 18.0 | 67.4 | 10.7 | 87.6 | 90.8 | 1.7 | 8.4 |
| | | 5 | 0.0 | 16.6 | 69.6 | 10.6 | 88.5 | 91.5 | 2.0 | 7.3 |
| | 10 | 50 | 0.0 | 18.1 | 67.3 | 10.6 | 87.5 | 90.7 | 1.6 | 8.5 |
| | | 10 | 0.0 | 17.7 | 67.9 | 10.7 | 87.8 | 91.0 | 1.7 | 8.2 |
| | | 5 | 0.2 | 13.1 | 75.0 | 9.8 | 90.7 | 93.2 | 14.9 | 4.5 |
| 0.36 | 0 | | 0.0 | 20.1 | 64.0 | 11.4 | 86.1 | 89.7 | 0.6 | 11.2 |
| | 5 | 50 | 0.0 | 20.1 | 64.0 | 11.4 | 86.1 | 89.7 | 0.6 | 11.2 |
| | | 10 | 0.0 | 19.9 | 64.2 | 11.4 | 86.2 | 89.7 | 0.6 | 11.1 |
| | | 5 | 0.0 | 18.3 | 66.8 | 11.4 | 87.3 | 90.6 | 1.6 | 9.3 |
| | 10 | 50 | 0.0 | 20.1 | 64.0 | 11.4 | 86.1 | 89.7 | 0.6 | 11.2 |
| | | 10 | 0.0 | 19.6 | 64.7 | 11.4 | 86.4 | 89.9 | 0.7 | 10.7 |
| | | 5 | 0.2 | 14.0 | 73.1 | 10.5 | 89.9 | 92.6 | 16.3 | 5.5 |
| 0.38 | 0 | | 0.0 | 22.1 | 60.6 | 12.1 | 84.6 | 88.5 | 0.2 | 14.6 |
| | 5 | 50 | 0.0 | 22.1 | 60.6 | 12.1 | 84.6 | 88.5 | 0.2 | 14.6 |
| | | 10 | 0.0 | 21.9 | 60.9 | 12.2 | 84.7 | 88.6 | 0.3 | 14.4 |
| | | 5 | 0.1 | 19.9 | 63.9 | 12.2 | 86.1 | 89.7 | 1.6 | 11.9 |
| | 10 | 50 | 0.0 | 22.1 | 60.6 | 12.1 | 84.6 | 88.5 | 0.2 | 14.6 |
| | | 10 | 0.0 | 21.5 | 61.5 | 12.2 | 85.0 | 88.9 | 0.3 | 13.8 |
| | | 5 | 0.3 | 14.9 | 71.3 | 11.3 | 89.2 | 92.0 | 18.6 | 6.6 |

TABLE 6

| | | | | | | | | | STRAY | |
|---|---|---|---|---|---|---|---|---|---|---|
| | R OF | PITCH OF | DIFFRACTION EFFICIENCY | | | | | | LIGHT RATIO | |
| | VERTEX | ANNULAR | WAVELENGTH 408 nm | | | | 670 nm | 780 nm | 1st- | 0th- |
| | 16c | CONVEX | 2nd- | 1st- | 0th- | -1st- | 0th- | 0th- | ORDER | ORDER |
| y | (μm) | PORTIONS | ORDER (%) | ORDER (%) | ORDER (%) | ORDER (%) | ORDER (%) | ORDER (%) | (%) | (%) |
| 0.26 | 0 | | 0.4 | 11.0 | 79.6 | 6.6 | 92.5 | 94.5 | 47.5 | 2.3 |
| | 5 | 50 | 0.4 | 11.0 | 79.6 | 6.6 | 92.5 | 94.5 | 47.5 | 2.3 |
| | | 10 | 0.4 | 10.9 | 79.7 | 6.6 | 92.6 | 94.5 | 46.7 | 2.3 |
| | | 5 | 0.3 | 10.2 | 80.9 | 6.6 | 93.0 | 94.9 | 41.7 | 2.1 |
| | 10 | 50 | 0.4 | 11.0 | 79.6 | 6.6 | 92.5 | 94.5 | 47.5 | 2.3 |
| | | 10 | 0.3 | 10.8 | 80.0 | 6.6 | 92.7 | 94.6 | 46.8 | 2.2 |
| | | 5 | 0.1 | 8.5 | 83.9 | 6.2 | 94.2 | 95.7 | 30.4 | 1.5 |
| 0.28 | 0 | | 0.4 | 12.7 | 76.7 | 7.4 | 91.4 | 93.6 | 34.2 | 3.2 |
| | 5 | 50 | 0.4 | 12.7 | 76.7 | 7.4 | 91.4 | 93.6 | 34.2 | 3.2 |
| | | 10 | 0.4 | 12.6 | 76.8 | 7.4 | 91.4 | 93.7 | 33.7 | 3.2 |
| | | 5 | 0.3 | 11.7 | 78.4 | 7.3 | 92.0 | 94.1 | 28.6 | 2.8 |
| | 10 | 50 | 0.4 | 12.7 | 76.7 | 7.4 | 91.4 | 93.6 | 34.2 | 3.2 |
| | | 10 | 0.3 | 12.5 | 77.2 | 7.4 | 91.6 | 93.8 | 32.9 | 3.1 |
| | | 5 | 0.1 | 9.5 | 82.0 | 6.9 | 93.5 | 95.2 | 21.9 | 1.9 |
| 0.30 | 0 | | 0.3 | 14.6 | 73.6 | 8.1 | 90.1 | 92.7 | 23.7 | 4.4 |
| | 5 | 50 | 0.3 | 14.6 | 73.6 | 8.1 | 90.1 | 92.7 | 23.7 | 4.4 |
| | | 10 | 0.3 | 14.5 | 73.8 | 8.1 | 90.2 | 92.8 | 23.3 | 4.3 |
| | | 5 | 0.2 | 13.2 | 75.8 | 8.1 | 91.0 | 93.4 | 19.9 | 3.7 |
| | 10 | 50 | 0.3 | 14.6 | 73.6 | 8.1 | 90.1 | 92.7 | 23.7 | 4.4 |
| | | 10 | 0.3 | 14.2 | 74.2 | 8.1 | 90.4 | 92.9 | 22.8 | 4.2 |
| | | 5 | 0.1 | 10.4 | 80.2 | 7.6 | 92.8 | 94.7 | 17.8 | 2.5 |
| 0.32 | 0 | | 0.3 | 16.5 | 70.5 | 8.8 | 88.8 | 91.8 | 16.6 | 5.8 |
| | 5 | 50 | 0.3 | 16.5 | 70.5 | 8.8 | 88.8 | 91.8 | 16.6 | 5.8 |
| | | 10 | 0.3 | 16.4 | 70.7 | 8.8 | 88.9 | 91.8 | 16.4 | 5.8 |
| | | 5 | 0.2 | 14.8 | 73.1 | 8.8 | 89.9 | 92.6 | 13.3 | 4.9 |
| | 10 | 50 | 0.3 | 16.5 | 70.5 | 8.8 | 88.8 | 91.8 | 16.6 | 5.8 |
| | | 10 | 0.3 | 16.0 | 71.2 | 8.9 | 89.2 | 92.0 | 15.5 | 5.6 |
| | | 5 | 0.1 | 11.3 | 78.5 | 8.3 | 92.1 | 94.2 | 14.7 | 3.0 |
| 0.34 | 0 | | 0.3 | 18.5 | 67.3 | 9.5 | 87.5 | 90.7 | 11.4 | 7.8 |
| | 5 | 50 | 0.3 | 18.5 | 67.3 | 9.5 | 87.5 | 90.7 | 11.4 | 7.8 |
| | | 10 | 0.3 | 18.4 | 67.5 | 9.5 | 87.6 | 90.8 | 11.2 | 7.7 |
| | | 5 | 0.2 | 16.4 | 70.4 | 9.6 | 88.8 | 91.7 | 8.9 | 6.4 |
| | 10 | 50 | 0.3 | 18.5 | 67.3 | 9.5 | 87.5 | 90.7 | 11.4 | 7.8 |
| | | 10 | 0.3 | 17.9 | 68.2 | 9.6 | 87.9 | 91.0 | 10.6 | 7.4 |
| | | 5 | 0.1 | 12.2 | 76.7 | 9.0 | 91.4 | 93.7 | 14.3 | 3.7 |
| 0.36 | 0 | | 0.3 | 20.6 | 64.0 | 10.1 | 86.1 | 89.7 | 7.5 | 10.2 |
| | 5 | 50 | 0.3 | 20.6 | 64.0 | 10.1 | 86.1 | 89.7 | 7.5 | 10.2 |
| | | 10 | 0.2 | 20.4 | 64.2 | 10.2 | 86.2 | 89.8 | 7.4 | 10.0 |
| | | 5 | 0.2 | 18.0 | 67.7 | 10.3 | 87.7 | 90.9 | 6.2 | 8.1 |
| | 10 | 50 | 0.3 | 20.6 | 64.0 | 10.1 | 86.1 | 89.7 | 7.6 | 10.2 |
| | | 10 | 0.2 | 19.9 | 65.0 | 10.2 | 86.5 | 90.0 | 6.9 | 9.6 |
| | | 5 | 0.2 | 13.1 | 75.0 | 9.7 | 90.7 | 93.2 | 14.9 | 4.5 |
| 0.38 | 0 | | 0.2 | 22.7 | 60.6 | 10.7 | 84.6 | 88.5 | 4.7 | 13.2 |
| | 5 | 50 | 0.2 | 22.7 | 60.6 | 10.7 | 84.6 | 88.5 | 4.7 | 13.2 |
| | | 10 | 0.2 | 22.5 | 60.9 | 10.8 | 84.7 | 88.7 | 4.6 | 13.0 |
| | | 5 | 0.1 | 19.6 | 65.0 | 11.0 | 86.5 | 90.0 | 4.1 | 10.2 |
| | 10 | 50 | 0.2 | 22.7 | 60.6 | 10.7 | 84.6 | 88.5 | 4.7 | 13.2 |
| | | 10 | 0.2 | 21.9 | 61.9 | 10.9 | 85.2 | 89.0 | 4.4 | 12.4 |
| | | 5 | 0.2 | 14.0 | 73.3 | 10.4 | 90.0 | 92.6 | 16.6 | 5.4 |

TABLE 7

| | | | | | | | | | STRAY | |
|---|---|---|---|---|---|---|---|---|---|---|
| | R OF | PITCH OF | DIFFRACTION EFFICIENCY | | | | | | LIGHT RATIO | |
| | VERTEX | ANNULAR | WAVELENGTH 408 nm | | | | 670 nm | 780 nm | 1st- | 0th- |
| | 16c | CONVEX | 2nd- | 1st- | 0th- | -1st- | 0th- | 0th- | ORDER | ORDER |
| y | (μm) | PORTIONS | ORDER (%) | ORDER (%) | ORDER (%) | ORDER (%) | ORDER (%) | ORDER (%) | (%) | (%) |
| 0.26 | 0 | | 0.2 | 10.1 | 79.6 | 9.2 | 92.5 | 94.5 | 26.5 | 2.9 |
| | 5 | 50 | 0.2 | 10.1 | 79.6 | 9.2 | 92.5 | 94.5 | 26.5 | 2.9 |
| | | 10 | 0.2 | 10.1 | 79.7 | 9.1 | 92.6 | 94.5 | 26.7 | 2.9 |
| | | 5 | 0.2 | 9.8 | 80.4 | 8.9 | 92.8 | 94.7 | 25.3 | 2.7 |
| | 10 | 50 | 0.2 | 10.1 | 79.6 | 9.2 | 92.5 | 94.5 | 26.5 | 2.9 |
| | | 10 | 0.2 | 10.0 | 79.8 | 9.1 | 92.6 | 94.6 | 25.4 | 2.9 |
| | | 5 | 0.2 | 8.8 | 82.4 | 8.1 | 93.6 | 95.3 | 34.4 | 2.1 |
| 0.28 | 0 | | 0.2 | 11.5 | 76.7 | 10.4 | 91.4 | 93.7 | 27.7 | 4.1 |
| | 5 | 50 | 0.2 | 11.5 | 76.7 | 10.4 | 91.4 | 93.7 | 27.7 | 4.1 |
| | | 10 | 0.2 | 11.5 | 76.8 | 10.3 | 91.4 | 93.7 | 27.9 | 4.0 |
| | | 5 | 0.2 | 11.1 | 77.7 | 10.1 | 91.8 | 94.0 | 27.8 | 3.7 |
| | 10 | 50 | 0.2 | 11.5 | 76.7 | 10.4 | 91.4 | 93.7 | 27.7 | 4.1 |
| | | 10 | 0.2 | 11.4 | 77.0 | 10.3 | 91.5 | 93.7 | 28.3 | 4.0 |
| | | 5 | 0.2 | 9.8 | 80.2 | 9.1 | 92.8 | 94.7 | 36.8 | 2.8 |
| 0.30 | 0 | | 0.3 | 13.0 | 73.6 | 11.6 | 90.2 | 92.7 | 29.7 | 5.5 |
| | 5 | 50 | 0.3 | 13.0 | 73.6 | 11.6 | 90.2 | 92.7 | 29.7 | 5.5 |
| | | 10 | 0.3 | 13.0 | 73.7 | 11.6 | 90.2 | 92.8 | 29.9 | 5.5 |
| | | 5 | 0.3 | 12.4 | 74.9 | 11.2 | 90.7 | 93.1 | 29.0 | 5.0 |
| | 10 | 50 | 0.3 | 13.0 | 73.6 | 11.6 | 90.2 | 92.7 | 29.7 | 5.5 |
| | | 10 | 0.3 | 12.9 | 74.0 | 11.5 | 90.3 | 92.8 | 29.5 | 5.4 |
| | | 5 | 0.3 | 10.8 | 78.1 | 10.0 | 91.9 | 94.1 | 40.2 | 3.5 |
| 0.32 | 0 | | 0.5 | 14.5 | 70.5 | 12.8 | 88.9 | 91.8 | 31.6 | 7.5 |
| | 5 | 50 | 0.5 | 14.5 | 70.5 | 12.8 | 88.9 | 91.8 | 31.6 | 7.5 |
| | | 10 | 0.5 | 14.5 | 70.6 | 12.8 | 88.9 | 91.8 | 31.1 | 7.4 |
| | | 5 | 0.4 | 13.8 | 72.0 | 12.4 | 89.5 | 92.3 | 30.2 | 6.6 |
| | 10 | 50 | 0.5 | 14.5 | 70.5 | 12.8 | 88.9 | 91.8 | 31.6 | 7.5 |
| | | 10 | 0.4 | 14.3 | 70.9 | 12.7 | 89.0 | 91.9 | 30.4 | 7.2 |
| | | 5 | 0.4 | 11.8 | 75.9 | 10.9 | 91.1 | 93.4 | 42.6 | 4.5 |
| 0.34 | 0 | | 0.6 | 16.0 | 67.3 | 14.0 | 87.5 | 90.8 | 32.5 | 9.9 |
| | 5 | 50 | 0.6 | 16.0 | 67.3 | 14.0 | 87.5 | 90.8 | 32.5 | 9.9 |
| | | 10 | 0.6 | 16.0 | 67.4 | 14.0 | 87.6 | 90.8 | 32.3 | 9.8 |
| | | 5 | 0.5 | 15.2 | 69.1 | 13.5 | 88.3 | 91.4 | 31.1 | 8.6 |
| | 10 | 50 | 0.6 | 16.0 | 67.3 | 14.0 | 87.5 | 90.8 | 32.5 | 9.9 |
| | | 10 | 0.6 | 15.8 | 67.8 | 13.9 | 87.7 | 90.9 | 32.0 | 9.6 |
| | | 5 | 0.5 | 12.8 | 73.9 | 11.8 | 90.3 | 92.8 | 45.4 | 5.5 |
| 0.36 | 0 | | 0.8 | 17.5 | 64.0 | 15.3 | 86.1 | 89.7 | 33.7 | 13.1 |
| | 5 | 50 | 0.8 | 17.5 | 64.0 | 15.3 | 86.1 | 89.7 | 33.7 | 13.1 |
| | | 10 | 0.8 | 17.5 | 64.1 | 15.2 | 86.2 | 89.7 | 33.1 | 13.0 |
| | | 5 | 0.7 | 16.6 | 66.2 | 14.7 | 87.1 | 90.4 | 31.8 | 11.1 |
| | 10 | 50 | 0.8 | 17.5 | 64.0 | 15.3 | 86.1 | 89.7 | 33.7 | 13.1 |
| | | 10 | 0.8 | 17.3 | 64.6 | 15.1 | 86.4 | 89.9 | 32.7 | 12.6 |
| | | 5 | 0.6 | 13.7 | 71.8 | 12.6 | 89.4 | 92.2 | 47.8 | 6.7 |
| 0.38 | 0 | | 1.0 | 19.1 | 60.6 | 16.5 | 84.6 | 88.6 | 34.3 | 17.1 |
| | 5 | 50 | 1.0 | 19.1 | 60.6 | 16.5 | 84.6 | 88.6 | 34.3 | 17.1 |
| | | 10 | 1.0 | 19.0 | 60.8 | 16.4 | 84.7 | 88.6 | 34.0 | 16.9 |
| | | 5 | 0.8 | 18.0 | 63.2 | 15.8 | 85.8 | 89.5 | 32.6 | 14.2 |
| | 10 | 50 | 1.0 | 19.1 | 60.6 | 16.5 | 84.6 | 88.6 | 34.3 | 17.1 |
| | | 10 | 1.0 | 18.8 | 61.3 | 16.3 | 84.9 | 88.8 | 33.3 | 16.3 |
| | | 5 | 0.8 | 14.6 | 69.8 | 13.5 | 88.6 | 91.6 | 50.1 | 8.0 |

TABLE 8

| | | | | | | | | | STRAY | |
|---|---|---|---|---|---|---|---|---|---|---|
| | R OF | PITCH OF | DIFFRACTION EFFICIENCY | | | | | | LIGHT RATIO | |
| | VERTEX | ANNULAR | WAVELENGTH 408 nm | | | | 670 nm | 780 nm | 1st- | 0th- |
| | 16c | CONVEX | 2nd- | 1st- | 0th- | -1st- | 0th- | 0th- | ORDER | ORDER |
| y | (μm) | PORTIONS | ORDER (%) | ORDER (%) | ORDER (%) | ORDER (%) | ORDER (%) | ORDER (%) | (%) | (%) |
| 0.26 | 0 | | 0.0 | 10.5 | 79.6 | 8.6 | 92.5 | 94.5 | 2.9 | 2.8 |
| | 5 | 50 | 0.0 | 10.5 | 79.6 | 8.6 | 92.5 | 94.5 | 2.9 | 2.8 |
| | | 10 | 0.0 | 10.4 | 79.7 | 8.6 | 92.6 | 94.5 | 2.9 | 2.8 |
| | | 5 | 0.0 | 10.0 | 80.5 | 8.4 | 92.9 | 94.8 | 4.8 | 2.6 |
| | 10 | 50 | 0.0 | 10.5 | 79.6 | 8.6 | 92.5 | 94.5 | 2.9 | 2.8 |
| | | 10 | 0.0 | 10.4 | 79.8 | 8.5 | 92.6 | 94.6 | 3.0 | 2.8 |
| | | 5 | 0.1 | 8.9 | 82.6 | 7.7 | 93.7 | 95.4 | 16.8 | 2.0 |
| 0.28 | 0 | | 0.1 | 12.0 | 76.7 | 9.7 | 91.4 | 93.7 | 5.3 | 3.9 |
| | 5 | 50 | 0.1 | 12.0 | 76.7 | 9.7 | 91.4 | 93.7 | 5.3 | 3.9 |
| | | 10 | 0.1 | 12.0 | 76.8 | 9.7 | 91.4 | 93.7 | 5.4 | 3.9 |
| | | 5 | 0.1 | 11.4 | 77.8 | 9.4 | 91.8 | 94.0 | 5.9 | 3.6 |
| | 10 | 50 | 0.1 | 12.0 | 76.7 | 9.7 | 91.4 | 93.7 | 5.3 | 3.9 |
| | | 10 | 0.1 | 11.9 | 77.0 | 9.6 | 91.5 | 93.7 | 5.5 | 3.8 |
| | | 5 | 0.1 | 9.9 | 80.5 | 8.6 | 92.9 | 94.8 | 19.6 | 2.6 |
| 0.30 | 0 | | 0.1 | 13.6 | 73.6 | 10.8 | 90.2 | 92.7 | 7.2 | 5.4 |
| | 5 | 50 | 0.1 | 13.6 | 73.6 | 10.8 | 90.2 | 92.7 | 7.2 | 5.4 |
| | | 10 | 0.1 | 13.5 | 73.7 | 10.8 | 90.2 | 92.8 | 7.3 | 5.3 |
| | | 5 | 0.1 | 12.9 | 75.0 | 10.5 | 90.7 | 93.2 | 8.2 | 4.8 |
| | 10 | 50 | 0.1 | 13.6 | 73.6 | 10.8 | 90.2 | 92.7 | 7.2 | 5.4 |
| | | 10 | 0.1 | 13.4 | 74.0 | 10.7 | 90.3 | 92.9 | 7.4 | 5.2 |
| | | 5 | 0.2 | 11.0 | 78.4 | 9.4 | 92.1 | 94.2 | 23.5 | 3.4 |
| 0.32 | 0 | | 0.2 | 15.2 | 70.5 | 11.9 | 88.9 | 91.8 | 9.2 | 7.2 |
| | 5 | 50 | 0.2 | 15.2 | 70.5 | 11.9 | 88.9 | 91.8 | 9.2 | 7.2 |
| | | 10 | 0.1 | 15.1 | 70.6 | 11.9 | 88.9 | 91.8 | 8.6 | 7.2 |
| | | 5 | 0.1 | 14.3 | 72.2 | 11.5 | 89.6 | 92.3 | 9.8 | 6.3 |
| | 10 | 50 | 0.2 | 15.2 | 70.5 | 11.9 | 88.9 | 91.8 | 9.2 | 7.2 |
| | | 10 | 0.1 | 15.0 | 71.0 | 11.8 | 89.1 | 91.9 | 8.9 | 7.0 |
| | | 5 | 0.3 | 11.9 | 76.4 | 10.3 | 91.3 | 93.6 | 27.9 | 4.2 |
| 0.34 | 0 | | 0.2 | 16.8 | 67.3 | 13.0 | 87.5 | 90.8 | 10.4 | 9.6 |
| | 5 | 50 | 0.2 | 16.8 | 67.3 | 13.0 | 87.5 | 90.8 | 10.4 | 9.6 |
| | | 10 | 0.2 | 16.8 | 67.4 | 12.9 | 87.6 | 90.8 | 10.5 | 9.6 |
| | | 5 | 0.2 | 15.8 | 69.3 | 12.6 | 88.4 | 91.4 | 11.7 | 8.3 |
| | 10 | 50 | 0.2 | 16.8 | 67.3 | 13.0 | 87.5 | 90.8 | 10.4 | 9.6 |
| | | 10 | 0.2 | 16.6 | 67.8 | 12.9 | 87.7 | 90.9 | 10.4 | 9.3 |
| | | 5 | 0.4 | 12.9 | 74.3 | 11.1 | 90.4 | 93.0 | 31.3 | 5.2 |
| 0.36 | 0 | | 0.3 | 18.5 | 64.0 | 14.0 | 86.1 | 89.7 | 11.9 | 12.7 |
| | 5 | 50 | 0.3 | 18.5 | 64.0 | 14.0 | 86.1 | 89.7 | 11.9 | 12.7 |
| | | 10 | 0.3 | 18.5 | 64.1 | 14.0 | 86.2 | 89.7 | 12.1 | 12.6 |
| | | 5 | 0.3 | 17.3 | 66.4 | 13.6 | 87.2 | 90.5 | 12.9 | 10.6 |
| | 10 | 50 | 0.3 | 18.5 | 64.0 | 14.0 | 86.1 | 89.7 | 11.9 | 12.7 |
| | | 10 | 0.3 | 18.2 | 64.6 | 13.9 | 86.4 | 89.9 | 11.7 | 12.2 |
| | | 5 | 0.5 | 13.8 | 72.3 | 11.9 | 89.6 | 92.3 | 34.8 | 6.3 |
| 0.38 | 0 | | 0.5 | 20.2 | 60.6 | 15.0 | 84.6 | 88.6 | 13.3 | 16.6 |
| | 5 | 50 | 0.5 | 20.2 | 60.6 | 15.0 | 84.6 | 88.6 | 13.3 | 16.6 |
| | | 10 | 0.4 | 20.1 | 60.8 | 15.0 | 84.7 | 88.6 | 13.2 | 16.4 |
| | | 5 | 0.4 | 18.7 | 63.5 | 14.6 | 85.9 | 89.6 | 14.5 | 13.5 |
| | 10 | 50 | 0.5 | 20.2 | 60.6 | 15.0 | 84.6 | 88.6 | 13.3 | 16.6 |
| | | 10 | 0.4 | 19.9 | 61.4 | 15.0 | 85.0 | 88.8 | 13.1 | 15.8 |
| | | 5 | 0.6 | 14.6 | 70.5 | 12.6 | 88.9 | 91.8 | 38.8 | 7.5 |

TABLE 9

| | | | | | | | | | STRAY | |
|---|---|---|---|---|---|---|---|---|---|---|
| | R OF | PITCH OF | DIFFRACTION EFFICIENCY | | | | | | LIGHT RATIO | |
| | VERTEX | ANNULAR | WAVELENGTH 408 nm | | | | 670 nm | 780 nm | 1st- | 0th- |
| | 16c | CONVEX | 2nd- | 1st- | 0th- | -1st- | 0th- | 0th- | ORDER | ORDER |
| y | (μm) | PORTIONS | ORDER (%) | ORDER (%) | ORDER (%) | ORDER (%) | ORDER (%) | ORDER (%) | (%) | (%) |
| 0.26 | 0 | | 0.1 | 10.9 | 79.6 | 7.3 | 92.5 | 94.5 | 17.4 | 2.5 |
| | 5 | 50 | 0.1 | 10.9 | 79.6 | 7.3 | 92.5 | 94.5 | 17.4 | 2.5 |
| | | 10 | 0.1 | 10.9 | 79.7 | 7.3 | 92.6 | 94.5 | 17.6 | 2.5 |
| | | 5 | 0.1 | 10.2 | 80.8 | 7.2 | 93.0 | 94.9 | 15.4 | 2.2 |
| | 10 | 50 | 0.1 | 10.9 | 79.6 | 7.3 | 92.5 | 94.5 | 17.4 | 2.5 |
| | | 10 | 0.1 | 10.7 | 80.0 | 7.3 | 92.7 | 94.6 | 16.7 | 2.4 |
| | | 5 | 0.1 | 8.5 | 83.6 | 6.6 | 94.1 | 95.7 | 18.3 | 1.6 |
| 0.28 | 0 | | 0.1 | 12.6 | 76.7 | 8.2 | 91.4 | 93.7 | 10.7 | 3.5 |
| | 5 | 50 | 0.1 | 12.6 | 76.7 | 8.2 | 91.4 | 93.7 | 10.7 | 3.5 |
| | | 10 | 0.1 | 12.5 | 76.8 | 8.2 | 91.4 | 93.7 | 10.8 | 3.5 |
| | | 5 | 0.1 | 11.7 | 78.2 | 8.0 | 92.0 | 94.1 | 9.2 | 3.1 |
| | 10 | 50 | 0.1 | 12.6 | 76.7 | 8.2 | 91.4 | 93.7 | 10.7 | 3.5 |
| | | 10 | 0.1 | 12.4 | 77.1 | 8.1 | 91.6 | 93.8 | 10.1 | 3.4 |
| | | 5 | 0.1 | 9.5 | 81.8 | 7.3 | 93.4 | 95.1 | 18.1 | 2.1 |
| 0.30 | 0 | | 0.1 | 14.4 | 73.6 | 9.0 | 90.2 | 92.7 | 6.4 | 4.8 |
| | 5 | 50 | 0.1 | 14.4 | 73.6 | 9.0 | 90.2 | 92.7 | 6.4 | 4.8 |
| | | 10 | 0.1 | 14.3 | 73.8 | 9.0 | 90.2 | 92.8 | 6.5 | 4.7 |
| | | 5 | 0.1 | 13.2 | 75.6 | 8.9 | 91.0 | 93.3 | 6.1 | 4.1 |
| | 10 | 50 | 0.1 | 14.3 | 73.6 | 9.0 | 90.2 | 92.7 | 6.4 | 4.8 |
| | | 10 | 0.1 | 14.0 | 74.2 | 9.0 | 90.4 | 92.9 | 6.0 | 4.6 |
| | | 5 | 0.1 | 10.4 | 80.0 | 8.1 | 92.7 | 94.6 | 17.7 | 2.6 |
| 0.32 | 0 | | 0.1 | 16.2 | 70.5 | 9.8 | 88.9 | 91.8 | 3.2 | 6.4 |
| | 5 | 50 | 0.1 | 16.2 | 70.5 | 9.8 | 88.9 | 91.8 | 3.2 | 6.4 |
| | | 10 | 0.1 | 16.1 | 70.7 | 9.8 | 88.9 | 91.8 | 3.3 | 6.3 |
| | | 5 | 0.1 | 14.7 | 72.9 | 9.7 | 89.9 | 92.5 | 4.0 | 5.4 |
| | 10 | 50 | 0.1 | 16.2 | 70.5 | 9.8 | 88.9 | 91.8 | 3.2 | 6.4 |
| | | 10 | 0.1 | 15.8 | 71.1 | 9.8 | 89.1 | 92.0 | 3.4 | 6.1 |
| | | 5 | 0.2 | 11.3 | 78.2 | 8.8 | 92.0 | 94.1 | 19.6 | 3.2 |
| 0.34 | 0 | | 0.0 | 18.1 | 67.3 | 10.6 | 87.5 | 90.8 | 1.6 | 8.5 |
| | 5 | 50 | 0.0 | 18.1 | 67.3 | 10.6 | 87.5 | 90.8 | 1.6 | 8.5 |
| | | 10 | 0.0 | 18.0 | 67.5 | 10.7 | 87.6 | 90.8 | 1.7 | 8.4 |
| | | 5 | 0.1 | 16.3 | 70.2 | 10.5 | 88.7 | 91.7 | 2.7 | 7.0 |
| | 10 | 50 | 0.0 | 18.1 | 67.3 | 10.6 | 87.5 | 90.8 | 1.6 | 8.5 |
| | | 10 | 0.0 | 17.6 | 68.1 | 10.7 | 87.9 | 91.0 | 1.8 | 8.1 |
| | | 5 | 0.2 | 12.2 | 76.5 | 9.5 | 91.3 | 93.6 | 21.7 | 3.9 |
| 0.36 | 0 | | 0.0 | 20.1 | 64.0 | 11.4 | 86.1 | 89.7 | 0.6 | 11.2 |
| | 5 | 50 | 0.0 | 20.1 | 64.0 | 11.4 | 86.1 | 89.7 | 0.6 | 11.2 |
| | | 10 | 0.0 | 19.9 | 64.2 | 11.4 | 86.2 | 89.8 | 0.6 | 11.0 |
| | | 5 | 0.1 | 17.8 | 67.4 | 11.3 | 87.6 | 90.8 | 2.1 | 8.9 |
| | 10 | 50 | 0.0 | 20.1 | 64.0 | 11.4 | 86.1 | 89.7 | 0.6 | 11.2 |
| | | 10 | 0.0 | 19.5 | 64.9 | 11.4 | 86.5 | 90.0 | 0.7 | 10.6 |
| | | 5 | 0.3 | 12.9 | 74.8 | 10.2 | 90.6 | 93.1 | 24.2 | 4.7 |
| 0.38 | 0 | | 0.0 | 22.1 | 60.6 | 12.1 | 84.6 | 88.6 | 0.2 | 14.6 |
| | 5 | 50 | 0.0 | 22.1 | 60.6 | 12.1 | 84.6 | 88.6 | 0.2 | 14.6 |
| | | 10 | 0.0 | 21.9 | 60.9 | 12.2 | 84.7 | 88.7 | 0.3 | 14.4 |
| | | 5 | 0.1 | 19.4 | 64.6 | 12.1 | 86.4 | 89.9 | 2.1 | 11.3 |
| | 10 | 50 | 0.0 | 22.1 | 60.6 | 12.1 | 84.6 | 88.6 | 0.2 | 14.6 |
| | | 10 | 0.0 | 21.4 | 61.7 | 12.2 | 85.1 | 89.0 | 0.3 | 13.7 |
| | | 5 | 0.4 | 13.7 | 73.2 | 10.8 | 90.0 | 92.6 | 27.3 | 5.5 |

TABLE 10

| | | | | | | | | | STRAY | |
|---|---|---|---|---|---|---|---|---|---|---|
| | R OF | PITCH OF | DIFFRACTION EFFICIENCY | | | | | | LIGHT RATIO | |
| | VERTEX | ANNULAR | WAVELENGTH 408 nm | | | | 670 nm | 780 nm | 1st- | 0th- |
| | 16c | CONVEX | 2nd- | 1st- | 0th- | -1st- | 0th- | 0th- | ORDER | ORDER |
| y | (μm) | PORTIONS | ORDER (%) | ORDER (%) | ORDER (%) | ORDER (%) | ORDER (%) | ORDER (%) | (%) | (%) |
| 0.26 | 0 | | 0.4 | 11.0 | 79.6 | 6.6 | 92.5 | 94.5 | 47.5 | 2.3 |
| | 5 | 50 | 0.4 | 11.0 | 79.6 | 6.6 | 92.5 | 94.5 | 47.5 | 2.3 |
| | | 10 | 0.4 | 10.9 | 79.7 | 6.6 | 92.6 | 94.5 | 46.9 | 2.3 |
| | | 5 | 0.3 | 10.1 | 81.2 | 6.6 | 93.2 | 95.0 | 40.2 | 2.0 |
| | 10 | 50 | 0.4 | 11.0 | 79.6 | 6.6 | 92.5 | 94.5 | 47.5 | 2.3 |
| | | 10 | 0.3 | 10.7 | 80.1 | 6.6 | 92.7 | 94.6 | 45.8 | 2.2 |
| | | 5 | 0.1 | 8.0 | 84.6 | 6.1 | 94.5 | 95.9 | 29.0 | 1.4 |
| 0.28 | 0 | | 0.4 | 12.7 | 76.7 | 7.4 | 91.4 | 93.7 | 34.2 | 3.2 |
| | 5 | 50 | 0.4 | 12.7 | 76.7 | 7.4 | 91.4 | 93.7 | 34.2 | 3.2 |
| | | 10 | 0.4 | 12.6 | 76.8 | 7.4 | 91.4 | 93.7 | 33.7 | 3.2 |
| | | 5 | 0.2 | 11.5 | 78.8 | 7.3 | 92.2 | 94.3 | 27.5 | 2.7 |
| | 10 | 50 | 0.4 | 12.7 | 76.7 | 7.4 | 91.4 | 93.7 | 34.2 | 3.2 |
| | | 10 | 0.3 | 12.4 | 77.3 | 7.4 | 91.6 | 93.8 | 32.2 | 3.1 |
| | | 5 | 0.1 | 8.9 | 83.0 | 6.7 | 93.8 | 95.5 | 23.2 | 1.7 |
| 0.30 | 0 | | 0.3 | 14.6 | 73.6 | 8.1 | 90.2 | 92.7 | 23.7 | 4.4 |
| | 5 | 50 | 0.3 | 14.6 | 73.6 | 8.1 | 90.2 | 92.7 | 23.7 | 4.4 |
| | | 10 | 0.3 | 14.4 | 73.8 | 8.1 | 90.2 | 92.8 | 23.4 | 4.3 |
| | | 5 | 0.2 | 13.0 | 76.2 | 8.1 | 91.2 | 93.5 | 19.0 | 3.6 |
| | 10 | 50 | 0.3 | 14.6 | 73.6 | 8.1 | 90.2 | 92.7 | 23.7 | 4.4 |
| | | 10 | 0.3 | 14.1 | 74.4 | 8.1 | 90.5 | 93.0 | 22.4 | 4.1 |
| | | 5 | 0.1 | 9.7 | 81.4 | 7.4 | 93.2 | 95.0 | 20.7 | 2.2 |
| 0.32 | 0 | | 0.3 | 16.5 | 70.5 | 8.8 | 88.9 | 91.8 | 16.6 | 5.8 |
| | 5 | 50 | 0.3 | 16.5 | 70.5 | 8.8 | 88.9 | 91.8 | 16.6 | 5.8 |
| | | 10 | 0.3 | 16.3 | 70.7 | 8.8 | 89.0 | 91.9 | 16.4 | 5.8 |
| | | 5 | 0.2 | 14.5 | 73.6 | 8.8 | 90.2 | 92.8 | 12.7 | 4.7 |
| | 10 | 50 | 0.3 | 16.5 | 70.5 | 8.8 | 88.9 | 91.8 | 16.6 | 5.8 |
| | | 10 | 0.3 | 15.9 | 71.4 | 8.9 | 89.2 | 92.1 | 15.2 | 5.5 |
| | | 5 | 0.1 | 10.6 | 79.7 | 8.1 | 92.6 | 94.6 | 18.6 | 2.7 |
| 0.34 | 0 | | 0.3 | 18.5 | 67.3 | 9.5 | 87.5 | 90.8 | 11.4 | 7.8 |
| | 5 | 50 | 0.3 | 18.5 | 67.3 | 9.5 | 87.5 | 90.8 | 11.4 | 7.8 |
| | | 10 | 0.3 | 18.3 | 67.5 | 9.5 | 87.6 | 90.9 | 10.9 | 7.6 |
| | | 5 | 0.2 | 16.0 | 71.1 | 9.6 | 89.1 | 92.0 | 8.9 | 6.0 |
| | 10 | 50 | 0.3 | 18.5 | 67.3 | 9.5 | 87.5 | 90.8 | 11.4 | 7.8 |
| | | 10 | 0.2 | 17.8 | 68.4 | 9.6 | 88.0 | 91.1 | 10.4 | 7.3 |
| | | 5 | 0.2 | 11.3 | 78.2 | 8.7 | 92.0 | 94.1 | 19.5 | 3.2 |
| 0.36 | 0 | | 0.3 | 20.6 | 64.0 | 10.1 | 86.1 | 89.7 | 7.5 | 10.2 |
| | 5 | 50 | 0.3 | 20.6 | 64.0 | 10.1 | 86.1 | 89.7 | 7.5 | 10.2 |
| | | 10 | 0.2 | 20.4 | 64.3 | 10.2 | 86.2 | 89.8 | 7.4 | 10.0 |
| | | 5 | 0.1 | 17.5 | 68.5 | 10.3 | 88.1 | 91.2 | 6.3 | 7.7 |
| | 10 | 50 | 0.3 | 20.6 | 64.0 | 10.1 | 86.1 | 89.7 | 7.6 | 10.2 |
| | | 10 | 0.2 | 19.7 | 65.3 | 10.2 | 86.7 | 90.1 | 6.7 | 9.5 |
| | | 5 | 0.2 | 12.1 | 76.6 | 9.4 | 91.4 | 93.6 | 21.0 | 3.9 |
| 0.38 | 0 | | 0.2 | 22.7 | 60.6 | 10.7 | 84.6 | 88.6 | 4.7 | 13.2 |
| | 5 | 50 | 0.2 | 22.7 | 60.6 | 10.7 | 84.6 | 88.6 | 4.7 | 13.2 |
| | | 10 | 0.2 | 22.5 | 61.0 | 10.8 | 84.8 | 88.7 | 4.6 | 13.0 |
| | | 5 | 0.1 | 19.0 | 65.9 | 11.0 | 87.0 | 90.3 | 4.4 | 9.6 |
| | 10 | 50 | 0.2 | 22.7 | 60.6 | 10.7 | 84.6 | 88.6 | 4.7 | 13.2 |
| | | 10 | 0.2 | 21.7 | 62.2 | 10.9 | 85.3 | 89.1 | 4.2 | 12.2 |
| | | 5 | 0.3 | 12.8 | 75.1 | 10.0 | 90.8 | 93.2 | 23.8 | 4.5 |

TABLE 11

| | | | | | | | | | STRAY | |
|---|---|---|---|---|---|---|---|---|---|---|
| | R OF | PITCH OF | DIFFRACTION EFFICIENCY | | | | | | LIGHT RATIO | |
| | VERTEX | ANNULAR | WAVELENGTH 408 nm | | | | 670 nm | 780 nm | 1st- | 0th- |
| | 16c | CONVEX | 2nd- | 1st- | 0th- | -1st- | 0th- | 0th- | ORDER | ORDER |
| y | (μm) | PORTIONS | ORDER (%) | ORDER (%) | ORDER (%) | ORDER (%) | ORDER (%) | ORDER (%) | (%) | (%) |
| 0.26 | 0 | | 0.2 | 10.1 | 79.6 | 9.2 | 92.5 | 94.5 | 26.5 | 2.9 |
| | 5 | 50 | 0.2 | 10.1 | 79.6 | 9.2 | 92.5 | 94.5 | 26.5 | 2.9 |
| | | 10 | 0.2 | 10.1 | 79.7 | 9.1 | 92.6 | 94.5 | 26.7 | 2.9 |
| | | 5 | 0.2 | 9.7 | 80.5 | 8.9 | 92.9 | 94.8 | 25.6 | 2.7 |
| | 10 | 50 | 0.2 | 10.1 | 79.6 | 9.2 | 92.5 | 94.5 | 26.5 | 2.9 |
| | | 10 | 0.2 | 10.0 | 79.9 | 9.1 | 92.6 | 94.6 | 25.5 | 2.9 |
| | | 5 | 0.2 | 8.6 | 82.7 | 8.0 | 93.7 | 95.4 | 35.9 | 2.0 |
| 0.28 | 0 | | 0.2 | 11.5 | 76.7 | 10.4 | 91.4 | 93.7 | 27.7 | 4.1 |
| | 5 | 50 | 0.2 | 11.5 | 76.7 | 10.4 | 91.4 | 93.7 | 27.7 | 4.1 |
| | | 10 | 0.2 | 11.5 | 76.8 | 10.3 | 91.4 | 93.7 | 27.9 | 4.0 |
| | | 5 | 0.2 | 11.0 | 77.8 | 10.0 | 91.8 | 94.0 | 28.2 | 3.6 |
| | 10 | 50 | 0.2 | 11.5 | 76.7 | 10.4 | 91.4 | 93.7 | 27.7 | 4.1 |
| | | 10 | 0.2 | 11.4 | 77.0 | 10.3 | 91.5 | 93.7 | 27.3 | 4.0 |
| | | 5 | 0.2 | 9.6 | 80.6 | 8.9 | 92.9 | 94.8 | 40.5 | 2.6 |
| 0.30 | 0 | | 0.3 | 13.0 | 73.6 | 11.6 | 90.2 | 92.7 | 29.7 | 5.5 |
| | 5 | 50 | 0.3 | 13.0 | 73.6 | 11.6 | 90.2 | 92.7 | 29.7 | 5.5 |
| | | 10 | 0.3 | 13.0 | 73.7 | 11.6 | 90.2 | 92.8 | 29.9 | 5.5 |
| | | 5 | 0.3 | 12.4 | 75.0 | 11.2 | 90.7 | 93.2 | 29.5 | 4.9 |
| | 10 | 50 | 0.3 | 13.0 | 73.6 | 11.6 | 90.2 | 92.7 | 29.7 | 5.5 |
| | | 10 | 0.3 | 12.8 | 74.0 | 11.5 | 90.3 | 92.9 | 29.6 | 5.4 |
| | | 5 | 0.3 | 10.5 | 78.6 | 9.8 | 92.1 | 94.2 | 44.0 | 3.3 |
| 0.32 | 0 | | 0.5 | 14.5 | 70.5 | 12.8 | 88.9 | 91.8 | 31.6 | 7.5 |
| | 5 | 50 | 0.5 | 14.5 | 70.5 | 12.8 | 88.9 | 91.8 | 31.6 | 7.5 |
| | | 10 | 0.5 | 14.4 | 70.6 | 12.8 | 88.9 | 91.8 | 31.2 | 7.4 |
| | | 5 | 0.4 | 13.7 | 72.3 | 12.3 | 89.6 | 92.3 | 30.0 | 6.5 |
| | 10 | 50 | 0.5 | 14.5 | 70.5 | 12.8 | 88.9 | 91.8 | 31.6 | 7.5 |
| | | 10 | 0.4 | 14.3 | 71.0 | 12.7 | 89.1 | 91.9 | 30.5 | 7.2 |
| | | 5 | 0.4 | 11.5 | 76.5 | 10.7 | 91.3 | 93.6 | 46.4 | 4.2 |
| 0.34 | 0 | | 0.6 | 16.0 | 67.3 | 14.0 | 87.5 | 90.8 | 32.5 | 9.9 |
| | 5 | 50 | 0.6 | 16.0 | 67.3 | 14.0 | 87.5 | 90.8 | 32.5 | 9.9 |
| | | 10 | 0.6 | 16.0 | 67.4 | 14.0 | 87.6 | 90.8 | 32.3 | 9.8 |
| | | 5 | 0.5 | 15.1 | 69.4 | 13.5 | 88.4 | 91.4 | 31.2 | 8.4 |
| | 10 | 50 | 0.6 | 16.0 | 67.3 | 14.0 | 87.5 | 90.8 | 32.5 | 9.9 |
| | | 10 | 0.6 | 15.8 | 67.8 | 13.9 | 87.8 | 90.9 | 31.6 | 9.5 |
| | | 5 | 0.5 | 12.4 | 74.6 | 11.5 | 90.6 | 93.0 | 49.8 | 5.1 |
| 0.36 | 0 | | 0.8 | 17.5 | 64.0 | 15.3 | 86.1 | 89.7 | 33.7 | 13.1 |
| | 5 | 50 | 0.8 | 17.5 | 64.0 | 15.3 | 86.1 | 89.7 | 33.7 | 13.1 |
| | | 10 | 0.8 | 17.5 | 64.1 | 15.2 | 86.2 | 89.7 | 33.2 | 12.9 |
| | | 5 | 0.7 | 16.4 | 66.5 | 14.6 | 87.2 | 90.5 | 32.0 | 10.9 |
| | 10 | 50 | 0.8 | 17.5 | 64.0 | 15.3 | 86.1 | 89.7 | 33.7 | 13.1 |
| | | 10 | 0.8 | 17.3 | 64.6 | 15.1 | 86.4 | 89.9 | 32.5 | 12.5 |
| | | 5 | 0.6 | 13.2 | 72.7 | 12.3 | 89.8 | 92.5 | 53.6 | 6.1 |
| 0.38 | 0 | | 1.0 | 19.1 | 60.6 | 16.5 | 84.6 | 88.6 | 34.3 | 17.1 |
| | 5 | 50 | 1.0 | 19.1 | 60.6 | 16.5 | 84.6 | 88.6 | 34.3 | 17.1 |
| | | 10 | 1.0 | 19.0 | 60.8 | 16.4 | 84.7 | 88.6 | 34.0 | 16.9 |
| | | 5 | 0.8 | 17.8 | 63.6 | 15.7 | 86.0 | 89.6 | 32.6 | 13.8 |
| | 10 | 50 | 1.0 | 19.1 | 60.6 | 16.5 | 84.6 | 88.6 | 34.3 | 17.1 |
| | | 10 | 1.0 | 18.8 | 61.4 | 16.3 | 85.0 | 88.8 | 33.1 | 16.2 |
| | | 5 | 0.8 | 14.0 | 70.8 | 13.0 | 89.0 | 91.9 | 55.7 | 7.3 |

TABLE 12

| | | | | | | | | | STRAY | |
|---|---|---|---|---|---|---|---|---|---|---|
| | R OF | PITCH OF | DIFFRACTION EFFICIENCY | | | | | | LIGHT RATIO | |
| | VERTEX | ANNULAR | WAVELENGTH 408 nm | | | | 670 nm | 780 nm | 1st- | 0th- |
| | 16c | CONVEX | 2nd- | 1st- | 0th- | -1st- | 0th- | 0th- | ORDER | ORDER |
| y | (μm) | PORTIONS | ORDER (%) | ORDER (%) | ORDER (%) | ORDER (%) | ORDER (%) | ORDER (%) | (%) | (%) |
| 0.26 | 0 | | 0.0 | 10.5 | 79.6 | 8.6 | 92.5 | 94.5 | 2.9 | 2.8 |
| | 5 | 50 | 0.0 | 10.5 | 79.6 | 8.6 | 92.5 | 94.5 | 2.9 | 2.8 |
| | | 10 | 0.0 | 10.4 | 79.7 | 8.6 | 92.6 | 94.5 | 2.9 | 2.8 |
| | | 5 | 0.0 | 10.0 | 80.6 | 8.3 | 92.9 | 94.8 | 4.8 | 2.6 |
| | 10 | 50 | 0.0 | 10.5 | 79.6 | 8.6 | 92.5 | 94.5 | 2.9 | 2.8 |
| | | 10 | 0.0 | 10.4 | 79.9 | 8.5 | 92.6 | 94.6 | 3.0 | 2.8 |
| | | 5 | 0.1 | 8.7 | 82.9 | 7.6 | 93.8 | 95.5 | 19.8 | 1.9 |
| 0.28 | 0 | | 0.1 | 12.0 | 76.7 | 9.7 | 91.4 | 93.7 | 5.3 | 3.9 |
| | 5 | 50 | 0.1 | 12.0 | 76.7 | 9.7 | 91.4 | 93.7 | 5.3 | 3.9 |
| | | 10 | 0.1 | 11.9 | 76.8 | 9.7 | 91.4 | 93.7 | 5.4 | 3.9 |
| | | 5 | 0.1 | 11.4 | 77.9 | 9.4 | 91.9 | 94.0 | 6.0 | 3.5 |
| | 10 | 50 | 0.1 | 12.0 | 76.7 | 9.7 | 91.4 | 93.7 | 5.3 | 3.9 |
| | | 10 | 0.1 | 11.8 | 77.0 | 9.6 | 91.5 | 93.8 | 5.5 | 3.8 |
| | | 5 | 0.1 | 9.7 | 80.9 | 8.4 | 93.0 | 94.9 | 24.2 | 2.5 |
| 0.30 | 0 | | 0.1 | 13.6 | 73.6 | 10.8 | 90.2 | 92.7 | 7.2 | 5.4 |
| | 5 | 50 | 0.1 | 13.6 | 73.6 | 10.8 | 90.2 | 92.7 | 7.2 | 5.4 |
| | | 10 | 0.1 | 13.5 | 73.8 | 10.8 | 90.2 | 92.8 | 7.3 | 5.3 |
| | | 5 | 0.1 | 12.8 | 75.2 | 10.4 | 90.8 | 93.2 | 8.3 | 4.7 |
| | 10 | 50 | 0.1 | 13.6 | 73.6 | 10.8 | 90.2 | 92.7 | 7.2 | 5.4 |
| | | 10 | 0.1 | 13.4 | 74.1 | 10.7 | 90.3 | 92.9 | 7.5 | 5.2 |
| | | 5 | 0.2 | 10.7 | 78.9 | 9.2 | 92.3 | 94.3 | 27.8 | 3.2 |
| 0.32 | 0 | | 0.2 | 15.2 | 70.5 | 11.9 | 88.9 | 91.8 | 9.2 | 7.2 |
| | 5 | 50 | 0.2 | 15.2 | 70.5 | 11.9 | 88.9 | 91.8 | 9.2 | 7.2 |
| | | 10 | 0.1 | 15.1 | 70.6 | 11.8 | 88.9 | 91.8 | 8.6 | 7.2 |
| | | 5 | 0.1 | 14.2 | 72.4 | 11.5 | 89.7 | 92.4 | 10.1 | 6.2 |
| | 10 | 50 | 0.2 | 15.2 | 70.5 | 11.9 | 88.9 | 91.8 | 9.2 | 7.2 |
| | | 10 | 0.1 | 14.9 | 71.0 | 11.8 | 89.1 | 91.9 | 8.9 | 7.0 |
| | | 5 | 0.3 | 11.6 | 77.0 | 10.0 | 91.5 | 93.7 | 32.1 | 3.9 |
| 0.34 | 0 | | 0.2 | 16.8 | 67.3 | 13.0 | 87.5 | 90.8 | 10.4 | 9.6 |
| | 5 | 50 | 0.2 | 16.8 | 67.3 | 13.0 | 87.5 | 90.8 | 10.4 | 9.6 |
| | | 10 | 0.2 | 16.8 | 67.4 | 12.9 | 87.6 | 90.8 | 10.5 | 9.5 |
| | | 5 | 0.2 | 15.7 | 69.5 | 12.5 | 88.5 | 91.5 | 11.9 | 8.1 |
| | 10 | 50 | 0.2 | 16.8 | 67.3 | 13.0 | 87.5 | 90.8 | 10.4 | 9.6 |
| | | 10 | 0.2 | 16.5 | 67.9 | 12.9 | 87.8 | 91.0 | 10.4 | 9.2 |
| | | 5 | 0.4 | 12.5 | 75.1 | 10.8 | 90.7 | 93.2 | 36.7 | 4.8 |
| 0.36 | 0 | | 0.3 | 18.5 | 64.0 | 14.0 | 86.1 | 89.7 | 11.9 | 12.7 |
| | 5 | 50 | 0.3 | 18.5 | 64.0 | 14.0 | 86.1 | 89.7 | 11.9 | 12.7 |
| | | 10 | 0.3 | 18.4 | 64.2 | 14.0 | 86.2 | 89.8 | 12.1 | 12.5 |
| | | 5 | 0.3 | 17.1 | 66.7 | 13.5 | 87.3 | 90.6 | 13.7 | 10.4 |
| | 10 | 50 | 0.3 | 18.5 | 64.0 | 14.0 | 86.1 | 89.7 | 11.9 | 12.7 |
| | | 10 | 0.3 | 18.2 | 64.7 | 13.9 | 86.4 | 89.9 | 11.7 | 12.1 |
| | | 5 | 0.5 | 13.3 | 73.2 | 11.6 | 90.0 | 92.6 | 40.8 | 5.7 |
| 0.38 | 0 | | 0.5 | 20.2 | 60.6 | 15.0 | 84.6 | 88.6 | 13.3 | 16.6 |
| | 5 | 50 | 0.5 | 20.2 | 60.6 | 15.0 | 84.6 | 88.6 | 13.3 | 16.6 |
| | | 10 | 0.4 | 20.1 | 60.8 | 15.0 | 84.7 | 88.6 | 13.2 | 16.3 |
| | | 5 | 0.4 | 18.6 | 63.8 | 14.5 | 86.1 | 89.7 | 14.8 | 13.2 |
| | 10 | 50 | 0.5 | 20.2 | 60.6 | 15.0 | 84.6 | 88.6 | 13.3 | 16.6 |
| | | 10 | 0.4 | 19.8 | 61.5 | 15.0 | 85.0 | 88.9 | 13.2 | 15.7 |
| | | 5 | 0.6 | 14.0 | 71.5 | 12.3 | 89.3 | 92.1 | 45.0 | 6.7 |

TABLE 13

| | | | | | | | | | STRAY | |
|---|---|---|---|---|---|---|---|---|---|---|
| | R OF | PITCH OF | DIFFRACTION EFFICIENCY | | | | | | LIGHT RATIO | |
| | VERTEX | ANNULAR | WAVELENGTH 408 nm | | | | 670 nm | 780 nm | 1st- | 0th- |
| | 16c | CONVEX | 2nd- | 1st- | 0th- | -1st- | 0th- | 0th- | ORDER | ORDER |
| y | (μm) | PORTIONS | ORDER (%) | ORDER (%) | ORDER (%) | ORDER (%) | ORDER (%) | ORDER (%) | (%) | (%) |
| 0.26 | 0 | | 0.1 | 10.9 | 79.6 | 7.3 | 92.5 | 94.5 | 17.4 | 2.5 |
| | 5 | 50 | 0.1 | 10.9 | 79.6 | 7.3 | 92.5 | 94.5 | 17.4 | 2.5 |
| | | 10 | 0.1 | 10.9 | 79.7 | 7.3 | 92.6 | 94.5 | 17.6 | 2.5 |
| | | 5 | 0.1 | 10.2 | 81.0 | 7.2 | 93.1 | 94.9 | 15.7 | 2.2 |
| | 10 | 50 | 0.1 | 10.9 | 79.6 | 7.3 | 92.5 | 94.5 | 17.4 | 2.5 |
| | | 10 | 0.1 | 10.7 | 80.0 | 7.3 | 92.7 | 94.6 | 16.8 | 2.4 |
| | | 5 | 0.1 | 8.3 | 84.0 | 6.5 | 94.2 | 95.8 | 22.0 | 1.5 |
| 0.28 | 0 | | 0.1 | 12.6 | 76.7 | 8.2 | 91.4 | 93.7 | 10.7 | 3.5 |
| | 5 | 50 | 0.1 | 12.6 | 76.7 | 8.2 | 91.4 | 93.7 | 10.7 | 3.5 |
| | | 10 | 0.1 | 12.5 | 76.8 | 8.2 | 91.4 | 93.7 | 10.8 | 3.5 |
| | | 5 | 0.1 | 11.6 | 78.4 | 8.0 | 92.1 | 94.2 | 9.4 | 3.0 |
| | 10 | 50 | 0.1 | 12.6 | 76.7 | 8.2 | 91.4 | 93.7 | 10.7 | 3.5 |
| | | 10 | 0.1 | 12.3 | 77.2 | 8.1 | 91.6 | 93.8 | 10.2 | 3.4 |
| | | 5 | 0.1 | 9.2 | 82.3 | 7.2 | 93.6 | 95.3 | 19.5 | 2.0 |
| 0.30 | 0 | | 0.1 | 14.4 | 73.6 | 9.0 | 90.2 | 92.7 | 6.4 | 4.8 |
| | 5 | 50 | 0.1 | 14.4 | 73.6 | 9.0 | 90.2 | 92.7 | 6.4 | 4.8 |
| | | 10 | 0.1 | 14.3 | 73.8 | 9.0 | 90.2 | 92.8 | 6.5 | 4.7 |
| | | 5 | 0.1 | 13.0 | 75.8 | 8.8 | 91.1 | 93.4 | 6.2 | 4.0 |
| | 10 | 50 | 0.1 | 14.3 | 73.6 | 9.0 | 90.2 | 92.7 | 6.4 | 4.8 |
| | | 10 | 0.1 | 14.0 | 74.2 | 9.0 | 90.4 | 92.9 | 6.1 | 4.6 |
| | | 5 | 0.1 | 10.0 | 80.7 | 7.9 | 92.9 | 94.8 | 21.0 | 2.4 |
| 0.32 | 0 | | 0.1 | 16.2 | 70.5 | 9.8 | 88.9 | 91.8 | 3.2 | 6.4 |
| | 5 | 50 | 0.1 | 16.2 | 70.5 | 9.8 | 88.9 | 91.8 | 3.2 | 6.4 |
| | | 10 | 0.1 | 16.1 | 70.7 | 9.8 | 89.0 | 91.8 | 3.3 | 6.3 |
| | | 5 | 0.1 | 14.6 | 73.2 | 9.7 | 90.0 | 92.6 | 4.1 | 5.3 |
| | 10 | 50 | 0.1 | 16.2 | 70.5 | 9.8 | 88.9 | 91.8 | 3.2 | 6.4 |
| | | 10 | 0.1 | 15.8 | 71.2 | 9.8 | 89.2 | 92.0 | 3.4 | 6.1 |
| | | 5 | 0.2 | 10.8 | 79.0 | 8.6 | 92.3 | 94.3 | 24.2 | 3.0 |
| 0.34 | 0 | | 0.0 | 18.1 | 67.3 | 10.6 | 87.5 | 90.8 | 1.6 | 8.5 |
| | 5 | 50 | 0.0 | 18.1 | 67.3 | 10.6 | 87.5 | 90.8 | 1.6 | 8.5 |
| | | 10 | 0.0 | 18.0 | 67.5 | 10.7 | 87.6 | 90.8 | 1.7 | 8.4 |
| | | 5 | 0.1 | 16.0 | 70.5 | 10.5 | 88.9 | 91.8 | 2.7 | 6.8 |
| | 10 | 50 | 0.0 | 18.1 | 67.3 | 10.6 | 87.5 | 90.8 | 1.6 | 8.5 |
| | | 10 | 0.0 | 17.6 | 68.2 | 10.7 | 87.9 | 91.1 | 1.8 | 8.0 |
| | | 5 | 0.2 | 11.6 | 77.3 | 9.3 | 91.6 | 93.8 | 26.3 | 3.6 |
| 0.36 | 0 | | 0.0 | 20.1 | 64.0 | 11.4 | 86.1 | 89.7 | 0.6 | 11.2 |
| | 5 | 50 | 0.0 | 20.1 | 64.0 | 11.4 | 86.1 | 89.7 | 0.6 | 11.2 |
| | | 10 | 0.0 | 19.9 | 64.3 | 11.4 | 86.2 | 89.8 | 0.6 | 11.0 |
| | | 5 | 0.1 | 17.6 | 67.8 | 11.3 | 87.8 | 90.9 | 2.6 | 8.6 |
| | 10 | 50 | 0.0 | 20.1 | 64.0 | 11.4 | 86.1 | 89.7 | 0.6 | 11.2 |
| | | 10 | 0.0 | 19.4 | 65.1 | 11.4 | 86.6 | 90.1 | 0.7 | 10.5 |
| | | 5 | 0.3 | 12.3 | 75.8 | 9.9 | 91.0 | 93.4 | 29.9 | 4.3 |
| 0.38 | 0 | | 0.0 | 22.1 | 60.6 | 12.1 | 84.6 | 88.6 | 0.2 | 14.6 |
| | 5 | 50 | 0.0 | 22.1 | 60.6 | 12.1 | 84.6 | 88.6 | 0.2 | 14.6 |
| | | 10 | 0.0 | 21.9 | 60.9 | 12.2 | 84.8 | 88.7 | 0.3 | 14.3 |
| | | 5 | 0.1 | 19.0 | 65.2 | 12.1 | 86.6 | 90.1 | 2.9 | 10.9 |
| | 10 | 50 | 0.0 | 22.1 | 60.6 | 12.1 | 84.6 | 88.6 | 0.2 | 14.6 |
| | | 10 | 0.0 | 21.3 | 61.9 | 12.2 | 85.2 | 89.0 | 0.3 | 13.6 |
| | | 5 | 0.4 | 13.0 | 74.3 | 10.6 | 90.4 | 93.0 | 33.5 | 5.0 |

TABLE 14

| | | | | | | | | | STRAY | |
|---|---|---|---|---|---|---|---|---|---|---|
| | R OF | PITCH OF | DIFFRACTION EFFICIENCY | | | | | | LIGHT RATIO | |
| | VERTEX | ANNULAR | WAVELENGTH 408 nm | | | | 670 nm | 780 nm | 1st- | 0th- |
| | 16c | CONVEX | 2nd- | 1st- | 0th- | -1st- | 0th- | 0th- | ORDER | ORDER |
| y | (μm) | PORTIONS | ORDER (%) | ORDER (%) | ORDER (%) | ORDER (%) | ORDER (%) | ORDER (%) | (%) | (%) |
| 0.26 | 0 | | 0.4 | 11.0 | 79.6 | 6.6 | 92.5 | 94.5 | 47.5 | 2.3 |
| | 5 | 50 | 0.4 | 11.0 | 79.6 | 6.6 | 92.5 | 94.5 | 47.5 | 2.3 |
| | | 10 | 0.4 | 10.9 | 79.8 | 6.6 | 92.6 | 94.5 | 46.9 | 2.3 |
| | | 5 | 0.2 | 10.0 | 81.4 | 6.5 | 93.2 | 95.0 | 39.5 | 2.0 |
| | 10 | 50 | 0.4 | 11.0 | 79.6 | 6.6 | 92.5 | 94.5 | 47.5 | 2.3 |
| | | 10 | 0.3 | 10.7 | 80.1 | 6.6 | 92.7 | 94.7 | 44.9 | 2.2 |
| | | 5 | 0.1 | 7.7 | 85.1 | 5.9 | 94.7 | 96.1 | 31.4 | 1.3 |
| 0.28 | 0 | | 0.4 | 12.7 | 76.7 | 7.4 | 91.4 | 93.7 | 34.2 | 3.2 |
| | 5 | 50 | 0.4 | 12.7 | 76.7 | 7.4 | 91.4 | 93.7 | 34.2 | 3.2 |
| | | 10 | 0.4 | 12.6 | 76.9 | 7.4 | 91.5 | 93.7 | 33.8 | 3.2 |
| | | 5 | 0.2 | 11.3 | 79.0 | 7.3 | 92.3 | 94.3 | 27.1 | 2.6 |
| | 10 | 50 | 0.4 | 12.7 | 76.7 | 7.4 | 91.4 | 93.7 | 34.2 | 3.2 |
| | | 10 | 0.3 | 12.3 | 77.4 | 7.4 | 91.7 | 93.9 | 31.5 | 3.0 |
| | | 5 | 0.1 | 8.6 | 83.5 | 6.6 | 94.0 | 95.6 | 25.1 | 1.6 |
| 0.30 | 0 | | 0.3 | 14.6 | 73.6 | 8.1 | 90.2 | 92.7 | 23.7 | 4.4 |
| | 5 | 50 | 0.3 | 14.6 | 73.6 | 8.1 | 90.2 | 92.7 | 23.7 | 4.4 |
| | | 10 | 0.3 | 14.4 | 73.9 | 8.1 | 90.3 | 92.8 | 23.4 | 4.3 |
| | | 5 | 0.2 | 12.8 | 76.5 | 8.0 | 91.3 | 93.6 | 18.8 | 3.5 |
| | 10 | 50 | 0.3 | 14.6 | 73.6 | 8.1 | 90.2 | 92.7 | 23.7 | 4.4 |
| | | 10 | 0.3 | 14.1 | 74.5 | 8.1 | 90.5 | 93.0 | 22.6 | 4.1 |
| | | 5 | 0.1 | 9.3 | 82.0 | 7.2 | 93.5 | 95.2 | 22.6 | 2.0 |
| 0.32 | 0 | | 0.3 | 16.5 | 70.5 | 8.8 | 88.9 | 91.8 | 16.6 | 5.8 |
| | 5 | 50 | 0.3 | 16.5 | 70.5 | 8.8 | 88.9 | 91.8 | 16.6 | 5.8 |
| | | 10 | 0.3 | 16.3 | 70.8 | 8.8 | 89.0 | 91.9 | 15.9 | 5.8 |
| | | 5 | 0.2 | 14.2 | 74.0 | 8.8 | 90.3 | 92.9 | 12.5 | 4.6 |
| | 10 | 50 | 0.3 | 16.5 | 70.5 | 8.8 | 88.9 | 91.8 | 16.6 | 5.8 |
| | | 10 | 0.3 | 15.9 | 71.5 | 8.9 | 89.3 | 92.1 | 15.3 | 5.5 |
| | | 5 | 0.1 | 10.1 | 80.5 | 7.9 | 92.9 | 94.8 | 22.1 | 2.5 |
| 0.34 | 0 | | 0.3 | 18.5 | 67.3 | 9.5 | 87.5 | 90.8 | 11.4 | 7.8 |
| | 5 | 50 | 0.3 | 18.5 | 67.3 | 9.5 | 87.5 | 90.8 | 11.4 | 7.8 |
| | | 10 | 0.3 | 18.3 | 67.6 | 9.5 | 87.7 | 90.9 | 10.9 | 7.6 |
| | | 5 | 0.2 | 15.7 | 71.5 | 9.5 | 89.3 | 92.1 | 8.7 | 5.8 |
| | 10 | 50 | 0.3 | 18.5 | 67.3 | 9.5 | 87.5 | 90.8 | 11.4 | 7.7 |
| | | 10 | 0.2 | 17.7 | 68.5 | 9.6 | 88.0 | 91.2 | 10.5 | 7.2 |
| | | 5 | 0.2 | 10.8 | 79.0 | 8.5 | 92.3 | 94.3 | 22.9 | 3.0 |
| 0.36 | 0 | | 0.3 | 20.6 | 64.0 | 10.1 | 86.1 | 89.7 | 7.5 | 10.2 |
| | 5 | 50 | 0.3 | 20.6 | 64.0 | 10.1 | 86.1 | 89.7 | 7.5 | 10.2 |
| | | 10 | 0.2 | 20.3 | 64.3 | 10.2 | 86.3 | 89.8 | 7.2 | 10.0 |
| | | 5 | 0.1 | 17.1 | 69.0 | 10.3 | 88.3 | 91.3 | 6.1 | 7.4 |
| | 10 | 50 | 0.3 | 20.6 | 64.0 | 10.1 | 86.1 | 89.7 | 7.6 | 10.2 |
| | | 10 | 0.2 | 19.6 | 65.5 | 10.3 | 86.8 | 90.2 | 6.8 | 9.4 |
| | | 5 | 0.2 | 11.5 | 77.6 | 9.2 | 91.7 | 93.9 | 25.8 | 3.5 |
| 0.38 | 0 | | 0.2 | 22.7 | 60.6 | 10.7 | 84.6 | 88.6 | 4.7 | 13.2 |
| | 5 | 50 | 0.2 | 22.7 | 60.6 | 10.7 | 84.6 | 88.6 | 4.7 | 13.2 |
| | | 10 | 0.2 | 22.4 | 61.1 | 10.8 | 84.8 | 88.7 | 4.6 | 12.9 |
| | | 5 | 0.1 | 18.6 | 66.5 | 11.0 | 87.2 | 90.5 | 5.0 | 9.2 |
| | 10 | 50 | 0.2 | 22.7 | 60.6 | 10.7 | 84.6 | 88.6 | 4.7 | 13.2 |
| | | 10 | 0.2 | 21.5 | 62.4 | 10.9 | 85.4 | 89.2 | 4.3 | 12.1 |
| | | 5 | 0.3 | 12.2 | 76.2 | 9.8 | 91.2 | 93.5 | 28.8 | 4.1 |

TABLE 15

| | | | | | | | | | STRAY | |
|---|---|---|---|---|---|---|---|---|---|---|
| | R OF | PITCH OF | DIFFRACTION EFFICIENCY | | | | | | LIGHT RATIO | |
| | VERTEX | ANNULAR | WAVELENGTH 408 nm | | | | 670 nm | 780 nm | 1st- | 0th- |
| | 16c | CONVEX | 2nd- | 1st- | 0th- | -1st- | 0th- | 0th- | ORDER | ORDER |
| y | (μm) | PORTIONS | ORDER (%) | ORDER (%) | ORDER (%) | ORDER (%) | ORDER (%) | ORDER (%) | (%) | (%) |
| 0.26 | 0 | | 0.2 | 10.1 | 79.6 | 9.2 | 92.7 | 94.6 | 26.5 | 2.9 |
| | 5 | 50 | 0.2 | 10.1 | 79.6 | 9.2 | 92.7 | 94.6 | 26.5 | 2.9 |
| | | 10 | 0.2 | 10.1 | 79.6 | 9.1 | 92.7 | 94.6 | 26.6 | 2.9 |
| | | 5 | 0.2 | 9.9 | 80.0 | 9.0 | 92.8 | 94.7 | 26.0 | 2.8 |
| | 10 | 50 | 0.2 | 10.1 | 79.6 | 9.2 | 92.7 | 94.6 | 26.5 | 2.9 |
| | | 10 | 0.2 | 10.1 | 79.7 | 9.1 | 92.7 | 94.6 | 26.8 | 2.9 |
| | | 5 | 0.2 | 9.4 | 81.1 | 8.6 | 93.2 | 95.0 | 27.5 | 2.5 |
| 0.28 | 0 | | 0.2 | 11.5 | 76.7 | 10.4 | 91.5 | 93.8 | 27.7 | 4.1 |
| | 5 | 50 | 0.2 | 11.5 | 76.7 | 10.4 | 91.5 | 93.8 | 27.7 | 4.1 |
| | | 10 | 0.2 | 11.5 | 76.7 | 10.4 | 91.5 | 93.8 | 27.8 | 4.0 |
| | | 5 | 0.2 | 11.3 | 77.2 | 10.2 | 91.7 | 93.9 | 27.8 | 3.9 |
| | 10 | 50 | 0.2 | 11.5 | 76.7 | 10.4 | 91.5 | 93.8 | 27.7 | 4.1 |
| | | 10 | 0.2 | 11.5 | 76.8 | 10.3 | 91.6 | 93.8 | 28.0 | 4.0 |
| | | 5 | 0.2 | 10.6 | 78.6 | 9.7 | 92.3 | 94.3 | 29.3 | 3.3 |
| 0.30 | 0 | | 0.3 | 13.0 | 73.6 | 11.6 | 90.3 | 92.9 | 29.7 | 5.5 |
| | 5 | 50 | 0.3 | 13.0 | 73.6 | 11.6 | 90.3 | 92.9 | 29.7 | 5.5 |
| | | 10 | 0.3 | 13.0 | 73.7 | 11.6 | 90.3 | 92.9 | 29.8 | 5.5 |
| | | 5 | 0.3 | 12.7 | 74.3 | 11.4 | 90.6 | 93.1 | 29.4 | 5.3 |
| | 10 | 50 | 0.3 | 13.0 | 73.6 | 11.6 | 90.3 | 92.9 | 29.7 | 5.5 |
| | | 10 | 0.3 | 12.9 | 73.8 | 11.5 | 90.4 | 92.9 | 30.1 | 5.5 |
| | | 5 | 0.3 | 11.9 | 76.1 | 10.8 | 91.3 | 93.6 | 30.3 | 4.4 |
| 0.32 | 0 | | 0.5 | 14.5 | 70.5 | 12.8 | 89.0 | 91.9 | 31.6 | 7.5 |
| | 5 | 50 | 0.5 | 14.5 | 70.5 | 12.8 | 89.0 | 91.9 | 31.6 | 7.5 |
| | | 10 | 0.5 | 14.5 | 70.5 | 12.8 | 89.1 | 92.0 | 31.0 | 7.4 |
| | | 5 | 0.4 | 14.1 | 71.3 | 12.6 | 89.4 | 92.2 | 30.7 | 7.0 |
| | 10 | 50 | 0.5 | 14.5 | 70.5 | 12.8 | 89.0 | 91.9 | 31.6 | 7.5 |
| | | 10 | 0.5 | 14.4 | 70.7 | 12.8 | 89.1 | 92.0 | 31.3 | 7.4 |
| | | 5 | 0.4 | 13.1 | 73.5 | 11.9 | 90.3 | 92.9 | 32.7 | 5.7 |
| 0.34 | 0 | | 0.6 | 16.0 | 67.3 | 14.0 | 87.7 | 90.9 | 32.5 | 9.9 |
| | 5 | 50 | 0.6 | 16.0 | 67.3 | 14.0 | 87.7 | 90.9 | 32.5 | 9.9 |
| | | 10 | 0.6 | 16.0 | 67.3 | 14.0 | 87.7 | 91.0 | 32.6 | 9.9 |
| | | 5 | 0.6 | 15.6 | 68.3 | 13.8 | 88.1 | 91.3 | 31.4 | 9.2 |
| | 10 | 50 | 0.6 | 16.0 | 67.3 | 14.0 | 87.7 | 90.9 | 32.5 | 9.9 |
| | | 10 | 0.6 | 15.9 | 67.5 | 14.0 | 87.8 | 91.0 | 32.0 | 9.8 |
| | | 5 | 0.5 | 14.3 | 70.9 | 12.9 | 89.2 | 92.1 | 33.8 | 7.4 |
| 0.36 | 0 | | 0.8 | 17.5 | 64.0 | 15.3 | 86.3 | 89.9 | 33.7 | 13.1 |
| | 5 | 50 | 0.8 | 17.5 | 64.0 | 15.3 | 86.3 | 89.9 | 33.7 | 13.1 |
| | | 10 | 0.8 | 17.5 | 64.0 | 15.2 | 86.3 | 89.9 | 33.4 | 13.0 |
| | | 5 | 0.7 | 17.1 | 65.1 | 15.0 | 86.8 | 90.3 | 32.2 | 12.1 |
| | 10 | 50 | 0.8 | 17.5 | 64.0 | 15.3 | 86.3 | 89.9 | 33.7 | 13.1 |
| | | 10 | 0.8 | 17.4 | 64.3 | 15.2 | 86.5 | 90.0 | 33.0 | 12.8 |
| | | 5 | 0.6 | 15.5 | 68.3 | 14.0 | 88.2 | 91.3 | 34.6 | 9.3 |
| 0.38 | 0 | | 1.0 | 19.1 | 60.6 | 16.5 | 84.8 | 88.8 | 34.3 | 17.1 |
| | 5 | 50 | 1.0 | 19.1 | 60.6 | 16.5 | 84.8 | 88.8 | 34.3 | 17.1 |
| | | 10 | 1.0 | 19.0 | 60.7 | 16.4 | 84.9 | 88.8 | 34.2 | 17.0 |
| | | 5 | 0.9 | 18.5 | 62.0 | 16.2 | 85.5 | 89.3 | 32.6 | 15.5 |
| | 10 | 50 | 1.0 | 19.1 | 60.6 | 16.5 | 84.8 | 88.8 | 34.3 | 17.1 |
| | | 10 | 1.0 | 18.9 | 61.0 | 16.4 | 85.0 | 88.9 | 33.7 | 16.7 |
| | | 5 | 0.8 | 16.7 | 65.7 | 15.0 | 87.1 | 90.5 | 35.7 | 11.6 |

TABLE 16

| | | | | | | | | | STRAY | |
|---|---|---|---|---|---|---|---|---|---|---|
| | R OF | PITCH OF | DIFFRACTION EFFICIENCY | | | | | | LIGHT RATIO | |
| | VERTEX | ANNULAR | WAVELENGTH 408 nm | | | | 670 nm | 780 nm | 1st- | 0th- |
| | 16c | CONVEX | 2nd- | 1st- | 0th- | -1st- | 0th- | 0th- | ORDER | ORDER |
| y | (μm) | PORTIONS | ORDER (%) | ORDER (%) | ORDER (%) | ORDER (%) | ORDER (%) | ORDER (%) | (%) | (%) |
| 0.26 | 0 | | 0.0 | 10.5 | 79.6 | 8.6 | 92.7 | 94.6 | 2.9 | 2.8 |
| | 5 | 50 | 0.0 | 10.5 | 79.6 | 8.6 | 92.7 | 94.6 | 2.9 | 2.8 |
| | | 10 | 0.0 | 10.5 | 79.6 | 8.6 | 92.7 | 94.6 | 2.9 | 2.8 |
| | | 5 | 0.0 | 10.3 | 80.1 | 8.5 | 92.8 | 94.7 | 3.0 | 2.7 |
| | 10 | 50 | 0.0 | 10.5 | 79.6 | 8.6 | 92.7 | 94.6 | 2.9 | 2.8 |
| | | 10 | 0.0 | 10.4 | 79.7 | 8.6 | 92.7 | 94.7 | 2.9 | 2.8 |
| | | 5 | 0.0 | 9.6 | 81.2 | 8.1 | 93.3 | 95.1 | 7.0 | 2.4 |
| 0.28 | 0 | | 0.1 | 12.0 | 76.7 | 9.7 | 91.5 | 93.8 | 5.3 | 3.9 |
| | 5 | 50 | 0.1 | 12.0 | 76.7 | 9.7 | 91.5 | 93.8 | 5.3 | 3.9 |
| | | 10 | 0.1 | 12.0 | 76.7 | 9.7 | 91.5 | 93.8 | 5.4 | 3.9 |
| | | 5 | 0.1 | 11.7 | 77.3 | 9.5 | 91.8 | 93.9 | 5.6 | 3.7 |
| | 10 | 50 | 0.1 | 12.0 | 76.7 | 9.7 | 91.5 | 93.8 | 5.3 | 3.9 |
| | | 10 | 0.1 | 11.9 | 76.8 | 9.6 | 91.6 | 93.8 | 5.4 | 3.9 |
| | | 5 | 0.1 | 10.9 | 78.8 | 9.1 | 92.3 | 94.4 | 9.3 | 3.2 |
| 0.30 | 0 | | 0.1 | 13.6 | 73.6 | 10.8 | 90.3 | 92.9 | 7.2 | 5.4 |
| | 5 | 50 | 0.1 | 13.6 | 73.6 | 10.8 | 90.3 | 92.9 | 7.2 | 5.4 |
| | | 10 | 0.1 | 13.5 | 73.7 | 10.8 | 90.3 | 92.9 | 7.2 | 5.4 |
| | | 5 | 0.1 | 13.2 | 74.4 | 10.6 | 90.6 | 93.1 | 7.7 | 5.1 |
| | 10 | 50 | 0.1 | 13.6 | 73.6 | 10.8 | 90.3 | 92.9 | 7.2 | 5.4 |
| | | 10 | 0.1 | 13.5 | 73.8 | 10.7 | 90.4 | 92.9 | 7.3 | 5.3 |
| | | 5 | 0.1 | 12.2 | 76.3 | 10.1 | 91.4 | 93.7 | 11.3 | 4.2 |
| 0.32 | 0 | | 0.2 | 15.2 | 70.5 | 11.9 | 89.0 | 91.9 | 9.2 | 7.2 |
| | 5 | 50 | 0.2 | 15.2 | 70.5 | 11.9 | 89.0 | 91.9 | 9.2 | 7.2 |
| | | 10 | 0.1 | 15.2 | 70.6 | 11.9 | 89.1 | 92.0 | 8.6 | 7.2 |
| | | 5 | 0.1 | 14.8 | 71.4 | 11.7 | 89.4 | 92.2 | 9.2 | 6.8 |
| | 10 | 50 | 0.2 | 15.2 | 70.5 | 11.9 | 89.0 | 91.9 | 9.2 | 7.2 |
| | | 10 | 0.1 | 15.1 | 70.7 | 11.8 | 89.1 | 92.0 | 8.7 | 7.1 |
| | | 5 | 0.2 | 13.5 | 73.7 | 11.1 | 90.4 | 92.9 | 13.9 | 5.5 |
| 0.34 | 0 | | 0.2 | 16.8 | 67.3 | 13.0 | 87.7 | 90.9 | 10.4 | 9.6 |
| | 5 | 50 | 0.2 | 16.8 | 67.3 | 13.0 | 87.7 | 90.9 | 10.4 | 9.6 |
| | | 10 | 0.2 | 16.8 | 67.3 | 12.9 | 87.7 | 91.0 | 10.5 | 9.6 |
| | | 5 | 0.2 | 16.3 | 68.3 | 12.8 | 88.2 | 91.3 | 10.8 | 8.9 |
| | 10 | 50 | 0.2 | 16.8 | 67.3 | 13.0 | 87.7 | 90.9 | 10.4 | 9.6 |
| | | 10 | 0.2 | 16.7 | 67.5 | 12.9 | 87.8 | 91.0 | 10.6 | 9.5 |
| | | 5 | 0.2 | 14.7 | 71.2 | 12.1 | 89.4 | 92.2 | 15.8 | 7.0 |
| 0.36 | 0 | | 0.3 | 18.5 | 64.0 | 14.0 | 86.3 | 89.9 | 11.9 | 12.7 |
| | 5 | 50 | 0.3 | 18.5 | 64.0 | 14.0 | 86.3 | 89.9 | 11.9 | 12.7 |
| | | 10 | 0.3 | 18.5 | 64.0 | 14.0 | 86.3 | 89.9 | 12.0 | 12.6 |
| | | 5 | 0.3 | 17.9 | 65.3 | 13.8 | 86.9 | 90.3 | 11.8 | 11.6 |
| | 10 | 50 | 0.3 | 18.5 | 64.0 | 14.0 | 86.3 | 89.9 | 11.9 | 12.7 |
| | | 10 | 0.3 | 18.4 | 64.3 | 14.0 | 86.5 | 90.0 | 11.8 | 12.4 |
| | | 5 | 0.3 | 16.0 | 68.7 | 13.0 | 88.3 | 91.4 | 18.3 | 8.8 |
| 0.38 | 0 | | 0.5 | 20.2 | 60.6 | 15.0 | 84.8 | 88.8 | 13.3 | 16.6 |
| | 5 | 50 | 0.5 | 20.2 | 60.6 | 15.0 | 84.8 | 88.8 | 13.3 | 16.6 |
| | | 10 | 0.5 | 20.2 | 60.7 | 15.0 | 84.9 | 88.8 | 13.4 | 16.5 |
| | | 5 | 0.4 | 19.5 | 62.1 | 14.9 | 85.5 | 89.3 | 13.4 | 15.0 |
| | 10 | 50 | 0.5 | 20.2 | 60.6 | 15.0 | 84.8 | 88.8 | 13.3 | 16.6 |
| | | 10 | 0.4 | 20.0 | 61.0 | 15.0 | 85.0 | 88.9 | 13.1 | 16.1 |
| | | 5 | 0.5 | 17.2 | 66.1 | 14.0 | 87.2 | 90.6 | 20.1 | 11.0 |

TABLE 17

| | | | | | | | | | STRAY | |
|---|---|---|---|---|---|---|---|---|---|---|
| | R OF | PITCH OF | DIFFRACTION EFFICIENCY | | | | | | LIGHT RATIO | |
| | VERTEX | ANNULAR | WAVELENGTH 408 nm | | | | 670 nm | 780 nm | 1st- | 0th- |
| | 16c | CONVEX | 2nd- | 1st- | 0th- | -1st- | 0th- | 0th- | ORDER | ORDER |
| y | (μm) | PORTIONS | ORDER (%) | ORDER (%) | ORDER (%) | ORDER (%) | ORDER (%) | ORDER (%) | (%) | (%) |
| 0.26 | 0 | | 0.1 | 10.9 | 79.6 | 7.3 | 92.7 | 94.6 | 17.4 | 2.5 |
| | 5 | 50 | 0.1 | 10.9 | 79.6 | 7.3 | 92.7 | 94.6 | 17.4 | 2.5 |
| | | 10 | 0.1 | 10.9 | 79.7 | 7.3 | 92.7 | 94.6 | 17.5 | 2.5 |
| | | 5 | 0.1 | 10.6 | 80.3 | 7.3 | 92.9 | 94.8 | 15.8 | 2.4 |
| | 10 | 50 | 0.1 | 10.9 | 79.6 | 7.3 | 92.7 | 94.6 | 17.4 | 2.5 |
| | | 10 | 0.1 | 10.8 | 79.8 | 7.3 | 92.7 | 94.7 | 16.4 | 2.5 |
| | | 5 | 0.1 | 9.6 | 81.9 | 7.0 | 93.5 | 95.3 | 16.0 | 2.0 |
| 0.28 | 0 | | 0.1 | 12.6 | 76.7 | 8.2 | 91.5 | 93.8 | 10.7 | 3.5 |
| | 5 | 50 | 0.1 | 12.6 | 76.7 | 8.2 | 91.5 | 93.8 | 10.7 | 3.5 |
| | | 10 | 0.1 | 12.6 | 76.7 | 8.2 | 91.5 | 93.8 | 10.7 | 3.5 |
| | | 5 | 0.1 | 12.1 | 77.5 | 8.1 | 91.9 | 94.0 | 9.5 | 3.3 |
| | 10 | 50 | 0.1 | 12.6 | 76.7 | 8.2 | 91.5 | 93.8 | 10.7 | 3.5 |
| | | 10 | 0.1 | 12.5 | 76.9 | 8.2 | 91.6 | 93.8 | 10.9 | 3.4 |
| | | 5 | 0.1 | 10.9 | 79.6 | 7.8 | 92.7 | 94.6 | 10.8 | 2.7 |
| 0.30 | 0 | | 0.1 | 14.4 | 73.6 | 9.0 | 90.3 | 92.9 | 6.4 | 4.8 |
| | 5 | 50 | 0.1 | 14.4 | 73.6 | 9.0 | 90.3 | 92.9 | 6.4 | 4.8 |
| | | 10 | 0.1 | 14.3 | 73.7 | 9.0 | 90.4 | 92.9 | 6.5 | 4.7 |
| | | 5 | 0.1 | 13.8 | 74.7 | 9.0 | 90.7 | 93.2 | 5.5 | 4.4 |
| | 10 | 50 | 0.1 | 14.4 | 73.6 | 9.0 | 90.3 | 92.9 | 6.4 | 4.8 |
| | | 10 | 0.1 | 14.2 | 73.9 | 9.0 | 90.4 | 93.0 | 5.9 | 4.7 |
| | | 5 | 0.1 | 12.1 | 77.3 | 8.6 | 91.8 | 94.0 | 8.4 | 3.5 |
| 0.32 | 0 | | 0.1 | 16.2 | 70.5 | 9.8 | 89.0 | 91.9 | 3.2 | 6.4 |
| | 5 | 50 | 0.1 | 16.2 | 70.5 | 9.8 | 89.0 | 91.9 | 3.2 | 6.4 |
| | | 10 | 0.1 | 16.1 | 70.6 | 9.8 | 89.1 | 92.0 | 3.3 | 6.4 |
| | | 5 | 0.1 | 15.4 | 71.8 | 9.8 | 89.6 | 92.3 | 3.6 | 5.9 |
| | 10 | 50 | 0.1 | 16.2 | 70.5 | 9.8 | 89.0 | 91.9 | 3.2 | 6.4 |
| | | 10 | 0.1 | 16.0 | 70.8 | 9.8 | 89.2 | 92.0 | 3.3 | 6.3 |
| | | 5 | 0.1 | 13.4 | 75.0 | 9.4 | 90.9 | 93.3 | 6.7 | 4.5 |
| 0.34 | 0 | | 0.0 | 18.1 | 67.3 | 10.6 | 87.7 | 90.9 | 1.6 | 8.5 |
| | 5 | 50 | 0.0 | 18.1 | 67.3 | 10.6 | 87.7 | 90.9 | 1.6 | 8.5 |
| | | 10 | 0.0 | 18.0 | 67.4 | 10.7 | 87.8 | 91.0 | 1.7 | 8.5 |
| | | 5 | 0.0 | 17.2 | 68.8 | 10.6 | 88.4 | 91.4 | 1.9 | 7.7 |
| | 10 | 50 | 0.0 | 18.1 | 67.3 | 10.6 | 87.7 | 90.9 | 1.6 | 8.5 |
| | | 10 | 0.0 | 17.8 | 67.7 | 10.7 | 87.9 | 91.1 | 1.7 | 8.3 |
| | | 5 | 0.1 | 14.6 | 72.7 | 10.2 | 89.9 | 92.6 | 6.8 | 5.6 |
| 0.36 | 0 | | 0.0 | 20.1 | 64.0 | 11.4 | 86.3 | 89.9 | 0.6 | 11.2 |
| | 5 | 50 | 0.0 | 20.1 | 64.0 | 11.4 | 86.3 | 89.9 | 0.6 | 11.2 |
| | | 10 | 0.0 | 20.0 | 64.1 | 11.4 | 86.4 | 89.9 | 0.6 | 11.1 |
| | | 5 | 0.0 | 18.9 | 65.8 | 11.4 | 87.1 | 90.5 | 1.1 | 10.0 |
| | 10 | 50 | 0.0 | 20.1 | 64.0 | 11.4 | 86.3 | 89.9 | 0.6 | 11.2 |
| | | 10 | 0.0 | 19.8 | 64.5 | 11.4 | 86.5 | 90.0 | 0.7 | 10.9 |
| | | 5 | 0.1 | 15.8 | 70.4 | 11.0 | 89.0 | 91.9 | 7.3 | 7.0 |
| 0.38 | 0 | | 0.0 | 22.1 | 60.6 | 12.1 | 84.8 | 88.8 | 0.2 | 14.6 |
| | 5 | 50 | 0.0 | 22.1 | 60.6 | 12.1 | 84.8 | 88.8 | 0.2 | 14.6 |
| | | 10 | 0.0 | 22.0 | 60.8 | 12.2 | 84.9 | 88.8 | 0.3 | 14.5 |
| | | 5 | 0.0 | 20.7 | 62.8 | 12.2 | 85.8 | 89.5 | 0.6 | 12.8 |
| | 10 | 50 | 0.0 | 22.1 | 60.6 | 12.1 | 84.8 | 88.8 | 0.2 | 14.6 |
| | | 10 | 0.0 | 21.7 | 61.2 | 12.2 | 85.1 | 89.0 | 0.3 | 14.1 |
| | | 5 | 0.2 | 17.0 | 68.2 | 11.8 | 88.1 | 91.2 | 8.5 | 8.6 |

TABLE 18

| | | | | | | | | | STRAY | |
|---|---|---|---|---|---|---|---|---|---|---|
| | R OF | PITCH OF | DIFFRACTION EFFICIENCY | | | | | | LIGHT RATIO | |
| | VERTEX | ANNULAR | WAVELENGTH 408 nm | | | | 670 nm | 780 nm | 1st- | 0th- |
| | 16c | CONVEX | 2nd- | 1st- | 0th- | -1st- | 0th- | 0th- | ORDER | ORDER |
| y | (μm) | PORTIONS | ORDER (%) | ORDER (%) | ORDER (%) | ORDER (%) | ORDER (%) | ORDER (%) | (%) | (%) |
| 0.26 | 0 | | 0.4 | 11.0 | 79.6 | 6.6 | 92.7 | 94.6 | 47.5 | 2.3 |
| | 5 | 50 | 0.4 | 11.0 | 79.6 | 6.6 | 92.7 | 94.6 | 47.5 | 2.3 |
| | | 10 | 0.4 | 10.9 | 79.7 | 6.6 | 92.7 | 94.6 | 47.9 | 2.3 |
| | | 5 | 0.3 | 10.5 | 80.5 | 6.6 | 93.0 | 94.9 | 43.9 | 2.1 |
| | 10 | 50 | 0.4 | 11.0 | 79.6 | 6.6 | 92.7 | 94.6 | 47.5 | 2.3 |
| | | 10 | 0.3 | 10.9 | 79.9 | 6.6 | 92.8 | 94.7 | 46.1 | 2.3 |
| | | 5 | 0.2 | 9.2 | 82.6 | 6.4 | 93.8 | 95.5 | 34.9 | 1.7 |
| 0.28 | 0 | | 0.4 | 12.7 | 76.7 | 7.4 | 91.5 | 93.8 | 34.2 | 3.2 |
| | 5 | 50 | 0.4 | 12.7 | 76.7 | 7.4 | 91.5 | 93.8 | 34.2 | 3.2 |
| | | 10 | 0.4 | 12.7 | 76.8 | 7.4 | 91.6 | 93.8 | 33.5 | 3.2 |
| | | 5 | 0.3 | 12.1 | 77.8 | 7.4 | 92.0 | 94.1 | 30.0 | 2.9 |
| | 10 | 50 | 0.4 | 12.7 | 76.7 | 7.4 | 91.5 | 93.8 | 34.2 | 3.2 |
| | | 10 | 0.3 | 12.5 | 77.0 | 7.4 | 91.7 | 93.9 | 33.3 | 3.1 |
| | | 5 | 0.2 | 10.4 | 80.5 | 7.1 | 93.0 | 94.9 | 23.7 | 2.3 |
| 0.30 | 0 | | 0.3 | 14.6 | 73.6 | 8.1 | 90.3 | 92.9 | 23.7 | 4.4 |
| | 5 | 50 | 0.3 | 14.6 | 73.6 | 8.1 | 90.3 | 92.9 | 23.7 | 4.4 |
| | | 10 | 0.3 | 14.5 | 73.7 | 8.1 | 90.4 | 92.9 | 23.9 | 4.3 |
| | | 5 | 0.3 | 13.7 | 75.1 | 8.1 | 90.9 | 93.3 | 20.8 | 3.9 |
| | 10 | 50 | 0.3 | 14.6 | 73.6 | 8.1 | 90.3 | 92.9 | 23.7 | 4.4 |
| | | 10 | 0.3 | 14.3 | 74.0 | 8.1 | 90.5 | 93.0 | 23.1 | 4.2 |
| | | 5 | 0.1 | 11.6 | 78.4 | 7.9 | 92.2 | 94.3 | 16.4 | 3.0 |
| 0.32 | 0 | | 0.3 | 16.5 | 70.5 | 8.8 | 89.0 | 91.9 | 16.6 | 5.8 |
| | 5 | 50 | 0.3 | 16.5 | 70.5 | 8.8 | 89.0 | 91.9 | 16.6 | 5.8 |
| | | 10 | 0.3 | 16.4 | 70.6 | 8.8 | 89.1 | 92.0 | 16.3 | 5.8 |
| | | 5 | 0.2 | 15.4 | 72.2 | 8.9 | 89.8 | 92.5 | 14.7 | 5.2 |
| | 10 | 50 | 0.3 | 16.5 | 70.5 | 8.8 | 89.0 | 91.9 | 16.6 | 5.8 |
| | | 10 | 0.3 | 16.2 | 71.0 | 8.8 | 89.3 | 92.1 | 15.7 | 5.7 |
| | | 5 | 0.1 | 12.8 | 76.2 | 8.6 | 91.4 | 93.7 | 12.2 | 3.8 |
| 0.34 | 0 | | 0.3 | 18.5 | 67.3 | 9.5 | 87.7 | 90.9 | 11.4 | 7.8 |
| | 5 | 50 | 0.3 | 18.5 | 67.3 | 9.5 | 87.7 | 90.9 | 11.4 | 7.8 |
| | | 10 | 0.3 | 18.4 | 67.4 | 9.5 | 87.8 | 91.0 | 11.1 | 7.7 |
| | | 5 | 0.2 | 17.1 | 69.4 | 9.6 | 88.6 | 91.6 | 9.5 | 6.8 |
| | 10 | 50 | 0.3 | 18.5 | 67.3 | 9.5 | 87.7 | 90.9 | 11.4 | 7.8 |
| | | 10 | 0.3 | 18.1 | 67.8 | 9.5 | 88.0 | 91.1 | 10.7 | 7.5 |
| | | 5 | 0.1 | 13.9 | 74.1 | 9.3 | 90.5 | 93.0 | 10.0 | 4.7 |
| 0.36 | 0 | | 0.3 | 20.6 | 64.0 | 10.1 | 86.3 | 89.9 | 7.5 | 10.2 |
| | 5 | 50 | 0.3 | 20.6 | 64.0 | 10.1 | 86.3 | 89.9 | 7.5 | 10.2 |
| | | 10 | 0.2 | 20.5 | 64.1 | 10.1 | 86.4 | 89.9 | 7.4 | 10.1 |
| | | 5 | 0.2 | 18.9 | 66.5 | 10.3 | 87.4 | 90.7 | 6.3 | 8.8 |
| | 10 | 50 | 0.3 | 20.6 | 64.0 | 10.1 | 86.3 | 89.9 | 7.5 | 10.2 |
| | | 10 | 0.2 | 20.1 | 64.6 | 10.2 | 86.6 | 90.1 | 7.0 | 9.8 |
| | | 5 | 0.1 | 15.0 | 72.1 | 10.1 | 89.7 | 92.4 | 9.0 | 5.8 |
| 0.38 | 0 | | 0.2 | 22.7 | 60.6 | 10.7 | 84.8 | 88.8 | 4.7 | 13.2 |
| | 5 | 50 | 0.2 | 22.7 | 60.6 | 10.7 | 84.8 | 88.8 | 4.7 | 13.2 |
| | | 10 | 0.2 | 22.6 | 60.8 | 10.7 | 84.9 | 88.9 | 4.8 | 13.1 |
| | | 5 | 0.1 | 20.7 | 63.6 | 11.0 | 86.2 | 89.8 | 4.2 | 11.2 |
| | 10 | 50 | 0.2 | 22.7 | 60.6 | 10.7 | 84.8 | 88.8 | 4.7 | 13.2 |
| | | 10 | 0.2 | 22.2 | 61.4 | 10.8 | 85.2 | 89.1 | 4.5 | 12.7 |
| | | 5 | 0.2 | 16.1 | 70.1 | 10.8 | 88.9 | 91.8 | 8.7 | 7.1 |

In Tables 3 to 18, “R of vertex 16c (μm)” indicates a radius of curvature of the vertex 16c of the convex portion 16 which is rounded. When R of the vertex 16c is not 0 (when the vertex 16c is not sharp), the diffraction efficiencies of the diffracted lights having different diffraction orders are not significantly varied from the diffraction efficiencies when R of the vertex 16c is 0. Therefore, as described in the first embodiment, if the diffraction plane 15 is provided with the periodically arranged convex portions 16, each of which is nearly triangular when viewed in section and has a vertex angle as considerably large as 150° or more, the optical performance is less likely to deteriorate even if the vertex 16c is rounded. Therefore, a relatively large cutting tool can be used. Thus, the objective optical system 10 and the optical pickup 1 which hardly cause variations in optical performance during the manufacture are obtained in an easy manner. R of the vertex 16c may be 5 μm or more.

In the first embodiment, the value y (h/{λ(n−1)}) is set extremely small. Therefore, as shown in Tables 3 to 18, the 0^{th}-order diffracted light having a wavelength longer than that of the laser light beam corresponding to the information recording surfaces 22a and 22b of the first and second information recording media 20a an 20b (if the first and second information recording media 20a and 20b are a BD and a HD-DVD, respectively, the wavelength is about 408 nm) will have an extremely high diffraction efficiency. For this reason, the optical pickup 1 may be configured to be able to reproduce information from an additional information recording medium having an information recording surface 22 corresponding to a laser light beam having a longer wavelength than that of the laser light beam corresponding to the information recording surfaces 22a and 22b of the first and second information recording media 20a and 20b. More specifically, the optical pickup 1 includes an additional light source for emitting the laser light beam having a wavelength corresponding to the information recording surface of the additional information recording medium and an additional light receiving element for detecting the laser light beam emitted from the additional light source and reflected on the information recording surface of the additional information recording medium. The laser light beam emitted from the additional light source may be focused onto the information recording surface of the additional information recording medium with use of the objective optical system 10. In such a case, 0^{th}-order diffracted light which is separated from the laser light beam from the additional light source on the diffraction plane 15 and has high diffraction efficiency is preferably focused onto the information recording surface. For example, when the first and second information recording media 20a and 20b are a BD and a HD-DVD, respectively, the additional information recording medium may be a Compact Disc® (hereinafter abbreviated as CD) and/or a Digital Versatile Disc® (hereinafter abbreviated as DVD).

In addition to the information recording/reproduction on/from the first information recording medium 20a and the information reproduction from various kinds of information recording media other than the first information recording medium 20a, this configuration also allows information recording on the various kinds of information recording media other than the first information recording medium 20a. For example, the optical pickup 1 which is able to reproduce information from the BD, HD-DVD, CD and DVD and record information on the BD is achieved.

With this configuration, from the aspect of appropriate information recording/reproduction on/from the additional information recording medium, the objective optical system 10 preferably meets the following conditional expression (7), more preferably (7-a). Further, it is preferable to meet the conditional expression (8) irrespective of or in addition to the conditional expression (7):

γ>85% (7)

γ>90% (7-a)

wherein γ is the diffraction efficiency of the 0^{th}-order diffracted light separated on the diffraction plane 15 from the laser light beam corresponding to the information recording surface of the additional information recording medium;

γ>η₀ (8)

wherein γ is the diffraction efficiency of the 0^{th}-order diffracted light separated on the diffraction plane 15 from the laser light beam corresponding to the information recording surface of the additional information recording medium and η₀ is the diffraction efficiency of the 0^{th}-order diffracted light separated on the diffraction plane 15 from the laser light beam corresponding to the information recording surfaces 22a and 22b of the first and second information recording media 20a and 20b.

The wavelength of the laser light beam corresponding to the information recording surface of the additional information recording medium may be, for example, not lower than 660 nm and not higher than 680 nm, or alternatively, not lower than 770 nm and not higher than 800 nm.

Up to this point, the optical pickup 1 has been explained as a preferred example of the present invention. It should be understood that the diffraction plane 15 is based on a phase function and the pitch of the plurality of convex portions 16 of the diffraction plane 15 may not be uniform. For example, the diffraction plane 15 may be configured such that the pitch of the convex portions 16 is gradually increased with increase in distance from the optical axis AX. Although it has been explained above that each of the convex portions 16a is nearly triangular when viewed in section, the side surfaces 16a and 16b of the convex portions 16 may not be linear in some cases because the diffraction plane 15 is based on the phase function. For example, the side surfaces 16a and 16b may be curved when viewed in section. In the first embodiment, the side surfaces 16a and 16b are depicted linearly in the cross section only for convenience sake. Thus, the side surfaces 16a and 16b are not limited to be linear when viewed in section.

### (First Modification)

In the first embodiment described above, the objective optical system 10 including the diffraction element 11 and the objective lens 12 has been explained. However, the objective optical system 10 is not limited to any particular configuration as long as it includes the diffraction plane 15 and is capable of focusing the laser light beam L.

In the first modification, the objective optical system 10 includes an objective lens 12a having the diffraction plane 15 on one of the lens surfaces thereof. In the description of the first modification, components having substantially the same function as those of the first embodiment are indicated by the same reference numerals to omit overlapping explanation.

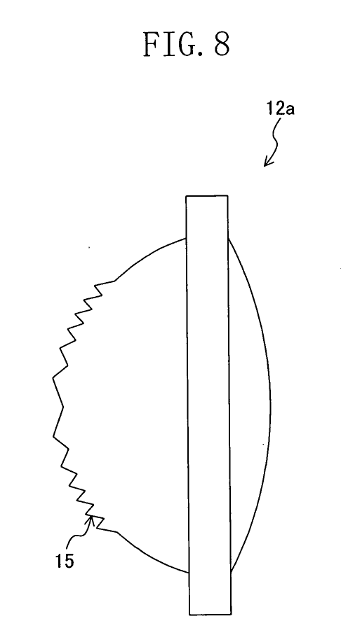

FIG. 8 is a side view of the objective lens 12a according to the first modification.

The objective lens 12a is an integral component having the diffraction plane 15 formed on one of the lens surfaces thereof. The objective lens 12a may be made of glass or a resin.

If the objective lens 12a is used in the objective optical system 10, the diffraction element 11 becomes unnecessary. Therefore, the weight of the lens folder 13 to be actuated by the actuator 35 is reduced. Further, as the component count is also reduced, the objective optical system 10 is assembled more easily and production cost is reduced.

### (Second Modification)

In the first modification described above, the objective lens 12a having the diffraction plane 15 on one of the lens surfaces thereof has been explained. However, the objective lens is not limited to such an integral example.

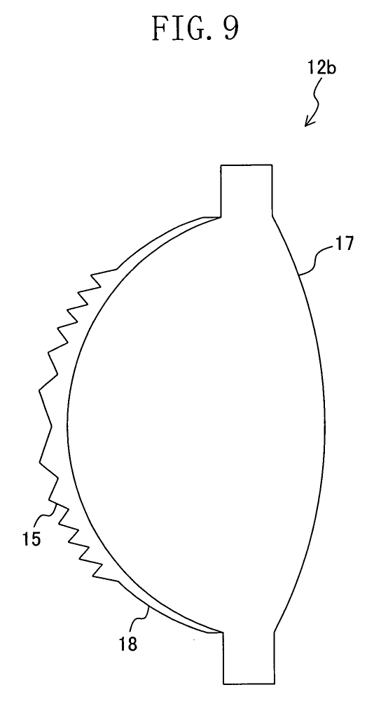

FIG. 9 is a side view of an objective lens 12b according to the second modification.

As shown in FIG. 9, the objective lens 12b includes an objective lens body 17 and a diffraction element 18 which is joined to the objective lens body 17 and has a shape conforming to one of the surfaces of the objective lens body 17. The objective lens body 17 has positive optical power and may be a so-called biconvex lens, for example, as shown in FIG. 9.

The diffraction element 18 is provided with the diffraction plane 15. Each of the objective lens body 17 and the diffraction element 18 may be made of glass or a resin. For higher transmittance of the laser light beam, the objective lens body 17 is particularly preferably made of glass. The diffraction element 18 is also preferably made of glass for the same reason. However, from the aspect of easy production, the diffraction element 18 is preferably made of a resin (e.g., a thermoplastic resin or an energy curable resin). The energy curable resin is a resin which is irreversibly cured when particular energy (e.g., thermal energy, optical energy (UV light), electron beam (EB) energy or the like) is applied to the resin in a softened state. Examples of the energy curable resin may include a thermosetting resin, a photosetting resin (e.g., a UV curable resin) and an electron beam (EB) curing resin.

For example, the objective lens 12a according to the first modification described above may be obtained by subjecting a glass perform to heat pressing (e.g., reheat pressing). More specifically, a glass preform in a heated and softened state is pressed using a pair of forming dies. In order to form the diffraction plane 15 on one of the lens surfaces of the objective lens 12a, one of the pressing surfaces of the forming dies has to be machined into the shape corresponding to the diffraction plane 15. The heat pressing is performed at a temperature as high as not lower than 500° C., for example. Therefore, the material for the forming dies preferably has high resistance to heat and high hardness. For example, the material may be hard metal containing tungsten carbide (WC) as a major component. However, if the forming dies are made of such hard material, it is extremely difficult to cut the surface of the forming dies into the shape corresponding to the diffraction plane 15 even if a diamond cutting tool is used. That is, the forming dies for forming the objective lens 12a are difficult to fabricate.

It may be possible to use a relatively soft alloy containing nickel or copper as the material for the forming dies from the aspect of easy machining of the forming dies into the fine shape corresponding to the diffraction plane 15. In this case, the forming dies are easily machined into the fine shape corresponding to the diffraction plane 15. However, the lifetime of the forming dies is reduced as they are made of the soft material. Therefore, the production cost for the objective lens 12a is increased.

According to the objective lens 12b of the second modification, on the other hand, even if the objective lens body 17 is made of glass, the objective lens body 17 is obtained by heat pressing using a pair of forming dies of relatively simple shape because there is no need to provide the diffraction plane 15 on the objective lens body 17. Further, the diffraction element 18 to be joined to the objective lens body 17 is formed by placing a softened resin on the objective lens body 17 and pressing the resin using a forming die having a pressing surface machined into the shape corresponding to the diffraction plane 15, for example, by 2P (photoreplication process). In this case, the pressing of the resin is performed at a temperature considerably lower than the temperature for the pressing of the glass material and it is not necessary to give very high hardness to the forming die. Therefore, the forming die can be made of a relatively soft material. Even if the forming die is made of the relatively soft material, the lifetime of the forming die is not significantly reduced. Thus, according to the configuration of the second modification, the objective lens 12b is obtained in an easy and low-cost manner.

As described in the present modification, if the diffraction plane 15 is formed on one of the lens surfaces from which the laser light beam L enters, sine condition is satisfied to a high degree. As a result, off-axis coma aberration is reduced to achieve high optical performance. Alternatively, the diffraction plane 15 may be formed on one of the lens surfaces from which the laser light beam L is emitted. Since the diameter of the laser light beam L on the exit lens surface is smaller than that on the entrance lens surface, the diameter of the diffraction plane 15 is made relatively small. Further, since the exit lens surface is generally less curved than the entrance lens surface, the diffraction plane 15 is provided thereon by 2P more easily than on the entrance lens surface.

The diffraction plane 15 may be formed at the interface between the objective lens body 17 and the diffraction element 18. By so doing, the dependence of the diffraction efficiency of the diffraction plane 15 on wavelength is reduced. This is particularly effective for an optical pickup using various kinds of laser light beams of different wavelengths.

In the second modification described above, the thickness of the diffraction element 18 along the optical axis AX is preferably not larger than 1/200 (more preferably not larger than 1/400) of the thickness of the objective lens body 17 along the optical axis AX. This condition is particularly preferable if the diffraction element 18 is made of a resin. By so doing, the light transmittance of the objective lens 12b is improved.

### (Third Modification)

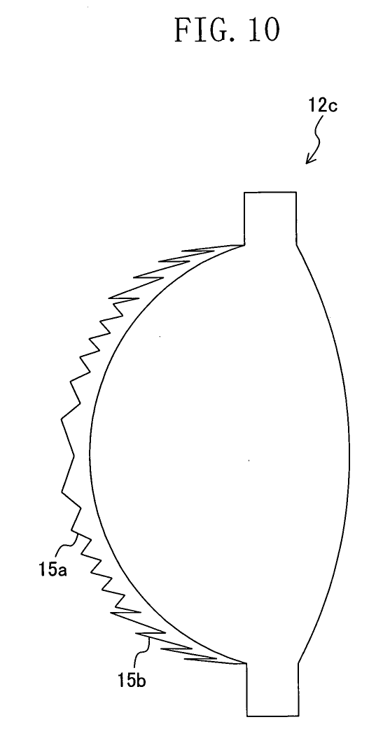

FIG. 10 is a sectional view illustrating an objective lens 12c according to a third modification.

The third modification is a further modified version of the second modification. In the second modification described above, the diffraction plane 15 is provided on part of the lens surface. In the third modification, on the other hand, the diffraction element 18 is provided with a first diffraction plane 15a formed on the middle of the lens surface and a second diffraction plane 15b which is formed on the periphery of the lens surface and based on a different phase function from that of the first diffraction plane 15a. The first diffraction plane 15a is formed into a certain shape such that the 0^{th}-order diffracted light of the laser light beam L corresponding to the first information recording medium 20a is focused onto the information recording surface 22a with reduced aberration. The second diffraction plane 15b is also formed into a certain shape such that the 1^{st}-order diffracted light of the laser light beam L corresponding to the second information recording medium 20b is focused onto the information recording surface 22b with reduced aberration.

This configuration makes it possible to reduce variations in wavelength of the laser light beam L due to a change in ambient temperature or the like and variations in spherical aberration caused by a change in refractive index of an optical element arranged on the optical axis AX. That is, durability to disturbance is improved.

In the first embodiment described above, the first and second diffraction planes 15a and 15b based on different phase functions may be provided in the same manner as in the third modification.

### Second Embodiment

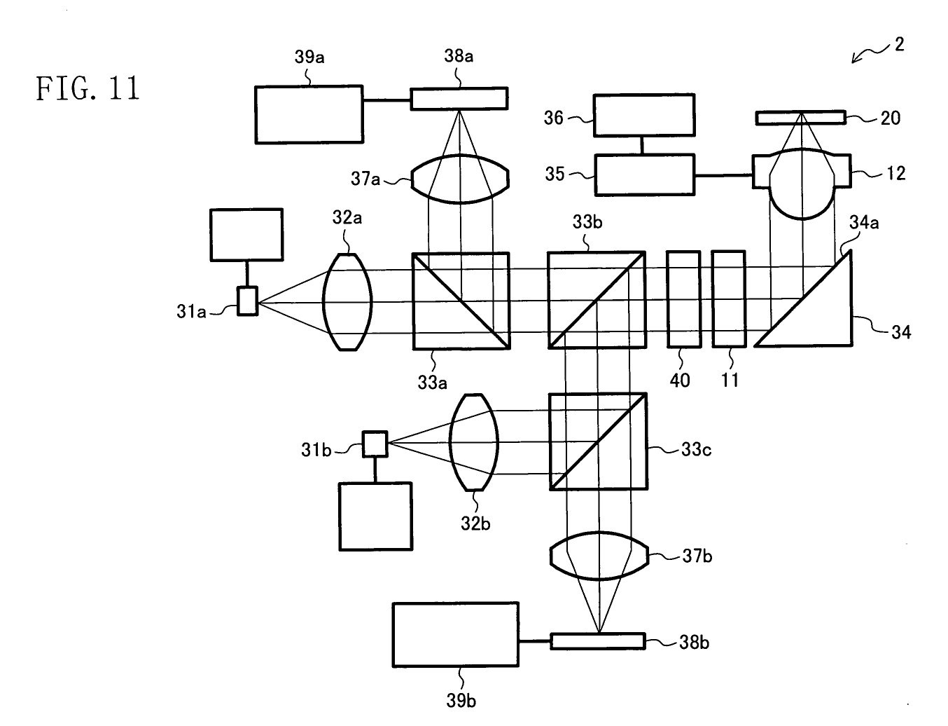

FIG. 11 is a view illustrating the structure of a major part of an optical pickup 2 according to a second embodiment.

An example according to the second embodiment includes a first light source 31a and a second light source 31b for emitting laser light beams having different wavelengths and is able to record/reproduce information on/from not less than three kinds of information recording media. More specifically, the example is able to record/reproduce information on/from not less than three kinds of information recording media including first and second information recording media 20a and 20b corresponding to laser light beams having substantially the same wavelength and having protection layers 21a and 21b of different thicknesses, respectively, such as a BD and a HD-DVD, and a third information recording medium 20c corresponding to a laser light beam of a different wavelength from the wavelength of the laser light beams corresponding to the first and second information recording media 20a and 20b and/or having a protection layer 21c of different thickness from that of the protection layers 21a and 21b, such as a CD or a DVD. In the description of the second embodiment, components having substantially the same function as those of the first embodiment are indicated by the same reference numerals to omit overlapping explanation.

An optical pickup 2 of the second embodiment includes first light sources 31a and 31b, collimator lenses 32a and 32b, beam splitters 33a and 33c, a dichroic prism 33b, a phase shifter 40, the diffraction element 11 described in the first embodiment, a mirror 34, an objective lens 12 which serves as an objective optical system in the second embodiment, an actuator 35, a control unit 36, collimator lenses 37a and 37b, light receiving elements 38a and 38b and signal processing units 39a and 39b.

The first light source 31a emits a laser light beam corresponding to the information recording surfaces 22a and 22b of the first and second information recording media 20a and 20b as described in the first embodiment. The collimator lens 32a is placed forward of the first light source 31a. The collimator lens 32a converts the laser light beam emitted from the first light source 31a into a parallel light beam. Thereafter, the parallel light beam passes through the beam splitter 33a and the dichroic prism 33b and enters the phase shifter 40 having a phase shift pattern.

The phase shift pattern of the phase shifter 40 includes steps arranged concentrically in a staircase pattern. In the second embodiment, the size of each of the stairs is defined such that the laser light beam emitted to the first or second information recording medium 20a or 20b from the first light source 31a passes through the phase shifter 40 without any change. In other words, provided that λ is the wavelength of the laser light beam emitted from the first light source 31a and n is a refractive index of the material of the phase shifter 40, the size of the stairs is designed to be equal to λ/(n−1).

The laser light beam emitted from the first light source 31a and passed through the phase shifter 40 enters the diffraction element 11. In the diffraction element 11, the laser light beam is separated into a plurality of light beams having different diffraction orders including at least 0^{th}- and 1^{st}-order diffracted lights as described in the first embodiment. Each of the diffracted lights coming out of the diffraction element 11 is guided toward the objective lens 12 by the mirror 34. Then, the diffracted lights are focused onto the information recording surface of the information recording medium 20 by the objective lens 12.

The objective lens 12 is designed to focus, at its reference position, the 0^{th}-order diffracted light separated by the diffraction element 11 from the laser light beam emitted from the first light source 31a onto the information recording surface 22a of the first information recording medium 20a.

The objective lens 12 is connected to the actuator 35 connected to the control unit 36. The actuator 35 is actuated by a signal sent from the control unit 36, thereby displacing the objective lens 12 along the optical axis to adjust the light focusing position of the objective lens 12.

The light beam reflected on the information recording surface 22 re-passes through the objective lens 12 and other components and is focused onto the light receiving element 38a by the collimator lens 37a. The light receiving element 38a is configured to output an electrical signal to the signal processing unit 39a in accordance with the amount of the reflected and focused light beam. In this manner, information reading from the information recording surface 22 is performed.

A laser light beam emitted from the second light source 31b having a wavelength different from (longer than) the wavelength of the laser light beam emitted from the first light source 31a is converted into a parallel light beam by the collimator lens 32b. The parallel light beam is then reflected on a reflection plane in the dichroic prism 33b and guided into the dichroic prism 33b. The light beam is reflected again on the reflection plane in the dichroic prism 33b and guided toward the phase shifter 40.

The size of each of the stairs of the phase shift pattern of the phase shifter 40 does not meet λ/(n−1) with respect to the wavelength of the laser light beam emitted from the second light source 31b. Therefore, the laser light beam from the second light source 31b is phase-modulated by the phase shifter 40.

The diffraction element 11 is configured to substantially 0^{th}-order diffract the phase-modulated laser light beam. Therefore, the phase-modulated laser light beam is substantially 0^{th}-order diffracted by the diffraction element 11. The 0^{th}-order diffracted light is focused onto the information recording surface 22c of the third information recording medium 20c corresponding to a wavelength of a laser light beam different from the wavelength of the laser light beam corresponding to the information recording surfaces 22a and 22b of the first and second information recording media 20a and 20b.

The light beam reflected on the information recording surface 22c re-passes through the objective lens 12 and other components and is focused onto the light receiving element 38b by a detection optical system 37b. The light receiving element 38b is configured to output an electrical signal to the signal processing unit 39b in accordance with the amount of the reflected and focused light beam. In this manner, information reading from the information recording surface 22c is performed.

Next, the operation of the optical pickup 2 will be explained.

First, explanation is made on the case where the first information recording medium 20a is placed in front of the objective lens 12.

When the first information recording medium 20a is placed, the first light source 31a is turned on and a laser light beam corresponding to the first information recording medium 20a is emitted from the first light source 31a. The second light source 31b is kept turned off. The laser light beam is converted into a parallel light beam by the collimator lens 32a. The parallel light beam passes through the beam splitter 33a and the dichroic prism 33b to enter the phase shifter 40. As described above, the phase shifter 40 is designed to allow the laser light beam from the first light source 31a to pass through without any change. Therefore, the parallel light beam enters the diffraction element 11.

As described in the first embodiment, the diffraction element 11 separates the laser light beam into the 0^{th}- and 1^{st}-order diffracted lights. Among the diffracted lights, the 0^{th}-order diffracted light is reflected on the mirror 34 and focused onto the information recording surface 22a of the first information recording medium 20a by the objective lens 12. Then, a light beam reflected on the information recording surface 22a is detected by the light receiving element 38a.

Then, the case where the second information recording medium 20b is placed in front of the objective lens 12 will be explained. Also in this case, the first light source 31a is turned on and a laser light beam is emitted from the first light source 31a. In the same manner as the case where the first information recording medium 20a is placed, the laser light beam is converted into a parallel light beam by the collimator lens 32a and passes through the beam splitter 33a and the dichroic prism 33b and the phase shifter 40 to enter the diffraction element 11. The diffraction element 11 diffracts the laser light beam into multiple laser light beams having different diffraction orders including the 0^{th}- and 1^{st}-order diffracted lights. With respect to the second information recording medium 20b, the position of the objective lens 12 is adjusted by the actuator 35 and the control unit 36 to focus the 1^{st}-order diffracted light onto the information recording surface 22b of the second information recording medium 20b (focus adjustment). As a result, the 1^{st}-order diffracted light is focused onto the information recording surface 22b of the second information recording medium 20b. Further, in order to reproduce information from the second information recording medium 20b, the light beam reflected on the information recording surface 22b is detected by the light receiving element 38a.

As explained in the first embodiment, the diffraction efficiency of the 0^{th}-order diffracted light is set relatively high and the 0^{th}-order/stray light ratio is set relatively low. Therefore, in the second embodiment, information recording/reproduction on/from the first information recording medium 20a is suitably performed just like in the first embodiment. Further, the diffraction efficiency of the 1^{st}-order diffracted light is also set high to some extent and the 1^{st}-order/stray light ratio is also set relatively low. Therefore, information reproduction from the second information recording medium 20b is also suitably performed.

Next, the case where the third information recording medium 20c is placed in front of the objective lens 12 will be explained. In this case, the first light source 31a is turned off, while the second light source 31b emits a laser light beam. The laser light beam emitted from the second light source 31b is converted into a parallel light beam by the collimator lens 32b. The parallel light beam is then reflected on a reflection plane provided in the beam splitter 33c, reflected on a reflection plane provided in the dichroic prism 33b and then enters the phase shifter 40.

As described above, the size of each of the stairs of the phase shift pattern of the phase shifter 40 does not meet λ/(n−1) with respect to the wavelength of the laser light beam emitted from the second light source 31b. Therefore, the laser light beam from the second light source 31b is phase-modulated by the phase shifter 40.

The phase-modulated laser light beam enters the diffraction element 11. The diffraction element 11 is configured to substantially 0^{th}-order diffract the phase-modulated laser light beam. Further, since the position of the objective lens 12 is adjusted by the actuator 35 such that the objective lens 12 focuses the 0^{th}-order diffracted light onto the information recording surface 22c of the third information recording medium 20c, the 0^{th}-order diffracted light is suitably focused onto the information recording surface 22c of the third information recording medium 20c. The light beam reflected on the information recording surface 22c is detected by the light receiving element 38b.

From the aspect of appropriate information recording/reproduction on/from the third information recording medium 20c, the diffraction element 11 preferably meets the following conditional expression (7), more preferably (7-a). Further, it is preferable to meet the conditional expression (8) independently from or simultaneously with the conditional expression (7). With this configuration, light is focused onto the information recording surface 22c with high efficiency and high S/N ratio is achieved:

γ>85% (7)

γ>90% (7-a)

wherein γ is the diffraction efficiency of the 0^{th}-order diffracted light separated on the diffraction plane 15 from the laser light beam L corresponding to the information recording surface 22c;

γ>η₀ (8)

wherein γ is the diffraction efficiency of the 0^{th}-order diffracted light separated on the diffraction plane 15 from the laser light beam L corresponding to the information recording surface 22c and η₀ is the 0^{th}-order diffracted light separated on the diffraction plane 15 from the laser light beam corresponding to the information recording surfaces 22a and 22b.

In the second embodiment, the actuator 35 actuates the objective lens 12 only. However, for example, the diffraction element 11 may be arranged closer to the objective lens 12 than the mirror 34 and the objective lens 12 and the diffraction element 11 are fixed by a lens folder or the like to be actuated together by the actuator 35. Alternatively, the diffraction element 11 and the phase shifter 40 may be arranged closer to the objective lens 12 than the mirror 34 such that the objective lens 12, the diffraction element 11 and the phase shifter 40 are fixed by a lens folder or the like. With this configuration, axial misalignment between the diffraction element 11 and the objective lens 12 is reduced and aberration that occurs when the objective lens 12 is displaced in the tracking direction is reduced.

One of the surfaces of the diffraction element 11 (on which the diffraction plane is not provided) may be provided with the same phase shift pattern as that of the phase shifter 40. Or alternatively, the diffraction element 11 may have a surface configured to have both of the geometric features of the diffraction plane and the phase shift pattern and the diffraction element 11 may be arranged closer to the objective lens 12 than the mirror 34 to be fixed by the lens folder together with the objective lens 12.

In the same manner as in the first embodiment, the diffraction plane 15 may be provided on one of the lens surfaces of the objective lens 12 instead providing the diffraction element 11.

The thickness of each of the protection layers 21a to 21c of the information recording media 20a to 20c is not particularly limited. For example, the thickness may be determined to meet the following conditional expressions (19) and (20):

t₁=t₂>t₃ (19)

t₁>t₂>t₃ (20)

wherein t₁ is the thickness of the protection layer 21a of the first information recording medium 20a, t₂ is the thickness of the protection layer 21b of the second information recording medium 20b and t₃ is the thickness of the protection layer 21c of the third information recording medium 20c.

The optical pickup 2 may be configured to be able to perform both of the information recording and reproduction on and from or only the information reproduction from the third information recording medium 20c.

Thus, the second embodiment described above makes it possible to perform information recording/reproduction on/from BD, information reproduction from HD-DVD and information recording/reproduction on/from or only information reproduction from DVD or CD.

### Third Embodiment

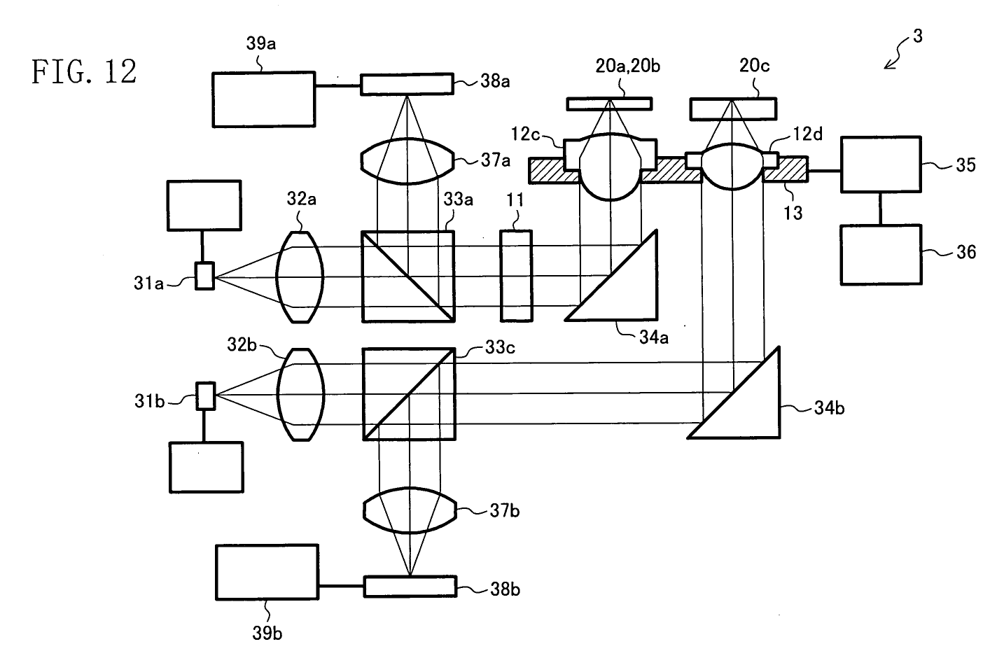

FIG. 12 is a view illustrating the structure of a major part of an optical pickup 3 according to a third embodiment.

In the first and second embodiments described above, the optical pickup including only a single objective lens has been explained. In the following third and fourth embodiments, an optical pickup 3 including two objective lenses will be explained.

Just like the optical pickup 2 described above, the optical pickup 3 is also able to record/reproduce information on/from not less than three kinds of information recording media including first and second information recording media 20a and 20b corresponding to laser light beams of substantially the same wavelength and having protection layers 21a and 21b of different thicknesses, respectively, such as a BD and a HD-DVD, and a third information recording medium 20c corresponding to a laser light beam of a wavelength different from that of the laser light beams corresponding to the first and second information recording media 20a and 20b and/or having a protection layer 21c of different thickness from that of the protection layers 21a and 21b, such as a CD or a DVD. In the description of the third embodiment, components having substantially the same function as those of the first and second embodiments are indicated by the same reference numerals to omit overlapping explanation.

As shown in FIG. 12, the optical pickup 3 of the third embodiment includes, just like the optical pickup 2 described above, a first light source 31a which emits a laser light beam having a wavelength corresponding to the first and second information recording media 20a and 20b and a second light source 31b which emits a laser light beam having a wavelength corresponding to the third information recording medium 20c. Further, collimator lenses 32a and 37a, a beam splitter 33a, a diffraction element 11, a light receiving element 38a and a signal processing unit 39a are provided in connection with the first light source 31a. For the second light source 31b, collimator lenses 32b and 37b, a beam splitter 33c, a light receiving element 38b and a signal processing unit 39b are provided.

In the third embodiment, an objective lens 12c is provided to focus the laser light beam from the first light source 31a onto the information recording surface 22a of the first information recording medium 20a or the information recording surface 22b of the second information recording medium 20b. Further, an objective lens 12d is provided to focus the laser light beam from the second light source 31b onto the information recording surface 22c of the third information recording medium 20c. That is, the objective lens 12d is additionally provided only for focusing the laser light beam from the second light source 31b onto the information recording surface 22c of the third information recording medium 20c.

The objective lenses 12c and 12d are fixed by a shared lens folder 13. An actuator 35 and a control unit 36 are connected to the lens folder 13 to actuate the objective lenses 12c and 12d together with the lens folder 13. The laser light beam from the first light source 31a is guided to the objective lens 12c by a mirror 34a, while the laser light beam from the second light source 31b is guided to the objective lens 12d by a reflection plane 34b.

When the first information recording medium 20a is placed in front of the optical pickup 3 of the third embodiment, the first light source 31a is turned on to emit a laser light beam having a wavelength corresponding to the information recording medium 22a of the first information recording medium 20a. The laser light beam emitted from the first light source 31a is converted into a parallel light beam by the collimator lens 32a. Then, the parallel light beam passes through the beam splitter 33a and enters the diffraction element 11. The diffraction element 11 separates the light beam into various kinds of diffracted lights including 0^{th}- and 1^{st}-order diffracted lights. Among them, the 0^{th}-order diffracted light is guided to the objective lens 12c by the mirror 34a and focused onto the information recording surface 22a of the information recording medium 20a by the objective lens 12c. For reproduction of the information recorded on the first information recording medium 20a, a light beam reflected on the information recording surface 22a is focused onto the light receiving element 38a by the collimator lens 37a and detected by the light receiving element 38a.

When the second information recording medium 20b is placed, the first light source 31a is turned on to emit a laser light beam having a wavelength corresponding to the information recording surface 22b of the second information recording medium 20b. The emitted laser light beam is converted into a parallel light beam by the collimator lens 32a. Then, the parallel light beam passes through the beam splitter 33a and enters the diffraction element 11. The laser light beam is separated into various kinds of diffracted lights including 0^{th}- and 1^{st}-order diffracted lights. Among them, the 1^{st}-order diffracted light is guided to the objective lens 12c by the mirror 34a and focused onto the information recording surface 22b of the second information recording medium 20b by the objective lens 12c displaced to a suitable position by the actuator 35 and the control unit 36. A light beam reflected on the information recording surface 22b is focused onto the light receiving element 38a by the collimator lens 37a and detected by the light receiving element 38a.

When the third information recording medium 20c is placed, the second light source 31b is turned on to emit a laser light beam having a wavelength corresponding to the information recording surface 22c of the third information recording medium 20c. The laser light beam emitted from the second light source 31b is converted into a parallel light beam by the collimator lens 37b. Then, the parallel light beam passes through the beam splitter 33c, guided to the objective lens 12d by a mirror 34b and focused onto the information recording surface 22c by the objective lens 12d. A light beam reflected on the information recording surface 22c is focused onto the light receiving element 38b by the collimator lens 37b and detected by the light receiving element 38b.

Also in the third embodiment, the diffraction efficiency of the 0^{th}-order diffracted light separated on the diffraction element 11 from the laser light beam from the first light source 31a is set relatively high and the 0^{th}-order/stray light ratio is set relatively low. Therefore, just like in the first and second embodiments described above, information recording/reproduction on/from the first information recording medium 20a is appropriately performed. Further, the diffraction efficiency of the 1^{st}-order diffracted light is set high to some extent and the 1^{st}-order/stray light ratio is also set relatively low. Therefore, information reproduction from the second information recording medium 20b is appropriately performed.

Further, in the third embodiment, the objective lens 12d is provided only for focusing the laser light beam from the second light source 31b onto the information recording surface 22c of the third information recording medium 20c. Therefore, the light is focused onto the information recording surface 22c of the third information recording medium 20c more appropriately.

According to the third embodiment, the objective lens 12c does not focus the laser light beam from the second light source 31b having a different wavelength from that of the laser light beam emitted from the first light source 31a. Therefore, the objective lens 12c can be designed only for focusing the laser light beam from the first light source 31a onto the information recording surfaces 22a and 22b of the first and second information recording media 20a and 20b. This makes it possible to extend the design freedom of the objective lens 12c.

According to the configuration of the third embodiment, the laser light beam from the second light source 31b is focused onto the information recording surface 22c without passing through the diffraction element 11. Therefore, the laser light beam is focused with higher efficiency.

In FIG. 12, the diffraction element 11 is depicted between the beam splitter 33a and the reflection plane 34a. However, it may be arranged between the reflection plane 34a and the objective lens 12c. Alternatively, the diffraction element 11 may be fixed by the lens folder 13 together with the objective lens 12c.

Thus, just like the second embodiment described above, the third embodiment also makes it possible to perform information recording/reproduction on/from BD, information reproduction from HD-DVD and information recording/reproduction on/from or only information reproduction from DVD or CD.

### Fourth Embodiment

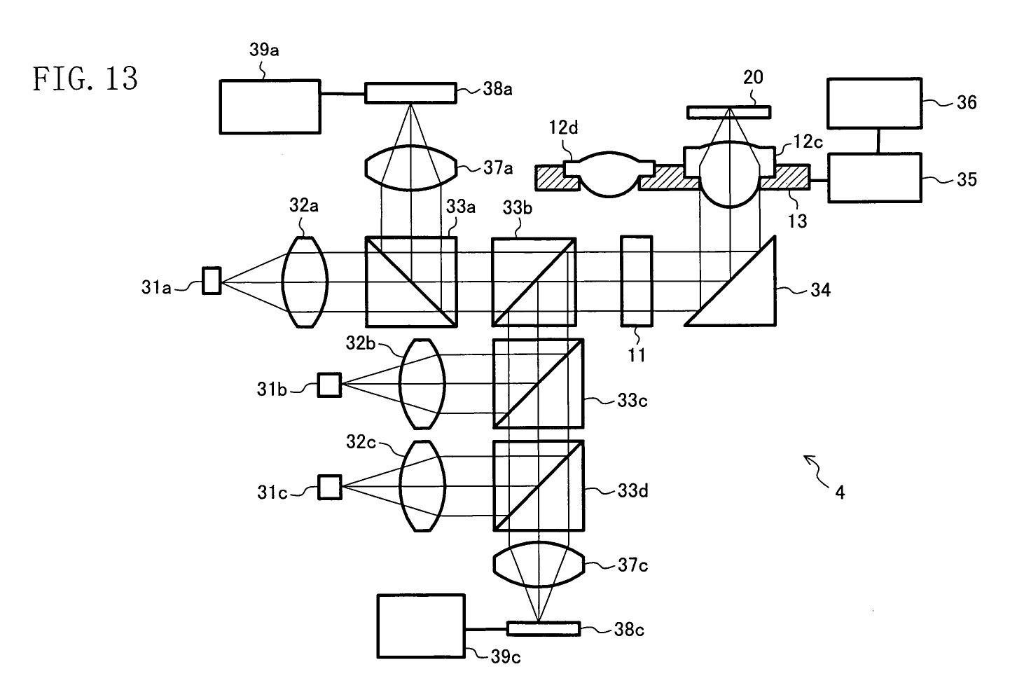

FIG. 13 is a view corresponding to the structure of a major part of an optical pickup 4 according to a fourth embodiment.

In the second and third embodiments described above, description has been made on an example of the optical pickup capable of recording/reproducing information on/from the first and second information recording media 20a and 20b having the information recording surfaces 22a and 22b corresponding to the laser light beam from the first light source 31a and the third information recording medium 20c having the information recording surface 22c corresponding to the laser light beam from the second light source 31b. However, the present invention is not limited thereto. The optical pickup may be configured to be capable of recording/reproducing information on/from, in addition to the first to third information recording media 20a to 20c, a fourth information recording medium 20d having an information recording surface 22d corresponding to a laser light beam of a wavelength different from both of the wavelengths of the laser light beams emitted from the first and second light sources 31a and 31b.

In the fourth embodiment, explanation will be made on an optical pickup 4 capable of recording/reproducing information not only on/from the first to third information recording media 20a to 20c but also on/from a fourth information recording medium 20d corresponding to a laser light beam having a wavelength different from the wavelengths of the laser light beams corresponding to the first to third information recording media 20a to 20c and/or having a protection layer 21d of a thickness different from the thicknesses of the protection layers 21a to 21c of the first to third information recording media 20a to 20c. In the description of the fourth embodiment, components having the same function as those of the first to third embodiments are indicated by the same reference numeral to omit overlapping explanation.

The optical pickup 4 of the fourth embodiment includes a first light source 31a for emitting a laser light beam having a wavelength corresponding to the first and second information recording media 20a and 20b, a second light source 31b for emitting a laser light beam having a wavelength corresponding to the third information recording medium 20c and a third light source 31c for emitting a laser light beam having a wavelength corresponding to the fourth information recording medium 20d.

When the first information recording medium 20a is placed in front of the optical pickup 4, the first light source 31a is turned on, while the second and third light sources 31b and 31c are turned off. A laser light beam emitted from the first light source 31a is converted into a parallel light beam by a collimator lens 32a. Then, the parallel light beam passes through a beam splitter 33a and a dichroic prism 33b to enter a diffraction element 11.

As described in the first embodiment, the diffraction element 11 separates the laser light beam emitted from the first light source 31a into 0^{th}- and 1^{st}-order diffracted lights. Among the diffracted lights, the 0^{th}-order diffracted light is reflected on a mirror 34.

The light beam reflected on a reflection plane 34a is headed for objective lenses 12c and 12d fixed by a lens folder 13. The lens folder 13 is connected to an actuator 35 and a control unit 36 for controlling the actuator 35. The actuator 35 and the control unit 36 make it possible to introduce one of the objective lenses 12c and 12d into the optical path and displace the objective lenses 12c and 12d in the focusing direction and/or tracking direction.

When the first information recording medium 20a is placed in front of the optical pickup 4, the objective lens 12c is placed on the optical path by the actuator 35 and the control unit 36. The objective lens 12c is designed to be able to suitably focus the 0^{th}-order diffracted light onto the information recording surface 22a of the first information recording medium 20a at its reference position. Therefore, the 0^{th}-order diffracted light guided to the objective lens 12c by the reflection plane 34a is focused onto the information recording surface 22a by the objective lens 12c. For the reproduction of information from the first information recording medium 20a, a light beam reflected on the information recording surface 22a re-passes through the objective lens 12c, the diffraction element 11 and the dichroic prism 33b. The light beam is then reflected again on a reflection plane of the beam splitter 33c, focused onto the light receiving element 38a by the collimator lens 37a and detected by the light receiving element 38a.

When the second information recording medium 20b is placed in front of the optical pickup 4, only the first light source 31a is turned on and the laser light beam emitted from the first light source 31a enters the diffraction element 11, just like when the first information recording medium 20a is placed. Further, with respect to the second information recording medium 20b, the objective lens 12c is placed on the optical path by the actuator 35 and the control unit 36. The position of the objective lens 12c is adjusted by the actuator 35 and the control unit 36 such that the 1^{st}-order diffracted light separated by the diffraction element 11 from the laser light beam emitted from the first light source 31a is suitably focused onto the information recording surface 22b of the second information recording medium 20b by the objective lens 12c. In this manner, the 1^{st}-order diffracted light is focused onto the information recording surface 22b of the second information recording medium 20b. Then, a light beam reflected on the information recording surface 22b re-passes through the objective lens 12c, the diffraction element 11 and the dichroic prism 33b. The light beam is reflected again on a reflection plane of the beam splitter 33c, focused onto the light receiving element 38a by the collimator lens 37a and detected by the light receiving element 38a.

As described in the first embodiment, the diffraction efficiency of the 0^{th}-order diffracted light is set relatively high and the 0^{th}-order/stray light ratio is set relatively low. Therefore, just like the first embodiment described above, the fourth embodiment makes it possible to appropriately record/reproduce information on/from the first information recording medium 20a. Further, since the diffraction efficiency of the 1^{st}-order diffracted light is set high to some extent and the 1^{st}-order/stray light ratio is set relatively low, information is appropriately reproduced from the second information recording medium 20b.

Now, the case where the third information recording medium 20c is placed in front of the optical pickup 4 will be explained. In this case, the first light sources 31a and 31c are turned off and the second light source 31b emits a laser light beam. The laser light beam emitted from the second light source 31b is converted into a parallel light beam by a collimator lens 32b. The parallel light beam is then reflected on a reflection plane provided in the beam splitter 33c and reflected again on a reflection plane provided in the dichroic prism 33b to enter the diffraction element 11. The laser light beam is then diffracted by diffraction element 11. The diffraction element 11 is configured to substantially 0^{th}-order diffract the phase-modulated laser light beam. Therefore, only the substantially 0^{th}-order diffracted light comes out of the diffraction element 11.

When the third information recording medium 20c is placed, the actuator 35 and the control unit 36 place the objective lens 12d for the third and fourth information recording media 20c and 20d on the optical path and adjust the position of the objective lens 12d in the focusing direction such that the objective lens 12d focuses the 0^{th}-order diffracted light onto the information recording surface 22c of the third information recording medium 20c. As a result, the 0^{th}-order diffracted light is suitably focused onto the information recording surface 22c of the third information recording medium 20c by the objective lens 12d. A light beam reflected from the information recording surface 22c is detected by the light receiving element 38c.

If two or more objective lenses 12 are provided in this manner, the design freedom for the objective lenses 12 is extended and the aberration on the information recording surfaces of the information recording media is reduced more effectively.

From the aspect of appropriate information recording/reproduction on/from the third information recording medium 20c, the diffraction element 11 preferably meets the following conditional expression (7), more preferably (7-a). Further, it is preferable to meet the conditional expression (8) irrespective of or in addition to the conditional expression (7). With this configuration, the light is focused onto the information recording surface 22c with high efficiency and high S/N ratio is obtained:

γ₁>85% (7)

γ₁>90% (7-a)

wherein γ₁ is the diffraction efficiency of the 0^{th}-order diffracted light separated on the diffraction plane 15 from the laser light beam corresponding to the information recording surface 22c;

γ₀>η₀ (8)

wherein γ₁ is the diffraction efficiency of the 0^{th}-order diffracted light separated on the diffraction plane 15 from the laser light beam corresponding to the information recording surface 22c and η₀ is the diffraction efficiency of the 0^{th}-order diffracted light separated on the diffraction plane 15 from the laser light beam corresponding to the information recording surfaces 22a and 22b.

Next, the case where the fourth information recording medium 20d is placed in front of the optical pickup 4 will be explained. In this case, the first light sources 31a and 31b are turned off and the third light source 31c emits a laser light beam.

The laser light beam emitted from the third light source 31c is converted into a parallel light beam by the collimator lens 32c. Then, the parallel light beam is reflected on a reflection plane provided in the beam splitter 33d and passes through the beam splitter 33c. Then, it is reflected again on a reflection plane provided in the dichroic prism 33b to enter the diffraction element 11. The laser light beam is diffracted by the diffraction element 11. The diffraction element 11 is configured to substantially 0^{th}-order diffract the laser light beam emitted from the third light source 31c. Therefore, only the substantially 0^{th}-order diffracted light comes out of the diffraction element 11.

When the fourth information recording medium 20d is placed, the actuator 35 and the control unit 36 place the objective lens 12d for the third and fourth information recording media 20c and 20d on the optical path and adjust the position of the objective lens 12d in the focusing direction such that the objective lens 12d focuses the 0^{th}-order diffracted light onto the information recording surface 22d of the fourth information recording medium 20d. Thus, the 0^{th}-order diffracted light is suitably focused onto the information recording surface 22d of the fourth information recording medium 20d by the objective lens 12d. A light beam reflected from the information recording surface 22d is detected by the light receiving element 38c.

From the aspect of appropriate information recording/reproduction on/from the fourth information recording medium 20d, the diffraction element 11 preferably meets the following conditional expression (7-b), more preferably (7-c). Further, it is preferable to meet the conditional expression (8-a) irrespective of or in addition to the conditional expression (7-b). With this configuration, the light is focused onto the information recording surface 22d with high efficiency and high S/N ratio is obtained:

γ₂>85% (7-b)

γ₂>90% (7-c)

wherein γ₂ is the diffraction efficiency of the 0^{th}-order diffracted light separated on the diffraction plane 15 from the laser light beam corresponding to the information recording surface 22d;

γ₂>η₀ (8-a)

wherein γ₂ is the diffraction efficiency of the 0^{th}-order diffracted light separated on the diffraction plane 15 from the laser light beam corresponding to the information recording surface 22d and o is the diffraction efficiency of the 0^{th}-order diffracted light separated on the diffraction plane 15 from the laser light beam corresponding to the information recording surfaces 22a and 22b.

In the fourth embodiment, the diffraction element 11 is arranged closer to the light source than the mirror 34. However, the diffraction element 11 may be arranged between the mirror 34 and the objective lens 12c. In such a case, the diffraction element 11 may be fixed by the lens folder 13 to face the objective lens 12c. With this configuration, the axial misalignment between the diffraction element 11 and the objective lens 12c is restricted and the diffraction element 11 does not enter the optical path when the objective lens 12d is arranged on the optical path. Therefore, the use efficiency of light for the third and fourth information recording media 20c and 20d is further increased.

The correlation among the laser light beams emitted from the light sources is not particularly limited. For example, the laser light beams may satisfy the following conditional expression (21):

λ₀<λ₂<λ₃ (21)

wherein λ₁ is the wavelength of the laser light beam emitted from the first light source 31a, λ₂ is the wavelength of the laser light beam emitted from the second light source 31b and λ₃ is the wavelength of the laser light beam emitted from the third light source 31c.

Further, the thickness of each of the protection layers 21a to 21d of the information recording media 20a to 20d is not particularly limited. For example, the thickness may be determined to meet the following conditional expression (22):

t₁<t₂=t₃<t₄ (22)

wherein t1 is the thickness of the protection layer 21a of the first information recording medium 20a, t2 is the thickness of the protection layer 21b of the second information recording medium 20b, t3 is the thickness of the protection layer 21c of the third information recording medium 20c and t4 is the thickness of the protection layer 21d of the fourth information recording medium 20d.

In the embodiments described above, the numerical aperture of the objective optical system for focusing light onto each of the information recording surfaces 22a to 22d is not particularly limited. For example, the following relationship may be established:

NA4<NA3≦NA2<NA1

wherein NA1 is the numerical aperture of the objective optical system when light is focused onto the information recording surface 22a of the first information recording medium 20a, NA2 is the numerical aperture of the objective optical system when light is focused onto the information recording surface 22b of the second information recording medium 20b, NA3 is the numerical aperture of the objective optical system when light is focused onto the information recording surface 22c of the third information recording medium 20c and NA4 is the numerical aperture of the objective optical system when light is focused onto the information recording surface 22d of the fourth information recording surface 20d.

The fourth embodiment described above makes it possible, for example, information recording/reproduction on/from BD, information reproduction from HD-DVD, information recording/reproduction on/from or only information reproduction from DVD, and information recording/reproduction on/from or only information reproduction from CD.

The objective optical system according to the present invention is useful for an optical pickup capable of suitably reproducing information from various kinds of information recording media corresponding to laser light beams having substantially the same wavelength and suitably recording information on at least one of the information recording media, e.g., an optical disk reproduction apparatus or an optical disk recording/reproduction apparatus for personal computers. For example, it is useful for an optical disk recording/reproduction apparatus capable of recording/reproducing information on/from BD and reproducing information from HD-DVD.

It should be noted that the present invention is not limited to the above embodiments and various modifications are possible within the spirit and essential features of the present invention. The above embodiments shall be interpreted as illustrative and not in a limiting sense. The scope of the present invention is specified only by the following claims and the description of the specification is not limitative at all. Further, it is also to be understood that all the changes and modifications made within the scope of the claims fall within the scope of the present invention.

What is claimed is:

1. An objective optical system used to focus, in an optical pickup which performs information recording/reproduction on/from a first information recording medium and information reproduction from a second information recording medium, a laser light beam onto information recording surfaces of the first and second information recording media, the first and second information recording media including information recording surfaces corresponding to laser light beams of substantially the same wavelength, respectively, and protection layers having different thicknesses from each other and covering the information recording surfaces, respectively, wherein
the objective optical system comprises a diffraction plane for separating the laser light beam into at least 0^{th}-order diffracted light and 1^{st}-order diffracted light such that the 0^{th}-order diffracted light is focused onto the information recording surface of the first information recording medium and the 1^{st}-order diffracted light is focused onto the information recording surface of the second information recording medium and
the objective optical system is configured to meet the following conditional expression (1):
η₀>η₁ (1)
wherein η₀ is the diffraction efficiency of the 0^{th}-order diffracted light and η₁ is the diffraction efficiency of the 1^{st}-order diffracted light.

2. The objective optical system of claim 1, wherein
the objective optical system is configured to meet the following conditional expression (1-a):
η₀>>η₁ (1-a)
wherein η₀ is the diffraction efficiency of the 0^{th}-order diffracted light and η₁ is the diffraction efficiency of the 1^{st}-order diffracted light.

3. The objective optical system of claim 1, wherein
the objective optical system is configured to meet the following conditional expression (2) at all times:
η₀>ηₘ (2)
wherein η₀ is the diffraction efficiency of the 0^{th}-order diffracted light, ηₘ is the diffraction efficiency of m^{th}-order diffracted light separated from the laser light beam on the diffraction plane and m is an integer other than 0.

4. The objective optical system of claim 1, wherein
the objective optical system is configured to meet the following conditional expression (2-a) at all times:
η₀>>ηₘ (2-a)
wherein η₀ is the diffraction efficiency of the 0^{th}-order diffracted light, ηₘ is the diffraction efficiency of the m^{th}-order diffracted light separated from the laser light beam on the diffraction plane and m is an integer other than 0.

5. The objective optical system of claim 1, wherein
the objective optical system is configured to meet the following conditional expressions (3) and (4):
η₀>60% (3)
η₁>10% (4)
wherein η₀ is the diffraction efficiency of the 0^{th}-order diffracted light and 1 μl is the diffraction efficiency of the 1^{st}-order diffracted light.

6. The objective optical system of claim 1, wherein
2^{nd}-order diffracted light separated from the laser light beam on the diffraction plane has a diffraction efficiency of less than 10%.

7. The objective optical system of claim 1, wherein
the objective optical system is configured to meet the following conditional expression (5):
2×(η₁×η₋₁)/(η₀²)<0.15 (5)
wherein η₀ is the diffraction efficiency of the 0^{th}-order diffracted light, η₁ is the diffraction efficiency of the 1^{st}-order diffracted light and η₋₁ is the diffraction efficiency of −1^{st}-order diffracted light separated from the laser light beam on the diffraction plane.

8. The objective optical system of claim 1, wherein
the diffraction plane is configured to meet the following conditional expression (6):
2×(η₀η₂)/(η₁²)<0.15 (6)
wherein η₀ is the diffraction efficiency of the 0^{th}-order diffracted light, η₁ is the diffraction efficiency of the 1^{st}-order diffracted light and η₂ is the diffraction efficiency of 2^{nd}-order diffracted light separated from the laser light beam on the diffraction plane.

9. The objective optical system of claim 1, wherein
the optical pickup is configured to be able to reproduce information from an additional information recording medium having an information recording surface corresponding to a laser light beam having a wavelength different from the wavelength corresponding to the first and second information recording media and/or having a protection layer of a thickness different from the thicknesses of the protection layers of the first and second information recording media.

10. The objective optical system of claim 9, wherein
the wavelength of the laser light beam corresponding to the information recording surface of the additional information recording medium is longer than the wavelength of the laser light beam corresponding to the information recording surfaces of the first and second information recording media and
the objective optical system is configured to focus 0^{th}-order diffracted light of the laser light beam having the wavelength corresponding to the information recording surface of the additional information recording medium onto the information recording surface of the additional information recording medium and meet the following conditional expression (7):
γ>85% (7)
wherein γ is the diffraction efficiency of the 0^{th}-order diffracted light separated on the diffraction plane from the laser light beam corresponding to the information recording surface of the additional information recording medium.

11. The objective optical system of claim 9, wherein
the wavelength of the laser light beam corresponding to the information recording surface of the additional information recording medium is longer than the wavelength of the laser light beam corresponding to the information recording surfaces of the first and second information recording media and
the objective optical system is configured to focus 0^{th}-order diffracted light of the laser light beam having the wavelength corresponding to the information recording surface of the additional information recording medium onto the information recording surface of the additional information recording medium and meet the following conditional expression (8):
γ>η₀ (8)
wherein γ is the diffraction efficiency of the 0^{th}-order diffracted light separated on the diffraction plane from the laser light beam corresponding to the information recording surface of the additional information recording medium and η₀ is the diffraction efficiency of the 0^{th}-order diffracted light separated on the diffraction plane from the laser light beam corresponding to the information recording surfaces of the first and second information recording media.

12. The objective optical system of claim 1, wherein
the diffraction plane includes a plurality of annular convex portions which are arranged concentrically and periodically and have a nearly triangular cross section with an obtuse vertex angle, respectively.

13. The objective optical system of claim 12, wherein
the objective optical system comprises a diffraction element provided with the diffraction plane and
the diffraction plane is configured to meet the conditional expression (9) when 55≦x≦60, the conditional expression (10) when 60≦x≦65 and the conditional expression (11) when 65≦x≦77:
0.26≦y≦0.35 (9)
−0.002x+0.38≦y≦0.35 (10)
0.25≦y≦0.35 (11)
wherein if the diffraction plane has negative optical power, x is the ratio of a distance between part of the convex portion closest to the optical axis and the vertex of the convex portion with respect to the pitch of the convex portions on the cross section of the diffraction plane including the optical axis or if the diffraction plane has positive optical power, x is the ratio of a distance between part of the convex portion farthest from the optical axis and the vertex of the convex portion with respect to the pitch of the convex portions on the cross section of the diffraction plane including the optical axis and y is a value defined by the following expression (12):
y=h/{λ(n−1)} (12)
wherein h is the height of the convex portion, λ is the wavelength of the laser light beam and n is a refractive index of the diffraction element with respect to the wavelength of the laser light beam.

14. The objective optical system of claim 12, wherein
the objective optical system comprises a diffraction element provided with the diffraction plane and
the diffraction plane is configured to meet the conditional expression (13) when 58≦x≦60, the conditional expression (14) when 60≦x≦65, the conditional expression (15) when 65≦x≦70, the conditional expression (16) when 70≦x≦72, the conditional expression (17) when 72≦x≦75 and the conditional expression (18) when 75≦x≦77:
0.24≦y≦0.035x−1.73 (13)
0.24≦y≦0.37 (14)
(0.03/5)x−0.15≦y≦0.002x+0.24 (15)
0.01x−0.43≦y≦0.38 (16)
(0.04/3)x−0.67≦y≦0.38 (17)
0.01x−0.42≦y≦0.38 (18)
wherein if the diffraction plane has negative optical power, x is the ratio of a distance between part of the convex portion closest to the optical axis and the vertex of the convex portion with respect to the pitch of the convex portions on the cross section of the diffraction plane including the optical axis or if the diffraction plane has positive optical power, x is the ratio of a distance between part of the convex portion farthest from the optical axis and the vertex of the convex portion with respect to the pitch of the convex portions on the cross section of the diffraction plane including the optical axis and y is a value defined by the following expression (12):
y=h/{λ/(n−1)} (12)
wherein h is the height of the convex portion, λ is the wavelength of the laser light beam and n is a refractive index of the diffraction element with respect to the wavelength of the laser light beam.

15. The objective optical system of claim 1, wherein
the objective optical system comprises a diffraction element provided with the diffraction plane and an objective lens for focusing the laser light beam diffracted by the diffraction element onto the information recording surface.

16. The objective optical system of claim 1, wherein
the objective optical system comprises an objective lens having the diffraction plane and focusing the laser light beam onto the information recording surface.

17. An optical pickup which performs information recording/reproduction on/from a first information recording medium including a first information recording surface and a first protection layer covering the first information recording surface and information reproduction from a second information recording medium including a second information recording surface corresponding to a laser light beam having substantially the same wavelength as that of a laser light beam corresponding to the first information recording surface and a second protection layer covering the second information recording surface and having a thickness different from that of the first protection layer, the optical pickup comprising:
a first light source for emitting a laser light beam having a wavelength corresponding to the first and second information recording surfaces;
a first objective optical system for focusing the laser light beam onto each of the first and second information recording surfaces; and
a first detector for detecting the laser light beam reflected from the first or second information recording surface, wherein
the first objective optical system includes a diffraction plane which separates the laser light beam emitted from the first light source into at least 0^{th}-order diffracted light and 1^{st}-order diffracted light such that the 0^{th}-order diffracted light is focused onto the first information recording surface of the first information recording medium and the 1^{st}-order diffracted light is focused onto the second information recording surface of the second information recording medium and the first objective optical system is configured to meet the following conditional expression (1):
η₀>η₁ (1)
wherein η₀ is the diffraction efficiency of the 0^{th}-order diffracted light and η₁ is the diffraction efficiency of the 1^{st}-order diffracted light.

18. The optical pickup of claim 17 further comprising a second light source for emitting a laser light beam having a wavelength different from the wavelength of the laser light beam emitted from the first light source onto the first objective optical system, wherein
the first objective optical system is configured to focus the laser light beam emitted from the second light source onto a third information recording surface of a third information recording medium, the third information recording medium including the third information recording surface corresponding to the wavelength of the laser light beam emitted from the second light source and a third protection layer covering the third information recording surface.

19. The optical pickup of claim 18, wherein
the wavelength of the laser light beam emitted from the second light source is longer than the wavelength of the laser light beam corresponding to the first and second information recording surfaces and
the diffraction plane is configured substantially not to diffract the laser light beam emitted from the second light source.

20. The optical pickup of claim 17 further comprising:
a second light source for emitting a laser light beam having a wavelength different from the wavelength of the laser light beam emitted from the first light source; and
a second objective optical system for focusing the laser light beam emitted from the second light source onto a third information recording surface of a third information recording medium, the third information recording medium including the third information recording surface corresponding to the wavelength of the laser light beam emitted from the second light source and a third protection layer covering the third information recording surface.

21. The optical pickup of claim 20 further comprising:
a third light source for emitting a laser light beam having a wavelength different from the wavelengths of the laser light beams emitted from the first and second light sources, wherein
the second objective optical system is configured to focus the laser light beam emitted from the third light source onto a fourth information recording surface of a fourth information recording medium, the fourth information recording medium including the fourth information recording surface corresponding to the wavelength of the laser light beam emitted from the third light source and a fourth protection layer covering the fourth information recording surface.
